(19) United States
(12) Patent Application Publication
(10) Pub. No.: US 2024/0079583 A1
(43) Pub. Date: Mar. 7, 2024

(54) FORMATION METHOD OF POSITIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Kazuya SHIMADA, Atsugi, Kanagawa (JP); Kousuke SASAKI, Atsugi, Kanagawa (JP); Takashi HIRAHARA, Atsugi, Kanagawa (JP); Yusuke YOSHITANI, Isehara, Kanagawa (JP); Mayumi MIKAMI, Atsugi, Kanagawa (JP); Yohei MOMMA, Isehara, Kanagawa (JP)

(21) Appl. No.: 18/262,126

(22) PCT Filed: Jan. 13, 2022
(86) PCT No.: PCT/IB2022/050226

§ 371 Date: Jul. 19, 2023

(30) Foreign Application Priority Data
Jan. 22, 2021 (JP) 2021-008573
Jan. 22, 2021 (JP) 2021-008675
Jan. 22, 2021 (JP) 2021-008812

(51) Int. Cl. H01M 4/525; C01G 51/00

(52) U.S. Cl. CPC H01M 4/525; C01G 51/42; C01P 2002/60; C01P 2002/72; C01P 2004/03; C01P 2006/40; H01M 2004/028

(57) ABSTRACT

A novel method for forming a positive electrode active material is provided. The method for forming a positive electrode active material includes causing a reaction between a cobalt aqueous solution and an alkaline aqueous solution to form a cobalt compound; mixing the cobalt compound and a lithium compound and performing a first heat treatment to form a first composite oxide; mixing the first composite oxide and a compound containing a first additive element and performing a second heat treatment to form a second composite oxide; and mixing the second composite oxide and a compound containing a second additive element and performing a third heat treatment. The first heat treatment is performed at a temperature higher than or equal to 700° C. and lower than or equal to 1100° C. The second heat treatment is performed at a temperature higher than or equal to 700° C. and lower than or equal to 1000° C. The third heat treatment is performed at a temperature equal to the temperature of the second heat treatment or at a temperature lower than the temperature of the second heat treatment.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material for a lithium-ion secondary battery and a manufacturing method thereof.

### BACKGROUND ART

In recent years, demand for lithium-ion secondary batteries with high output and high capacity has rapidly grown and the lithium-ion secondary batteries are essential as repeatedly-usable energy sources in modern society.

In particular, lithium ion secondary batteries for portable electronic devices have been required to have high discharge capacity per weight and excellent charge and discharge characteristics. To meet the requirements, positive electrode active materials used in lithium-ion secondary batteries have been actively improved (see Patent Document 1, for example). A positive electrode active material that has high capacity and excellent charge and discharge characteristics is disclosed in Patent Document 1.

### REFERENCE

### [Patent Document]

[Patent Document 1] PCT International Publication No. WO2020/099978

### SUMMARY OF THE INVENTION

### Problems to be Solved by the Invention

Patent Document 1 described above does not describe a formation method relating to a hydroxide containing an element M (cobalt is exemplified as M) that is a raw material. Furthermore, Patent Document 1 described above exemplifies a case of buying pre-synthesized lithium cobalt oxide.

In order to manufacture a secondary battery having excellent charge and discharge characteristics or the like, it is important to manage a positive electrode active material from a stage of a starting material. However, in the case of employing a method for forming lithium cobalt oxide in Patent Document 1 described above, management of a positive electrode active material is difficult; for example, the shape, particle diameter, or the like of lithium cobalt oxide cannot be controlled. Furthermore, an impurity contained in the lithium cobalt oxide cannot be grasped.

In view of the above, an object of one embodiment of the present invention is to provide a method for forming a positive electrode active material, which can solve at least one of the above-described points.

Another object of one embodiment of the present invention is to provide a method for forming a positive electrode active material with high discharge capacity. Another object of one embodiment of the present invention is to provide a method for forming a positive electrode active material that can withstand high charge and discharge voltages. Another object of one embodiment of the present invention is to provide a method for forming a positive electrode active material that is less likely to deteriorate. Another object of one embodiment of the present invention is to provide a novel positive electrode active material.

Another object of one embodiment of the present invention is to provide a method for manufacturing a secondary battery including the above-described positive electrode active material. That is, an object of one embodiment of the present invention is to provide a method for manufacturing a secondary battery with high discharge capacity. Another object of one embodiment of the present invention is to provide a method for manufacturing a secondary battery that can withstand high charge and discharge voltages. Another object of one embodiment of the present invention is to provide a method for manufacturing a secondary battery that is less likely to deteriorate. Another object of one embodiment of the present invention is to provide a method for manufacturing a secondary battery with a long lifetime. Another object of one embodiment of the present invention is to provide a method for manufacturing a novel secondary battery.

Another object of one embodiment of the present invention is to provide a positive electrode active material or a secondary battery obtained by the above manufacturing method.

Note that the description of the above objects does not preclude the existence of other objects. Moreover, objects other than the above objects can be derived from the description of the specification, the drawings, and the claims. One embodiment of the present invention does not necessarily achieve all the above objects, and achieve at least any one of all the above objects.

### Means for Solving the Problems

As a result of intensive research on the above objects, the present inventors and the like have found a method for forming a cobalt compound by causing a reaction between an aqueous solution containing a cobalt ion (referred to as a cobalt aqueous solution) and an aqueous solution showing basicity (referred to as a basic aqueous solution). As the basic aqueous solution, an aqueous solution showing alkalinity (referred to as an alkaline aqueous solution) can be typically used. In view of the above, one embodiment of the present invention is a method for forming a positive electrode active material, including causing a reaction between a cobalt aqueous solution and an alkaline aqueous solution to form a cobalt compound; mixing the cobalt compound and a lithium compound and performing a first heat treatment to form a first composite oxide; mixing the first composite oxide and a compound containing a first additive element and performing a second heat treatment to form a second composite oxide; and mixing the second composite oxide and a compound containing a second additive element and performing a third heat treatment. The first heat treatment is performed at a temperature higher than or equal to 700° C. and lower than or equal to 1100° C. The second heat treatment is performed at a temperature higher than or equal to 700° C. and lower than or equal to 1000° C. The third heat treatment is performed at a temperature equal to the temperature of the second heat treatment or at a temperature lower than the temperature of the second heat treatment.

Another embodiment of the present invention is a method for forming a positive electrode active material, including causing a reaction between a cobalt aqueous solution, an alkaline aqueous solution, and a chelate agent to form a cobalt compound; mixing the cobalt compound and a lithium compound and performing a first heat treatment to form a first composite oxide; mixing the first composite oxide and a compound containing a first additive element and performing a second heat treatment to form a second composite oxide; and mixing the second composite oxide and a compound containing a second additive element and performing a third heat treatment. The first heat treatment is performed at a temperature higher than or equal to 700° C. and lower than or equal to 1100° C. The second heat treatment is performed at a temperature higher than or equal to 700° C. and lower than or equal to 1000° C. The third heat treatment is performed at a temperature equal to the temperature of the second heat treatment or at a temperature lower than the temperature of the second heat treatment.

Another embodiment of the present invention is a method for forming a positive electrode active material, including causing a reaction between a first mixed solution including a cobalt aqueous solution and a first chelate agent and a second mixed solution including an alkaline aqueous solution and a second chelate agent to form a cobalt compound; mixing the cobalt compound and a lithium compound and performing a first heat treatment to form a first composite oxide; mixing the first composite oxide and a compound containing a first additive element and performing a second heat treatment to form a second composite oxide; and mixing the second composite oxide and a compound containing a second additive element and performing a third heat treatment. The first heat treatment is performed at a temperature higher than or equal to 700° C. and lower than or equal to 1100° C. The second heat treatment is performed at a temperature higher than or equal to 700° C. and lower than or equal to 1000° C. The third heat treatment is performed at a temperature equal to the temperature of the second heat treatment or at a temperature lower than the temperature of the second heat treatment.

Another embodiment of the present invention is a method for forming a positive electrode active material, including causing a reaction between a first mixed solution including a cobalt aqueous solution and a first chelate agent, an alkaline aqueous solution, and a second chelate agent to form a cobalt compound; mixing the cobalt compound and a lithium compound and performing a first heat treatment to form a first composite oxide; mixing the first composite oxide and a compound containing a first additive element and performing a second heat treatment to form a second composite oxide; and mixing the second composite oxide and a compound containing a second additive element and performing a third heat treatment. The first heat treatment is performed at a temperature higher than or equal to 700° C. and lower than or equal to 1100° C. The second heat treatment is performed at a temperature higher than or equal to 700° C. and lower than or equal to 1000° C. The third heat treatment is performed at a temperature equal to the temperature of the second heat treatment or at a temperature lower than the temperature of the second heat treatment.

In another embodiment of the present invention, a complexing agent or a chelate agent can be used. It is preferable that ammonia be used as the complexing agent and glycine, oxine, 1-nitroso-2-naphthol, or 2-mercaptobenzothiazole be used as the chelate agent.

In another embodiment of the present invention, a complexing agent or a chelate agent can be used. It is preferable that ammonia be used as a first complexing agent and ammonia be used as a second complexing agent or glycine, oxine, 1-nitroso-2-naphthol, or 2-mercaptobenzothiazole be used as a first chelate agent and glycine, oxine, 1-nitroso-2-naphthol, or 2-mercaptobenzothiazole be used as a second chelate agent.

In another embodiment of the present invention, it is preferable that the first chelate agent contain the same material as the second chelate agent.

In another embodiment of the present invention, it is preferable that the first additive element contain Mg or F and the second additive element contain Ni or Al.

In another embodiment of the present invention, it is preferable that the second composite oxide and the compound containing the second additive element be mixed to form a mixture, the mixture and a compound containing a third additive element be mixed, and the third heat treatment be performed.

In another embodiment of the present invention, it is preferable that the first additive element contain Mg or F, the second additive element contain Ni, and the third additive element contain Zr or Al.

In another embodiment of the present invention, it is preferable that the first composite oxide be crushed and then the second heat treatment be performed to form the second composite oxide.

### Effect of the Invention

According to one embodiment of the present invention, a positive electrode active material can be managed from a stage of a starting material. According to one embodiment of the present invention, the shape, particle diameter, or the like of a positive electrode active material can be controlled. According to one embodiment of the present invention, an impurity contained in a positive electrode active material can be grasped.

According to one embodiment of the present invention, a method for forming a positive electrode active material with high discharge capacity can be provided. According to one embodiment of the present invention, a method for forming a positive electrode active material that can withstand high charge and discharge voltages can be provided. According to one embodiment of the present invention, a method for forming a positive electrode active material that is less likely to deteriorate can be provided. According to one embodiment of the present invention, a novel positive electrode active material can be provided.

Note that the description of these effects does not preclude the existence of other effects. One embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a flow chart showing a formation process of a positive electrode active material which is one embodiment of the present invention.

FIG. 2 is a flow chart showing a formation process of a positive electrode active material which is one embodiment of the present invention.

FIG. 3 is a flow chart showing a formation process of a positive electrode active material which is one embodiment of the present invention.

FIG. 4 is a flow chart showing a formation process of a positive electrode active material which is one embodiment of the present invention.

FIG. 5 is a flow chart showing a formation process of a positive electrode active material which is one embodiment of the present invention.

FIG. 6 is a flow chart showing a formation process of a positive electrode active material which is one embodiment of the present invention.

FIG. 7 is a flow chart showing a formation process of a positive electrode active material which is one embodiment of the present invention.

FIG. 8 is a flow chart showing a formation process of a positive electrode active material which is one embodiment of the present invention.

FIG. 9 is a flow chart showing a formation process of a positive electrode active material which is one embodiment of the present invention.

FIG. 10 is a flow chart showing a formation process of a positive electrode active material which is one embodiment of the present invention.

FIG. 11 is a diagram showing coprecipitation synthesis equipment which is one embodiment of the present invention.

FIG. 12 is a diagram showing coprecipitation synthesis equipment which is one embodiment of the present invention.

FIG. 13 is a diagram illustrating a change in a crystal structure of a positive electrode active material.

FIG. 14 is a diagram illustrating a change in a crystal structure of a positive electrode active material of a conventional example.

FIG. 15 is a diagram showing XRD patterns calculated from crystal structures.

FIG. 16 is a diagram showing XRD patterns calculated from crystal structures.

FIG. 17A to FIG. 17D are cross-sectional views illustrating examples of a positive electrode of a secondary battery.

FIG. 18A is an exploded perspective view of a coin-type secondary battery, FIG. 18B is a perspective view of the coin-type secondary battery, and FIG. 18C is a cross-sectional perspective view thereof.

FIG. 19A is a diagram showing an example of a cylindrical secondary battery, FIG. 19B is a diagram showing an example of a cylindrical secondary battery, and FIG. 19C is a diagram showing an example of a plurality of cylindrical secondary batteries.

FIG. 20A and FIG. 20B are diagrams illustrating examples of a secondary battery, and FIG. 20C is a diagram showing the internal state of the secondary battery.

FIG. 21A to FIG. 21C are diagrams illustrating an example of a secondary battery.

FIG. 22A and FIG. 22B are diagrams showing external views of secondary batteries.

FIG. 23A to FIG. 23C are diagrams illustrating a manufacturing method of a secondary battery.

FIG. 24A is a diagram showing an external view of a battery pack, FIG. 24B is a diagram showing a structure example of the battery pack, and FIG. 24C is a diagram showing a structure example of the battery pack.

FIG. 25A and FIG. 25B are diagrams illustrating examples of a secondary battery.

FIG. 26A to FIG. 26C are diagrams illustrating an example of a secondary battery.

FIG. 27A and FIG. 27B are diagrams illustrating an example of a secondary battery.

FIG. 28A is a perspective view of a battery pack showing one embodiment of the present invention, FIG. 28B is a block diagram of the battery pack, and FIG. 28C is a block diagram of a vehicle having a motor.

FIG. 29A to FIG. 29D are diagrams illustrating examples of transport vehicles.

FIG. 30A and FIG. 30B are diagrams illustrating a power storage device of one embodiment of the present invention.

FIG. 31A is a diagram showing an electric bicycle, FIG. 31B is a diagram showing a secondary battery of the electric bicycle, and FIG. 31C is a diagram illustrating an electric motorcycle.

FIG. 32A to FIG. 32C are diagrams illustrating examples of electronic devices.

FIG. 33A illustrates examples of wearable devices, FIG. 33B is a perspective view of a watch-type device, and FIG. 33C is a diagram illustrating a side surface of the watch-type device.

FIG. 34A and FIG. 34B are drawings showing examples of electronic devices.

FIG. 35A to FIG. 35E are diagrams showing examples of an electronic device.

FIG. 36A to FIG. 36H are drawings illustrating examples of electronic devices.

FIG. 37A to FIG. 37C are diagrams illustrating an example of an electronic device.

FIG. 38 is a drawing illustrating examples of electronic devices.

FIG. 39 is a diagram showing XRD analysis results.

FIG. 40 shows plan SEM images of positive electrode active materials.

FIG. 41 is a graph showing results of a cycle test using coin cells.

FIG. 42A and FIG. 42B are graphs showing results of cycle tests using coin cells.

FIG. 43A and FIG. 43B are graphs showing results of cycle tests using coin cells.

FIG. 44 is a diagram showing XRD analysis results.

FIG. 45 shows plan SEM images of positive electrode active materials.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

In this embodiment, description is made on a method for forming a positive electrode active material which is one embodiment of the present invention.

### <Formation Method 1>

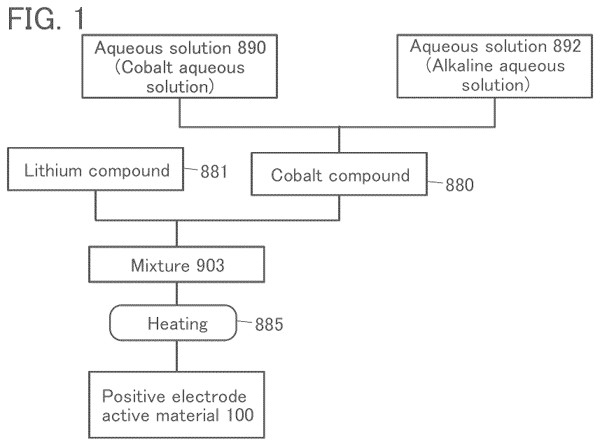

As shown in FIG. 1, a cobalt aqueous solution is prepared as an aqueous solution 890, and an alkaline solution is prepared as an aqueous solution 892. A reaction is caused between them, whereby a cobalt compound 880 is formed. This reaction is referred to as a neutralization reaction, an acid-base reaction, or a coprecipitation reaction, and this cobalt compound 880 is referred to as a precursor of lithium cobaltate in some cases.

### <Cobalt Aqueous Solution>

As the cobalt aqueous solution, an aqueous solution containing cobalt sulfate (e.g., CoSO₄), cobalt chloride (e.g., CoCl₂), cobalt nitrate (e.g., Co(NO₃)₂), cobalt acetate (e.g., C₄H₆CoO₄), cobalt alkoxide, an organocobalt complex, hydrate of any of these, or the like is given. For example, an aqueous solution obtained by dissolving these in pure water can be used. The cobalt aqueous solution shows acidity, and thus can be referred to as an acid aqueous solution. The cobalt aqueous solution can be referred to as a cobalt source in a formation process of a positive electrode active material.

### <Alkaline Aqueous Solution>

As the alkaline solution, an aqueous solution containing sodium hydroxide, potassium hydroxide, lithium hydroxide, or ammonia is given. For example, an aqueous solution obtained by dissolving these in pure water can be used. An aqueous solution in which multiple kinds selected from sodium hydroxide, potassium hydroxide, lithium hydroxide, and ammonia are dissolved in pure water may be used.

### <Pure Water>

The pure water that is preferably used for the cobalt aqueous solution and the alkaline aqueous solution is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities.

### <Reaction Conditions>

In the case where a reaction is caused between the aqueous solution 890 and the aqueous solution 892 by the coprecipitation method, the pH of the reaction system is set to greater than or equal to 9.0 and less than or equal to 13.0, and the pH is preferably set to greater than or equal to 9.8 and less than or equal to 12.5. For example, in the case where the aqueous solution 892 is put into a reaction tank (also referred to as a reaction container) and the aqueous solution 890 is dropped into the reaction container, the pH of the aqueous solution in the reaction container is preferably kept in the above range of the condition. As the reaction container, a highly chemical-resistant container such as a glass container or a stainless steel container can be used. As the glass container, a beaker or a flask is given. Being kept in the range means that when the pH of the aqueous solution in the reaction container changes by dropping of the aqueous solution 890, the pH of the aqueous solution in the reaction container falls within the above range after a predetermined time elapsed. The predetermined time is longer than or equal to 1 second and shorter than or equal to 5 seconds, preferably longer than or equal to 1 second and shorter than or equal to 3 seconds. The same applies to the case where the aqueous solution 890 is put into the reaction container and the aqueous solution 892 is dropped. The dropping rate of the aqueous solution 890 or the aqueous solution 892 is preferably higher than or equal to 0.1 mL/min and lower than or equal to 1.0 mL/min, preferably higher than or equal to 0.3 mL/min and lower than or equal to 1.0 mL/min. The dropping rate is preferably low, in which case the pH condition can be controlled easily.

The aqueous solution 892 or the aqueous solution 890 in the reaction container is preferably stirred with a stirring means. A stirrer can be used as the stirring means and a magnetic stirrer is given as the stirrer. Alternatively, a mechanical stirring means can be used; for example, a stirring blade connected to a motor can be used. Examples of the stirring blade include a propeller blade and an inclined paddle blade, each of which can have two or more and six or less blades. For example, in the case of four blades, they are preferably arranged to make a cross shape when seen from above. The rotational frequency of the stirring means is preferably higher than or equal to 800 rpm and lower than or equal to 1200 rpm.

The temperature of the aqueous solution 890 or the aqueous solution 892 in the reaction container is controlled to be higher than or equal to 40° C., preferably higher than or equal to 50° C. and lower than or equal to 90° C. After the temperature reaches the above temperature, dropping of the aqueous solution is preferably started.

The reaction container preferably has an inert atmosphere. For example, in the case of a nitrogen atmosphere, a nitrogen gas is preferably introduced at a flow rate of 0.5 L/min or higher and 2 L/min.

In the reaction container, a reflux condenser may be placed. The nitrogen gas can be released from the reaction container with use of the reflux condenser. Water generated by reflux cooling can be returned to the reaction container.

Through the above reaction, a cobalt compound is precipitated in the reaction container. Filtration is performed to collect the cobalt compound. Before the filtration, a reaction product precipitated in the reaction container is preferably washed with pure water and then washed with an organic solvent with a low boiling point (e.g., acetone). Moreover, the cobalt compound may be made to pass through a sieve before the washing.

Furthermore, the cobalt compound after the filtration is preferably dried. For example, the cobalt compound is dried in a vacuum atmosphere at higher than or equal to 60° C. and lower than or equal to 90° C. for longer than or equal to 0.5 hours and shorter than or equal to 3 hours. In this manner, the cobalt compound 880 can be obtained.

The cobalt compound 880 includes cobalt hydroxide (e.g., Co(OH)₂). The cobalt hydroxide after the filtration is obtained as a secondary particle which is an aggregation of primary particles. Note that in this specification, the primary particle refers to a lump of minimum particles that is found when being observed, e.g., at a magnification of 5000 times with a SEM (scanning electron microscope), for example. In other words, the primary particle means a minimum unit of particle surrounded by a grain boundary. In addition to the grain boundary that can be observed with a SEM, there is a grain boundary existing inside the particle. The secondary particle refers to a particle in which the primary particles are aggregated, partially sharing the grain boundary (the circumference of the primary particle or the like) and are not easily separated from each other (an independent particle). That is, the secondary particle has a grain boundary in some cases.

Next, a lithium compound 881 is prepared.

### <Lithium Compound 881>

Examples of the lithium compound 881 include lithium hydroxide (e.g., LiOH), lithium carbonate (e.g., Li₂CO₃), and lithium nitrate (e.g., LiNO₃).

In the case where cobalt hydroxide is obtained as the compound 880, lithium hydroxide is preferably used as the lithium compound 881.

As the lithium compound 881, a high-purity material is preferably used. The lithium compound can be referred to as a lithium source. Specifically, the purity of the material is higher than or equal to 4N (99.99%), preferably higher than or equal to 4N5 (99.995%), further preferably higher than or equal to 5N (99.999%). The use of the high-purity material can improve the battery characteristics of a secondary battery.

The lithium compound 881 is preferably microparticulated. In order to improve battery characteristics, it is preferable that a lithium compound that is unreacted in synthesis do not exist, and microparticulation can increase reactivity. In the case where lithium hydroxide or lithium carbonate is used as the lithium compound, the particle diameter of each of them is greater than or equal to 1 μm and less than or equal to 5 μm, preferably greater than or equal to 1 μm and less than or equal to 3 μm. Here, the particle diameter is a median diameter (D50).

### <Mixture>

The lithium compound 881 and the cobalt compound 880 are mixed, whereby a mixture 903 is obtained. The mixing can be performed by a dry process or a wet process. A planetary centrifugal mixer may be used for the mixing. Moreover, a ball mill, a bead mill, or the like can be used as a mixing means. When the ball mill is used, zirconia balls are preferably used as media, for example. When a ball mill, a bead mill, or the like is used, the peripheral speed is preferably greater than or equal to 100 mm/sec and less than or equal to 2000 mm/sec in order to inhibit contamination from the media or the material. The cobalt compound 880 and the lithium compound 881 are sometimes ground during the mixing but are not necessarily ground.

Next, the mixture is subjected to heating 885. This step is referred to as a heating step and the heating step is referred to as baking in some cases. In the case where heating is performed after this step, with the use of an ordinal number, the heating in this step is sometimes referred to as first heating.

### <Heating Conditions>

The heating temperature is preferably higher than or equal to 700° C. and lower than 1100° C., further preferably higher than or equal to 800° C. and lower than or equal to 1000° C., still further preferably higher than or equal to 800° C. and lower than or equal to 950° C. A heating step may be performed a plurality of times; for example, heating may be performed first at a temperature higher than or equal to 400° C. and lower than or equal to 700° C., and then heating may be performed at the above-described temperature higher than or equal to 700° C. and lower than 1100° C. The former heating is performed at a low temperature and thus is sometimes referred to as temporary baking. By such heating, gas components in a starting material are expected to be released, and the composite oxide with fewer impurities can be formed with the use of the starting material.

The heating time can be longer than or equal to 1 hour and shorter than or equal to 100 hours, for example, and is preferably longer than or equal to 2 hours and shorter than or equal to 20 hours.

The heating atmosphere is preferably an oxygen-containing atmosphere or an oxygen-containing atmosphere that is what is called dry air with little water (e.g., a dew point is lower than or equal to −50° C., and a dew point is preferably lower than or equal to −80° C.). The latter oxygen-containing atmosphere is referred to as a dry atmosphere. As the oxygen-containing atmosphere, an atmosphere in which the proportion of oxygen is higher than or equal to 90% is preferable.

For example, in the case where the heating is performed at 850° C. for 10 hours, the temperature rising rate is preferably higher than or equal to 150° C./h and lower than or equal to 250° C./h. The flow rate of dry air that forms the dry atmosphere is higher than or equal to 1 L/min and lower than or equal to 15 L/min, preferably higher than or equal to 8 L/min and lower than or equal to 15 L/min, further preferably higher than or equal to 5 L/min and lower than or equal to 10 L/min. The temperature decreasing time from a specified temperature to room temperature is preferably longer than or equal to 10 hours and shorter than or equal to 50 hours. The temperature decreasing rate can be calculated from the temperature decreasing time or the like.

A crucible, a sagger, a setter, or a container used in the heating is preferably made of a material that hardly releases impurities. For example, a crucible made of alumina with a purity of 99.9% is preferably used. In the case of mass production, a sagger made of mullite cordierite is preferably used. A sagger made of mullite cordierite is a sagger formed using mullite and cordierite as raw materials.

When the heated material is collected, the material is sometimes moved from the crucible to a mortar. At this time, impurities are not mixed into the material. Therefore, a mortar made of alumina with a purity of 90% or higher, preferably 99% or higher, is preferably used. It is needless to say that a mortar made of zirconia may be used.

Through the above steps, a positive electrode active material 100 such as lithium cobalt oxide can be formed. The shape, particle diameter, or composition of the lithium cobalt oxide can be controlled compared to the case of lithium cobalt oxide formed thoroughly by a solid phase method. Lithium cobalt oxide is sometimes referred to as a cobalt compound or a composite oxide.

The lithium cobalt oxide is preferred in containing few impurities. However, sulfur might be detected from the lithium cobalt oxide, when sulfate is used as a starting material. With use of GD-MS (a glow discharge mass spectrometer), ICP-MS (an inductively coupled plasma-mass spectrometer), or the like, elements in the whole particle of the positive electrode active material can be analyzed to measure the concentration of sulfur.

### <Formation Method 2>

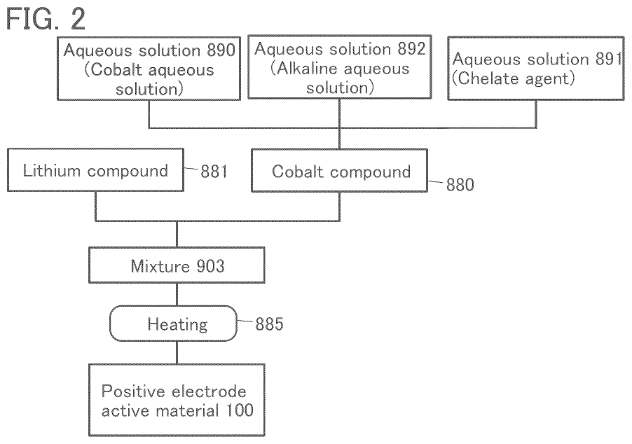

As shown in FIG. 2, a cobalt aqueous solution is prepared as the aqueous solution 890, an alkaline solution is prepared as the aqueous solution 892, and a chelate agent is prepared as an aqueous solution 891. Other components are similar to those in Formation method 1 described above.

### <Chelate Agent>

Examples of constituent materials of the chelate agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. An aqueous solution obtained by dissolving any of these in pure water is a chelate agent. The chelate agent is a complexing agent for forming a chelate compound, and is preferred to a general complexing agent. Needless to say, a complexing agent other than the chelate agent may be used, and ammonia water can be used as the complexing agent.

The chelate agent is preferably used, in which case generation of unnecessary crystal nuclei is suppressed to promote the crystal growth of a primary particle. Since generation of unnecessary crystal nuclei is suppressed to inhibit generation of fine particles, a composite oxide with good particle size distribution can be obtained. Furthermore, the use of the chelate agent can slow an acid-base reaction, so that the reaction gradually proceeds to form a nearly spherical secondary particle. The use of the chelate agent is preferable because it is easy to control the pH in the reaction container for obtaining the cobalt compound 880. Glycine has a function of keeping the pH value greater than or equal to 9.0 and less than or equal to 10.0 or the vicinity of the range. Using a glycine aqueous solution as the chelate agent is preferable because it is easy to control the pH of the reaction container for obtaining the cobalt compound 880. Furthermore, the concentration of glycine in the glycine aqueous solution is preferably greater than or equal to 0.05 mol/L and less than or equal to 0.1 mol/L in the aqueous solution 891.

Through the above steps, the positive electrode active material 100 such as lithium cobalt oxide can be formed. The shape, particle diameter, or composition of the lithium cobalt oxide can be controlled compared to the case of lithium cobalt oxide formed thoroughly by a solid phase method. Lithium cobalt oxide is sometimes referred to as a cobalt compound or a composite oxide.

The lithium cobalt oxide is preferred in containing few impurities. However, sulfur might be detected from the lithium cobalt oxide, when sulfate is used as a starting material. With use of GD-MS, ICP-MS, or the like, elements in the whole particle of the positive electrode active material can be analyzed to measure the concentration of sulfur.

### <Formation Method 3>

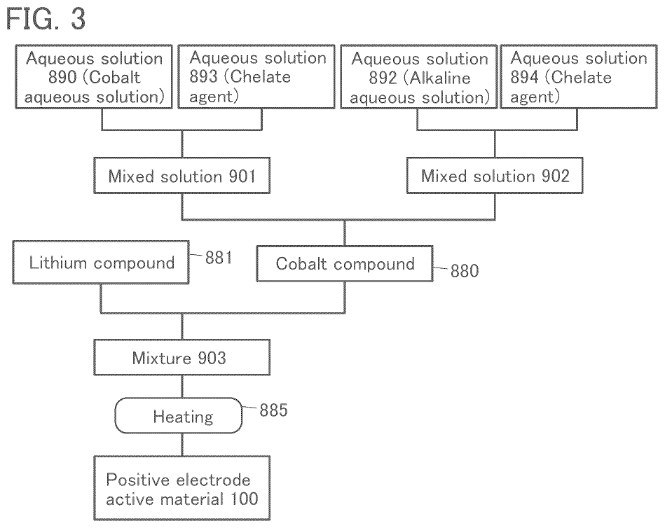

As shown in FIG. 3, a cobalt aqueous solution is prepared as the aqueous solution 890, an alkaline solution is prepared as the aqueous solution 892, and chelate agents are prepared as an aqueous solution 893 and an aqueous solution 894. The aqueous solution 893 is mixed with the aqueous solution 890 to form a mixed solution 901. The aqueous solution 894 is mixed with the aqueous solution 892 to form a mixed solution 902. Then, a reaction is caused between the mixed solution 901 and the mixed solution 902, whereby the cobalt compound 880 is obtained. Other components are similar to those in Formation method 1 described above.

The chelate agent is preferably used, in which case generation of unnecessary crystal nuclei is suppressed to promote the crystal growth of a primary particle. Since generation of unnecessary crystal nuclei is suppressed to inhibit generation of fine particles, a composite oxide with good particle size distribution can be obtained. Furthermore, the use of the chelate agent can slow an acid-base reaction, so that the reaction gradually proceeds to form a nearly spherical secondary particle. The use of the chelate agent is preferable because it is easy to control the pH in the reaction container for obtaining the cobalt compound 880. Glycine has a function of keeping the pH value greater than or equal to 9.0 and less than or equal to 10.0 or the vicinity of the range. Using a glycine aqueous solution as the chelate agent is preferable because it is easy to control the pH of the reaction container for obtaining the cobalt compound 880. Furthermore, the concentration of glycine in the glycine aqueous solution is preferably greater than or equal to 0.05 mol/L and less than or equal to 0.1 mol/L in the aqueous solution 893 or the aqueous solution 894.

Through the above steps, the positive electrode active material 100 such as lithium cobalt oxide can be formed. The shape, particle diameter, or composition of the lithium cobalt oxide can be controlled compared to the case of lithium cobalt oxide formed thoroughly by a solid phase method. Lithium cobalt oxide is sometimes referred to as a cobalt compound or a composite oxide.

The lithium cobalt oxide is preferred in containing few impurities. However, sulfur might be detected from the lithium cobalt oxide, when sulfate is used as a starting material. With use of GD-MS, ICP-MS, or the like, elements in the whole particle of the positive electrode active material can be analyzed to measure the concentration of sulfur.

### <Formation Method 4>

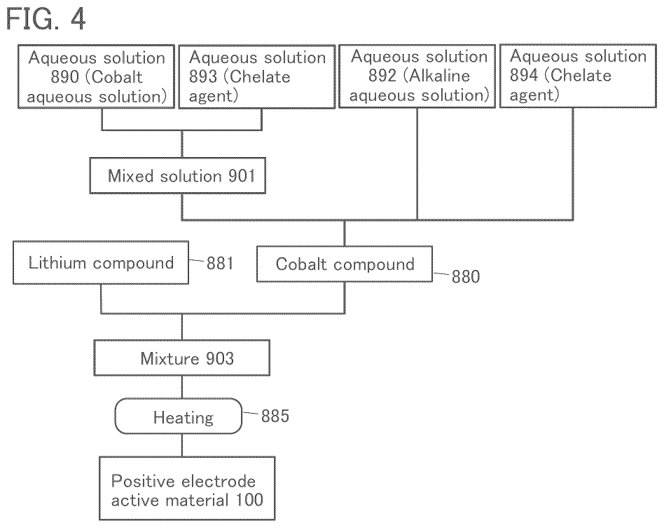

As shown in FIG. 4, a cobalt aqueous solution is prepared as the aqueous solution 890, an alkaline solution is prepared as the aqueous solution 892, and chelate agents are prepared as the aqueous solution 893 and the aqueous solution 894. The aqueous solution 893 is mixed with the aqueous solution 890 to form the mixed solution 901. Without mixing the aqueous solution 894 and the aqueous solution 892 in advance, a reaction is caused between the mixed solution 901 and the aqueous solutions, whereby the cobalt compound 880 is obtained. Specifically, the aqueous solution 894 is put in the reaction container, and then the mixed solution 901 and the aqueous solution 892 are dropped into the reaction container. Other components are similar to those in Formation method 1 described above.

The chelate agent is preferably used, in which case generation of unnecessary crystal nuclei is suppressed to promote the crystal growth of a primary particle. Since generation of unnecessary crystal nuclei is suppressed to inhibit generation of fine particles, a composite oxide with good particle size distribution can be obtained. Furthermore, the use of the chelate agent can slow an acid-base reaction, so that the reaction gradually proceeds to form a nearly spherical secondary particle. The use of the chelate agent is preferable because it is easy to control the pH in the reaction container for obtaining the cobalt compound 880. Glycine has a function of keeping the pH value greater than or equal to 9.0 and less than or equal to 11.0 or the vicinity of the range. Using a glycine aqueous solution as the chelate agent is preferable because it is easy to control the pH of the reaction container for obtaining the cobalt compound 880. Furthermore, the concentration of glycine in the glycine aqueous solution is preferably greater than or equal to 0.05 mol/L and less than or equal to 0.1 mol/L in the aqueous solution 893 or the aqueous solution 894.

Through the above steps, the positive electrode active material 100 such as lithium cobalt oxide can be formed. The shape, particle diameter, or composition of the lithium cobalt oxide can be controlled compared to the case of lithium cobalt oxide formed thoroughly by a solid phase method. Lithium cobalt oxide is sometimes referred to as a cobalt compound or a composite oxide.

The lithium cobalt oxide is preferred in containing few impurities. However, sulfur might be detected from the lithium cobalt oxide, when sulfate is used as a starting material. With use of GD-MS, ICP-MS, or the like, elements in the whole particle of the positive electrode active material can be analyzed to measure the concentration of sulfur.

### <Formation Method 5>

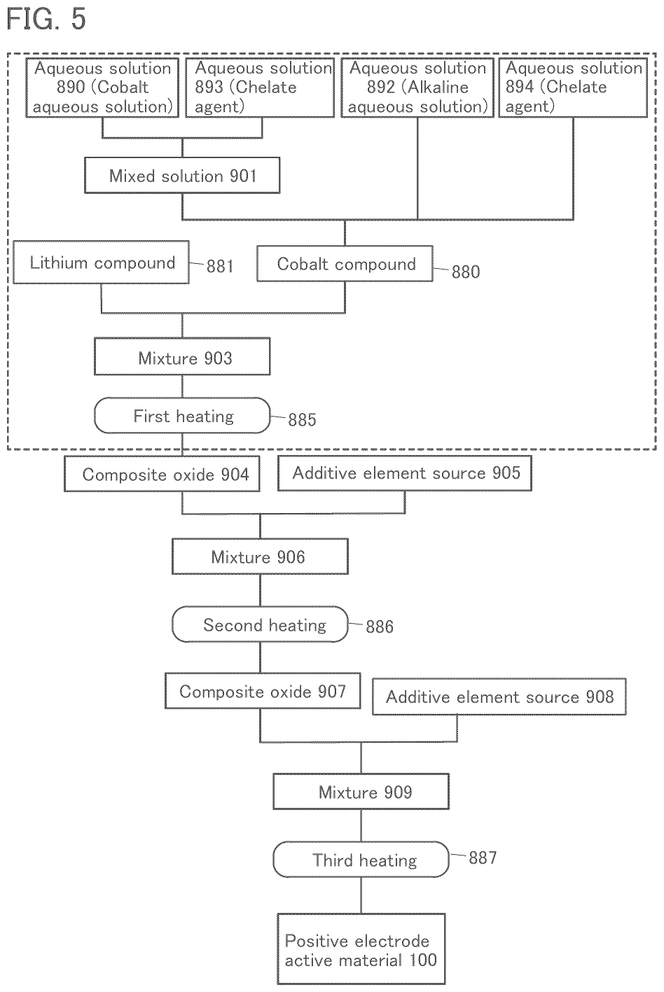

A method for adding an additive element to the positive electrode active material 100 obtained by any of Formation methods 1 to 4 described above will be described with reference to FIG. 5. In FIG. 5, the positive electrode active material 100 obtained in accordance with Formation method 4 described above is denoted by a composite oxide 904 and a method for adding an additive element to the composite oxide 904 is exemplified. Specifically, a method surrounded by a dashed line in FIG. 5 is a method similar to Formation method 4 described above. Note that a method similar to any of Formation methods 1 to 3 described above may be employed as the method surrounded by the dashed line in FIG. 5.

First, an additive element source 905 to be added to the composite oxide 904 is prepared. A lithium source may be prepared together with the additive element source 905.

### <Additive Element>

The additive element source 905 contains an additive element X. The additive element X is added to the composite oxide 904. As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element X, one or more selected from bromine and beryllium can be used. Note that the aforementioned additive elements are more suitable because bromine and beryllium are elements having toxicity to living things.

When magnesium is selected as the additive element X, the additive element source 905 can be referred to as a magnesium source. As the magnesium source, magnesium fluoride (e.g., MgF₂), magnesium oxide (e.g., MgO), magnesium hydroxide (e.g., Mg(OH)₂), magnesium carbonate (e.g., MgCO₃), or the like can be used. Two or more of these magnesium sources may be used.

When fluorine is selected as the additive element X, the additive element source can be referred to as a fluorine source. As the fluorine source, lithium fluoride (e.g., LiF), magnesium fluoride (e.g., MgF₂), aluminum fluoride (e.g., AlF₃), titanium fluoride (e.g., TiF₄), cobalt fluoride (e.g., CoF₂ and CoF₃), nickel fluoride (e.g., NiF₂), zirconium fluoride (e.g., ZrF₄), vanadium fluoride (e.g., VF₅), manganese fluoride, iron fluoride, chromium fluoride, niobium fluoride, zinc fluoride (e.g., ZnF₂), calcium fluoride (e.g., CaF₂), sodium fluoride (e.g., NaF), potassium fluoride (e.g., KF), barium fluoride (e.g., BaF₂), cerium fluoride (e.g., CeF₂), lanthanum fluoride (e.g., LaF₃), sodium aluminum hexafluoride (e.g., Na₃AlF₆), or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used as both the fluorine source and the lithium source. As another lithium source, lithium carbonate is given.

The fluorine source may be a gas, and fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In the case where lithium fluoride and magnesium fluoride are ground and mixed to form the additive element source 905, the molar ratio of the lithium fluoride to the magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that an approximate value means a value greater than 0.9 times and less than 1.1 times a certain value.

The grinding of the additive element source 905 and the mixing in the case of using two or more kinds of additive element sources can be performed by a dry process or a wet process. A wet process is preferred because it can crush a material into a smaller size. When a wet process is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. Dehydrated acetone with purity higher than or equal to 99.5% is preferably used. With the use of dehydrated acetone with the above-described purity, impurities that might be mixed can be reduced.

A mortar, a ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the rotational frequency is preferably higher than or equal to 300 rpm and lower than or equal to 500 rpm in order to inhibit contamination from the media.

Although two kinds of additive element sources are prepared in the example described above, one kind or three or more kinds of additive element sources may be used.

When the additive element source 905 that has been subjected to the mixing and grinding is collected, classification may be performed using a sieve with an aperture diameter of greater than or equal to 250 m and less than or equal to 350 m. Note that in the case of employing a wet process, a solvent is preferably dried before the classification is performed using a sieve.

As the addition method of the additive element X, a solid phase method, a liquid phase method such as a sol-gel method, a sputtering method, an evaporation method, a CVD (chemical vapor deposition) method, a PLD (pulsed laser deposition) method, or the like can be employed.

The solid phase method is exemplified. First, a mixture 906 of the additive element source 905 and the composite oxide 904 is formed. Mixing for the mixture 906 can be performed by a dry process or a wet process. For the dry and wet processes and a means of the mixing or the like, the mixing of the additive element source is referred to. Note that in order to prevent the composite oxide 904 from being damaged, the rotational frequency in the mixing or the like is preferably higher than or equal to 100 rpm and lower than or equal to 200 rpm.

Next, second heating 886 is performed on the mixture 906. Any of the conditions of the first heating 885 can be selected to perform the second heating 886.

Here, a supplementary explanation of the heating temperature is provided. The temperature of the second heating 886 needs to be higher than or equal to the temperature at which a reaction between the composite oxide 904 and the additive element source 905 proceeds. The temperature at which the reaction proceeds is the temperature at which interdiffusion occurs in the composite oxide 904 and the additive element source 905, and may be lower than the melting temperatures of these materials. It is known that in the case of an oxide as an example, interdiffusion occurs at a temperature that is 0.757 times the melting temperature Tₘ (Tamman temperature T_{d}). Accordingly, it is only required that the heating temperature of the second heating 886 be higher than or equal to 500° C.

Needless to say, a temperature higher than or equal to the temperature at which part of the composite oxide 904 and the additive element source 905 is melted is preferable because the reaction proceeds easily. In the case where LiF and MgF₂ are included as the additive element sources 905, the eutectic point of LiF and MgF₂ is around 742° C., and the temperature of the second heating 886 is preferably higher than or equal to 742° C., i.e., preferably higher than or equal to 700° C. when possible.

In the case where the mixture 906 is obtained by mixing such that LiCoO₂:LiF:MgF₂=100:0.33:1 (molar ratio), an endothermic peak is observed at around 830° C. in differential scanning calorimetry measurement (DSC measurement). Therefore, the temperature of the second heating 886 is further preferably higher than or equal to 830° C.

A higher heating temperature is preferable because it facilitates the reaction, shortens the heating time, and enables high productivity.

The heating temperature is lower than the decomposition temperature of the composite oxide 904 (the decomposition temperature of LiCoO₂ is 1130° C.). At around the decomposition temperature, a slight amount of the composite oxide 904 might be decomposed. Thus, the heating temperature is preferably lower than or equal to 1000° C., further preferably lower than or equal to 950° C., still further preferably lower than or equal to 900° C.

In view of the above, the heating temperature of the second heating 886 is preferably higher than or equal to 500° C. and lower than or equal to 1130° C., further preferably higher than or equal to 700° C. and lower than or equal to 1000° C., still further preferably higher than or equal to 700° C. and lower than or equal to 950° C., yet still further preferably higher than or equal to 700° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 906, the partial pressure of fluorine or a fluoride originating the fluorine source or the like is preferably controlled to be within an appropriate range.

In the formation method described in this embodiment, LiF, which is the fluorine source, functions as flux in some cases. Owing to this function, the temperature of the second heating 886 can be lower than the decomposition temperature of the composite oxide 904, e.g., a temperature higher than or equal to 742° C. and lower than or equal to 950° C., which allows distribution of the additive element X such as magnesium in the surface portion and formation of the positive electrode active material having favorable performance.

However, since LiF in a gas phase has a specific gravity less than that of oxygen, LiF might be sublimated by heating and the sublimation causes a reduction in the amount of LiF in the mixture 906. As a result, the function of flux deteriorates. Thus, heating needs to be performed while the sublimation of LiF is inhibited. Note that even when LiF is not used as the fluorine source or the like, Li at the surface of the composite oxide 904 and F of the fluorine source other than LiF might react to produce LiF, which might be sublimated. Therefore, the sublimation needs to be inhibited also when a fluoride having a higher melting point than LiF is used as the fluorine source other than LiF.

In view of this, in the second heating 886, the mixture 906 is preferably heated in an atmosphere containing LiF, i.e., the mixture 906 is preferably heated in a state where the partial pressure of LiF in a heating furnace is high. Such heating can inhibit sublimation of LiF in the mixture 906.

The second heating is preferably performed such that particles of the mixture 906 are not adhered to one another. Adhesion of the particles of the mixture 906 during the heating might decrease the area of contact with oxygen in the atmosphere and inhibit a path of diffusion of the additive element (e.g., fluorine), thereby hindering distribution of the additive element (e.g., magnesium) in the surface portion.

It is considered that uniform distribution of the additive element (e.g., fluorine) in the surface portion leads to a smooth positive electrode active material with little unevenness. Thus, it is preferable that the particles not be adhered to one another.

In the case of performing the heating with use of a rotary kiln, the heating is preferably performed while entry and exit of oxygen are controlled so that an atmosphere in the kiln contains oxygen. For example, there is a method of suppressing entry and exit of oxygen, i.e., setting the flow rate of oxygen low, after the atmosphere contains oxygen. Specifically, for example, it is preferable that no introduction (no flowing) of oxygen be performed after oxygen is introduced into the kiln first and the atmosphere in the kiln contains oxygen. Flowing of oxygen in the kiln is not preferable because it might cause sublimation of the fluorine source, which prevents maintaining the smoothness of the surface.

In the case of performing the heating with use of a roller hearth kiln, the mixture 906 can be heated in an atmosphere containing LiF with the container containing the mixture 906 covered with a lid, for example.

The material obtained by heating the mixture 906 is collected and crushing is performed as needed, whereby a composite oxide 907 is obtained. Here, the collected materials are preferably made to pass through a sieve. It is preferable to use a sieve with an aperture diameter of greater than or equal to 40 μm and less than or equal to 60 μm.

Addition of the additive element may be divided into two or more steps. In view of this, Formation method 5 describes a method for adding an additive element source 908 to the composite oxide 907.

First, the additive element source 908 to be added to the composite oxide 907 is prepared under the conditions similar to the conditions used for the preparation of the additive element source 905.

The additive element source 908 contains an additive element Y. The additive element Y is added to the composite oxide 907. Any of the elements described as the additive element X can be used as the additive element Y, and the additive element Y is preferably different from the additive element X. As the addition method of the additive element Y, a solid phase method, a liquid phase method such as a sol-gel method, a sputtering method, an evaporation method, a CVD method, a PLD method, or the like can be employed as in the case of the additive element X.

In the case where a solid phase method is employed as the addition method of the additive element Y, a hydroxide is prepared as the additive element source 908. A nickel hydroxide and an aluminum hydroxide are given, for example. In the case where two or more kinds of additive element sources are used, the additive element sources are preferably mixed first. At that time, grinding may be performed on the mixed additive element sources or may be performed while the additive element sources are being mixed. Moreover, a mixture in a heated state may be used as the additive element source 908.

In the case where a sol-gel method is employed as the addition method of the additive element Y, a metal alkoxide can be used as the additive element source 908. In addition to the metal alkoxide, a solvent used for the sol-gel method is prepared. As the solvent, alcohol can be used. In the case of performing addition of aluminum, aluminum isopropoxide can be used as the metal source and isopropanol (2-propanol) can be used as the solvent, for example. In the case of performing addition of zirconium, zirconium(IV) tetrapropoxide can be used as the metal source and isopropanol can be used as the solvent, for example.

In the case where a plurality of elements are contained as the additive element source 908, they may be prepared independently. In some cases, a nickel hydroxide is prepared as a nickel source, aluminum isopropoxide is prepared as an aluminum source, and isopropanol is prepared as the solvent, for example.

The solid phase method is exemplified. First, a mixture 909 of the additive element source 908 and the composite oxide 907 is formed. The mixture 909 can be obtained by a method similar to the formation method of the mixture 906. Note that in order to prevent the composite oxide 907 from being damaged, the rotational frequency in the mixing or the like is preferably higher than or equal to 50 rpm and lower than or equal to 150 rpm.

Next, third heating 887 is performed on the mixture 909. Any of the conditions of the first heating 885 can be selected to perform the third heating 887.

Here, a supplementary explanation of the heating temperature is provided. The heating temperature of the third heating 887 is preferably a temperature equal to the heating temperature of the second heating 886 or a temperature slightly lower than the heating temperature of the second heating 886. Specifically, the heating temperature is preferably higher than or equal to 450° C. and lower than or equal to 1130° C., further preferably higher than or equal to 450° C. and lower than or equal to 1000° C., still further preferably higher than or equal to 450° C. and lower than or equal to 950° C., yet still further preferably higher than or equal to 450° C. and lower than or equal to 900° C. Furthermore, the heating temperature is preferably higher than or equal to 692° C. and lower than or equal to 1130° C., further preferably higher than or equal to 692° C. and lower than or equal to 1000° C., still further preferably higher than or equal to 692° C. and lower than or equal to 950° C., yet still further preferably higher than or equal to 692° C. and lower than or equal to 900° C. Furthermore, the heating temperature is preferably higher than or equal to 750° C. and lower than or equal to 1000° C., further preferably higher than or equal to 780° C. and lower than or equal to 1130° C., still further preferably higher than or equal to 780° C. and lower than or equal to 1000° C., yet still further preferably higher than or equal to 780° C. and lower than or equal to 950° C., yet still further preferably higher than or equal to 780° C. and lower than or equal to 900° C. The heating time is preferably longer than or equal to 3 hours and shorter than or equal to 50 hours, further preferably longer than or equal to 5 hours and shorter than or equal to 15 hours, for example.

Next, as in the case of the composite oxide 907, the heated material is crushed in a mortar to make particle diameters equal to each other, and then collected. Furthermore, as in the case of the composite oxide 907, classification may be performed using a sieve.

In such a manner, the positive electrode active material 100 to which the additive element is added can be obtained.

### <Formation Method 6>

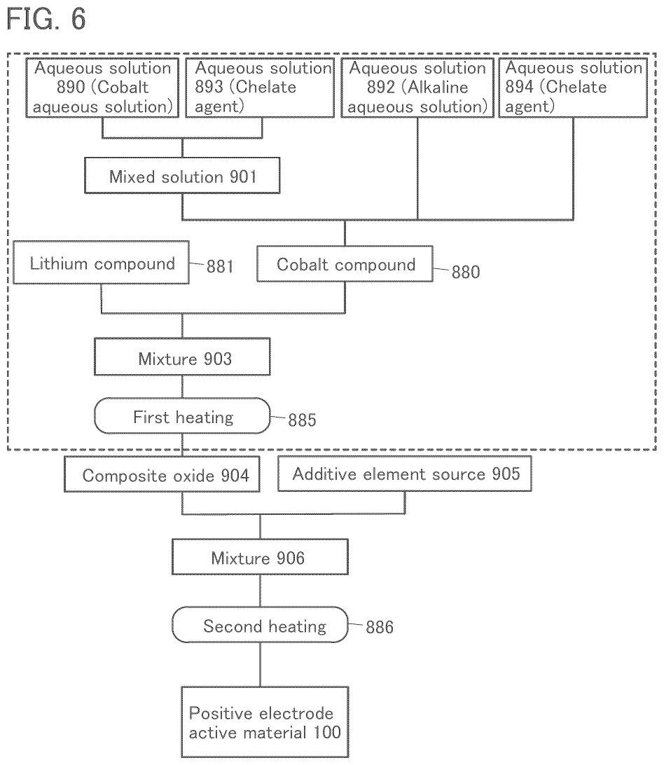

The case where the composite oxide 907 obtained by Formation method 5 described above is used as the positive electrode active material 100 is described with reference to FIG. 6. In that case, description of FIG. 5 may be referred to.

In FIG. 6, the positive electrode active material 100 obtained in accordance with Formation method 4 described above is denoted by the composite oxide 904 and a method for adding an additive element to the composite oxide 904 is exemplified. Specifically, a method surrounded by a dashed line in FIG. 6 is a method similar to Formation method 4 described above. Note that a method similar to any of Formation methods 1 to 3 described above may be employed as the method surrounded by the dashed line in FIG. 6.

The positive electrode active material 100 can be obtained in a manner similar to that in Formation method 5 described above. It is preferable that crushing be performed in a mortar to loosen sintered particles or make particle diameters equal to each other, and then the particles be collected. Furthermore, classification may be performed using a sieve. Other steps are similar to those of Formation method 5.

### <Formation Method 7>

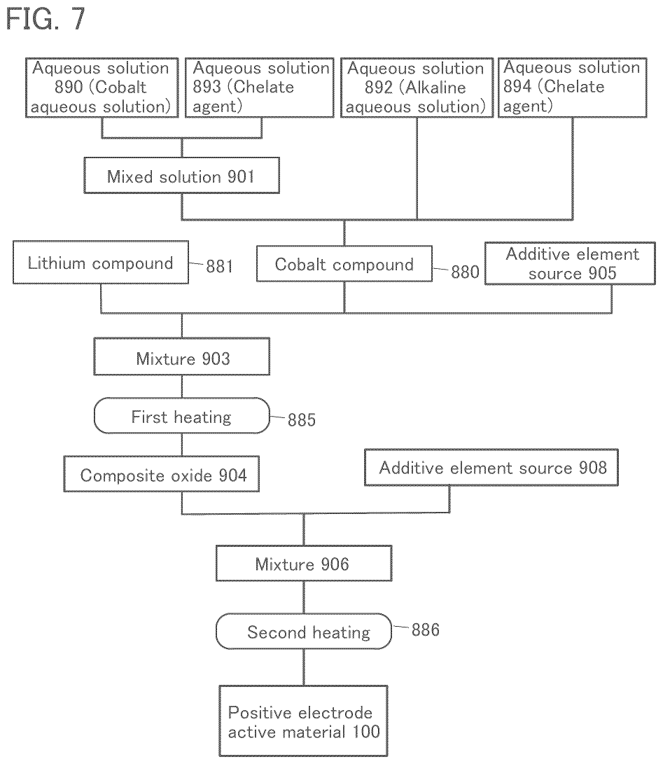

A formation method in which the additive element source 905 is added at a timing different from that in Formation method 5 described above is described with reference to FIG. 7. In that case, description of FIG. 5 may be referred to.

As shown in FIG. 7, the additive element source 905 is added at the same timing as mixing of the lithium compound 881 and the cobalt compound 880. In the case where hydroxides are used as the lithium compound 881 and the cobalt compound 880, a hydroxide containing the additive element X is preferably used as the additive element source 905.

By adding the additive element source 905 at the above-described timing, the additive element X is likely to exist in an inner portion (bulk) of a cobalt oxide to be a positive electrode active material. After the addition, the first heating 885 is preferably performed.

After that, by adding the additive element source 908, the additive element Y is likely to exist in a surface portion of the cobalt oxide. After the addition, the second heating 886 is preferably performed.

Note that in Formation method 7, the additive element source 908 is not necessarily added.

The positive electrode active material 100 can be obtained in a manner similar to that in Formation method 5 described above. It is preferable that crushing be performed in a mortar to loosen sintered particles or make particle diameters equal to each other, and then the particles be collected. Furthermore, classification may be performed using a sieve. Other steps are similar to those of Formation method 5.

### <Formation Method 8>

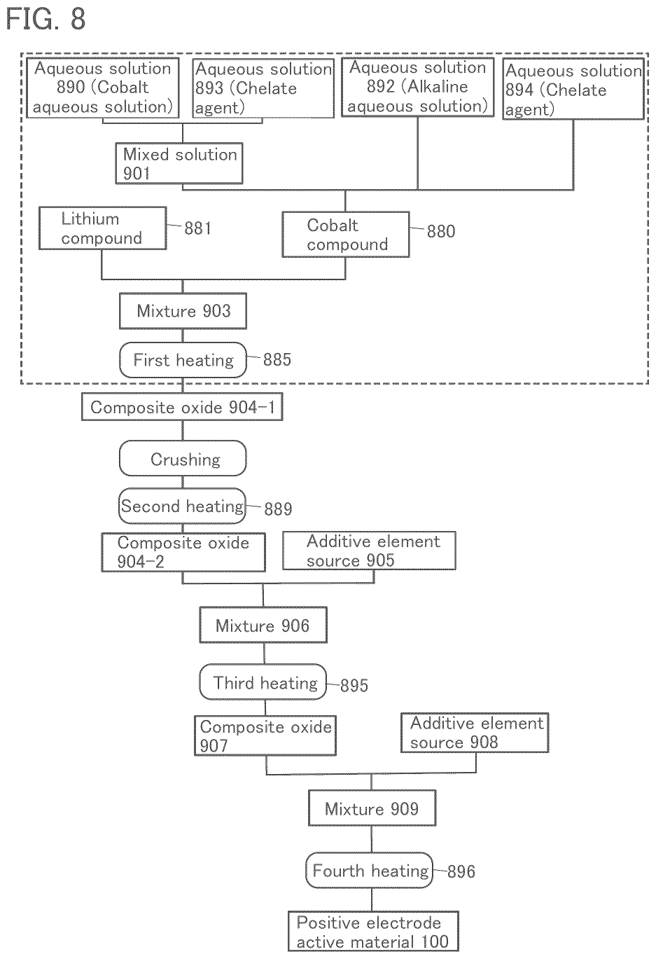

A method for adding an additive element to the positive electrode active material obtained by any of Formation methods 1 to 4 described above will be described with reference to FIG. 8. In FIG. 8, the positive electrode active material 100 obtained in accordance with Formation method 4 described above is denoted by a composite oxide 904-1 and a method for adding an additive element to the composite oxide 904-1 is exemplified. Specifically, a method surrounded by a dashed line in FIG. 8 is a method similar to Formation method 4 described above. Note that a method similar to any of Formation methods 1 to 3 described above may be employed as the method surrounded by the dashed line in FIG. 8.

First, the composite oxide 904-1 is crushed. The crushing can be performed by a dry process or a wet process. A wet process is preferred because it can crush a material into a smaller size. When a wet process is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. Dehydrated acetone with purity higher than or equal to 99.5% is preferably used. With the use of dehydrated acetone with the above-described purity, impurities that might be mixed can be reduced.

A mortar, a ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the rotational frequency is preferably higher than or equal to 300 rpm and lower than or equal to 500 rpm in order to inhibit contamination from the media.

### <Initial Heating>

Then, second heating 889 is performed. The heating is the first heating performed on the composite oxide and thus, this heating is referred to as initial heating. Through the initial heating, the surface of the composite oxide is made smooth. A smooth surface refers to a state where the composite oxide has little unevenness on its surface, the composite oxide is rounded as a whole, and a corner portion is rounded. Being smooth refers to a state where few foreign matters are attached to the surface. Foreign matters are deemed to cause unevenness and are preferably not attached to a surface.

The initial heating is heating performed after a composite oxide is obtained, and the initial heating for making the surface smooth can reduce degradation after charging and discharging in some cases. The initial heating for making the surface smooth does not need a lithium source.

Alternatively, the initial heating for making the surface smooth does not need an additive element source.

Alternatively, the initial heating for making the surface smooth does not need a flux agent.

The initial heating is sometimes referred to as preheating or pretreatment.

Impurities are sometimes mixed into the lithium source, and the initial heating can reduce the impurities of the composite oxide.

The heating conditions of the initial heating can be freely set as long as the surface of the above composite oxide is made smooth. For example, any of the heating conditions described for the first heating can be selected. For example, the heating is preferably performed at a temperature higher than or equal to 700° C. and lower than 1000° C. for longer than or equal to 2 hours. Additionally, the heating temperature of the initial heating is preferably lower than the temperature of the first heating so that the crystal structure of the composite oxide is maintained. The heating time of the initial heating is preferably shorter than the time of the first heating so that the crystal structure of the composite oxide is maintained.

In a secondary battery including a composite oxide with a smooth surface as a positive electrode active material, degradation by charging and discharging is suppressed and a crack in the positive electrode active material can be prevented.

It can be said that when surface unevenness information in one cross section of a composite oxide is converted into numbers with measurement data, a smooth surface of the composite oxide has a surface roughness of at least less than or equal to 10 nm. The one cross section is, for example, a cross section obtained in observation using a scanning transmission electron microscope (STEM).

After the second heating 889, a composite oxide 904-2 can be obtained.

Next, the additive element source (X source) 905 to be added to the composite oxide 904-2 is prepared. A lithium source may be prepared together with the additive element source.

### <Additive Element>

The additive element source (X source) 905 contains the additive element X. The additive element X is added to the composite oxide 904-2. As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element X, one or more selected from bromine and beryllium can be used. Note that the aforementioned additive elements are more suitable because bromine and beryllium are elements having toxicity to living things.

When magnesium is selected as the additive element X, the additive element source (X source) can be referred to as a magnesium source. As the magnesium source, magnesium fluoride (e.g., MgF₂), magnesium oxide (e.g., MgO), magnesium hydroxide (e.g., Mg(OH)₂), magnesium carbonate (e.g., MgCO₃), or the like can be used. Two or more of these magnesium sources may be used.

When fluorine is selected as the additive element X, the additive element source can be referred to as a fluorine source. As the fluorine source, lithium fluoride (e.g., LiF), magnesium fluoride (e.g., MgF₂), aluminum fluoride (e.g., AlF₃), titanium fluoride (e.g., TiF₄), cobalt fluoride (e.g., CoF₂ and CoF₃), nickel fluoride (e.g., NiF₂), zirconium fluoride (e.g., ZrF₄), vanadium fluoride (e.g., VF₅), manganese fluoride, iron fluoride, chromium fluoride, niobium fluoride, zinc fluoride (e.g., ZnF₂), calcium fluoride (e.g., CaF₂), sodium fluoride (e.g., NaF), potassium fluoride (e.g., KF), barium fluoride (e.g., BaF₂), cerium fluoride (e.g., CeF₂), lanthanum fluoride (e.g., LaF₃), sodium aluminum hexafluoride (e.g., Na₃AlF₆), or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used as both the fluorine source and the lithium source. As another lithium source, lithium carbonate is given.

The fluorine source may be a gas, and fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In the case where lithium fluoride and magnesium fluoride are ground and mixed to form the additive element source (X source), the molar ratio of the lithium fluoride to the magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that an approximate value means a value greater than 0.9 times and less than 1.1 times a certain value.

In grinding of the additive element source (X source) 905 and mixing in the case of using two or more kinds of additive element sources, the additive element sources are mixed first. Mixing is performed by a method in which raw materials are mixed while being ground or a method in which raw materials are mixed without being ground. Therefore, the two or more kinds of additive element sources may be ground while being mixed.

The grinding of the additive element source (X source) 905 and the mixing in the case of using two or more kinds of additive element sources can be performed by a dry process or a wet process. A wet process is preferred because it can crush a material into a smaller size. When a wet process is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. Dehydrated acetone with purity higher than or equal to 99.5% is preferably used. With the use of dehydrated acetone with the above-described purity, impurities that might be mixed can be reduced.

A ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the rotational frequency is preferably higher than or equal to 300 rpm and lower than or equal to 500 rpm in order to inhibit contamination from the media.

Although two kinds of additive element sources are prepared in the example described above, one kind or three or more kinds of additive element sources may be used.

When the additive element source 905 (X source) that has been subjected to the mixing and grinding is collected, classification may be performed using a sieve with an aperture diameter of greater than or equal to 250 m and less than or equal to 350 m.

As the addition method of the additive element X, a solid phase method, a liquid phase method such as a sol-gel method, a sputtering method, an evaporation method, a CVD (chemical vapor deposition) method, a PLD (pulsed laser deposition) method, or the like can be employed.

The solid phase method is exemplified. First, a mixture 906 of the additive element source (X source) 905 and the composite oxide 904-2 is formed. Mixing for the mixture 906 can be performed by a dry process or a wet process. For the dry and wet processes and a means of the mixing or the like, the mixing of the additive element source is referred to. Note that in order to prevent the composite oxide 904-2 from being damaged, the rotational frequency in the mixing or the like is preferably higher than or equal to 100 rpm and lower than or equal to 200 rpm.

Next, third heating 895 is performed on the mixture 906. Any of the conditions of the first heating 885 can be selected to perform the third heating 895.

Here, a supplementary explanation of the heating temperature is provided. The temperature of the third heating 895 needs to be higher than or equal to the temperature at which a reaction between the composite oxide 904-2 and the additive element source (X source) 905 proceeds. The temperature at which the reaction proceeds is the temperature at which interdiffusion occurs in the composite oxide 904-2 and the additive element source 905, and may be lower than the melting temperatures of these materials. It is known that in the case of an oxide as an example, interdiffusion occurs at a temperature that is 0.757 times the melting temperature Tₘ (Tamman temperature T_{d}). Accordingly, it is only required that the heating temperature of the third heating 895 be higher than or equal to 500° C.

Needless to say, a temperature higher than or equal to the temperature at which part of the composite oxide 904-2 and the additive element source (X source) 905 is melted is preferable because the reaction proceeds easily. In the case where LiF and MgF₂ are included as the additive element sources (X source) 905, the eutectic point of LiF and MgF₂ is around 742° C., and the temperature of the third heating 895 is preferably higher than or equal to 742° C., i.e., preferably higher than or equal to 700° C. when possible.

In the case where the mixture 906 is obtained by mixing such that LiCoO₂:LiF:MgF₂=100:0.33:1 (molar ratio), an endothermic peak is observed at around 830° C. in differential scanning calorimetry measurement (DSC measurement). Therefore, the temperature of the third heating 895 is further preferably higher than or equal to 830° C.

A higher heating temperature is preferable because it facilitates the reaction, shortens the heating time, and enables high productivity.

The heating temperature is lower than the decomposition temperature of the composite oxide 904-2 (the decomposition temperature of LiCoO₂ is 1130° C.). At around the decomposition temperature, a slight amount of the composite oxide 904-2 might be decomposed. Thus, the heating temperature is preferably lower than or equal to 1000° C., further preferably lower than or equal to 950° C., still further preferably lower than or equal to 900° C.

In view of the above, the heating temperature of the third heating 895 is preferably higher than or equal to 500° C. and lower than or equal to 1130° C., further preferably higher than or equal to 700° C. and lower than or equal to 1000° C., still further preferably higher than or equal to 700° C. and lower than or equal to 950° C., yet still further preferably higher than or equal to 700° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C.

In addition, at the time of heating the mixture 906, the partial pressure of fluorine or a fluoride originating the fluorine source or the like is preferably controlled to be within an appropriate range.

In the formation method described in this embodiment, LiF, which is the fluorine source, functions as flux in some cases. Owing to this function, the temperature of the third heating 895 can be lower than the decomposition temperature of the composite oxide 904-2, e.g., a temperature higher than or equal to 742° C. and lower than or equal to 950° C., which allows distribution of the additive element X such as magnesium in the surface portion and formation of the positive electrode active material having favorable performance.

However, since LiF in a gas phase has a specific gravity less than that of oxygen, LiF might be sublimated by heating and the sublimation causes a reduction in the amount of LiF in the mixture 906. As a result, the function of flux deteriorates. Thus, heating needs to be performed while the sublimation of LiF is inhibited. Note that even when LiF is not used as the fluorine source or the like, Li at the surface of the composite oxide 904-2 and F of the fluorine source other than LiF might react to produce LiF, which might be sublimated. Therefore, the sublimation needs to be inhibited also when a fluoride having a higher melting point than LiF is used as the fluorine source other than LiF.

In view of this, the mixture 906 is preferably heated in an atmosphere containing LiF, i.e., the mixture 906 is preferably heated in a state where the partial pressure of LiF in a heating furnace is high. Such heating can inhibit sublimation of LiF in the mixture 906.

The third heating 895 is preferably performed such that particles of the mixture 906 are not adhered to one another. Adhesion of the particles of the mixture 906 during the heating might decrease the area of contact with oxygen in the atmosphere and inhibit a path of diffusion of the additive element (e.g., fluorine), thereby hindering distribution of the additive element (e.g., magnesium) in the surface portion.

It is considered that uniform distribution of the additive element (e.g., fluorine) in the surface portion leads to a smooth positive electrode active material with little unevenness. Thus, it is preferable that the particles not be adhered to one another.

In the case of performing the heating with use of a rotary kiln, the heating is preferably performed while entry and exit of oxygen are controlled so that an atmosphere in the kiln contains oxygen. For example, there is a method of suppressing entry and exit of oxygen, i.e., setting the flow rate of oxygen low, after the atmosphere contains oxygen. Specifically, for example, it is preferable that no introduction (no flowing) of oxygen be performed after oxygen is introduced into the kiln first and the atmosphere in the kiln contains oxygen. Flowing of oxygen in the kiln is not preferable because it might cause sublimation of the fluorine source, which prevents maintaining the smoothness of the surface.

In the case of performing the heating with use of a roller hearth kiln, the mixture 906 can be heated in an atmosphere containing LiF with the container containing the mixture 906 covered with a lid, for example.

The material obtained by heating the mixture 906 is collected and crushing is performed as needed, whereby a composite oxide 907 is obtained. Here, the collected materials are preferably made to pass through a sieve.

Addition of the additive element may be divided into two or more steps. In view of this, Formation method 8 describes a method for adding an additive element source (Y source) to the composite oxide 907.

First, a second additive element source (Y source) 908 to be added to the composite oxide 907 is prepared. A lithium source may be prepared together with the second additive element source.

The second additive element source (Y source) 908 contains the additive element Y. The additive element Y is added to the composite oxide 907. Any of the elements described as the additive element X can be used as the additive element Y, and the additive element Y is preferably different from the additive element X. As the addition method of the additive element Y, a solid phase method, a liquid phase method such as a sol-gel method, a sputtering method, an evaporation method, a CVD method, a PLD method, or the like can be employed as in the case of the additive element X.

In the case where a solid phase method is employed as the addition method of the additive element Y, a hydroxide is prepared as the second additive element source (Y source). A nickel hydroxide and an aluminum hydroxide are given, for example. In the case where two or more kinds of additive element sources are used, the additive element sources are mixed first. Mixing is performed by a method in which raw materials are mixed while being ground or a method in which raw materials are mixed without being ground. Therefore, additive element sources may be ground while being mixed. Moreover, a mixture in a heated state may be used as the second additive element source (Y source) 908.

In the case where a sol-gel method is employed as the addition method of the additive element Y, a metal alkoxide can be used as the second additive element source (Y source). In addition to the metal alkoxide, a solvent used for the sol-gel method is prepared. As the solvent, alcohol can be used. In the case of performing addition of aluminum, aluminum isopropoxide can be used as the metal source and isopropanol (2-propanol) can be used as the solvent, for example. In the case of performing addition of zirconium, zirconium(IV) tetrapropoxide can be used as the metal source and isopropanol can be used as the solvent, for example.

In the case where a plurality of elements are contained as the second additive element source (Y source), they may be prepared independently. In some cases, a nickel hydroxide is prepared as a nickel source, aluminum isopropoxide is prepared as an aluminum source, and isopropanol is prepared, for example.

The solid phase method is exemplified. First, a mixture 909 of the second additive element source (Y source) 908 and the composite oxide 907 is formed. The composite oxide 907 can be obtained by a method similar to the formation method of the mixture 906. Note that in order to prevent the composite oxide 907 from being damaged, the rotational frequency in the mixing or the like is preferably higher than or equal to 50 rpm and lower than or equal to 150 rpm.

Next, fourth heating 896 is performed on the mixture 909. Any of the conditions of the first heating 885 can be selected to perform the fourth heating 896. Additionally, in consideration of the melting point of the additive element source (Y source) 908, the heating temperature of the fourth heating 896 is preferably a temperature equal to or lower than the heating temperature of the third heating 895.

Through the above steps, the positive electrode active material 100 such as lithium cobalt oxide can be formed. The shape, particle diameter, or composition of the lithium cobalt oxide can be controlled compared to the case of lithium cobalt oxide formed thoroughly by a solid phase method. Lithium cobalt oxide is sometimes referred to as a cobalt compound or a composite oxide.

The lithium cobalt oxide is preferred in containing few impurities. However, sulfur might be detected from the lithium cobalt oxide, when sulfate is used as a starting material. With use of GD-MS, ICP-MS, or the like, elements in the whole particle of the positive electrode active material can be analyzed to measure the concentration of sulfur.

### <Formation Method 9>

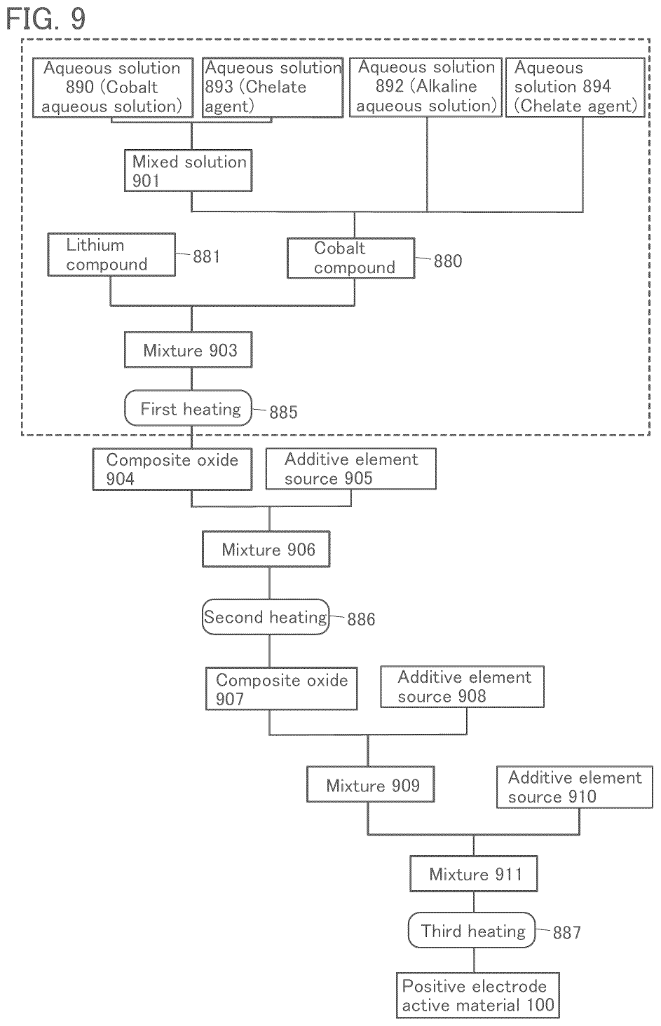

A method for adding an additive element to the positive electrode active material 100 obtained by any of Formation methods 1 to 4 described above will be described with reference to FIG. 9. In FIG. 9, the positive electrode active material 100 obtained in accordance with Formation method 4 described above is denoted by the composite oxide 904 and a method for adding an additive element to the composite oxide 904 is exemplified. Specifically, a method surrounded by a dashed line in FIG. 9 is a method similar to Formation method 4 described above. Note that a method similar to any of Formation methods 1 to 3 described above may be employed as the method surrounded by the dashed line in FIG. 9.

First, an additive element source 905 to be added to the composite oxide 904 is prepared. A lithium source may be prepared together with the additive element source 905.

### <Additive Element>

The additive element source 905 contains the additive element X. The additive element X is added to the composite oxide 904. As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element X, one or more selected from bromine and beryllium can be used. Note that the aforementioned additive elements are more suitable because bromine and beryllium are elements having toxicity to living things.

When magnesium is selected as the additive element X, the additive element source 905 can be referred to as a magnesium source. As the magnesium source, magnesium fluoride (e.g., MgF₂), magnesium oxide (e.g., MgO), magnesium hydroxide (e.g., Mg(OH)₂), magnesium carbonate (e.g., MgCO₃), or the like can be used. Two or more of these magnesium sources may be used.

When fluorine is selected as the additive element X, the additive element source can be referred to as a fluorine source. As the fluorine source, lithium fluoride (e.g., LiF), magnesium fluoride (e.g., MgF₂), aluminum fluoride (e.g., AlF₃), titanium fluoride (e.g., TiF₄), cobalt fluoride (e.g., CoF₂ and CoF₃), nickel fluoride (e.g., NiF₂), zirconium fluoride (e.g., ZrF₄), vanadium fluoride (e.g., VF₅), manganese fluoride, iron fluoride, chromium fluoride, niobium fluoride, zinc fluoride (e.g., ZnF₂), calcium fluoride (e.g., CaF₂), sodium fluoride (e.g., NaF), potassium fluoride (e.g., KF), barium fluoride (e.g., BaF₂), cerium fluoride (e.g., CeF₂), lanthanum fluoride (e.g., LaF₃), sodium aluminum hexafluoride (e.g., Na₃AlF₆), or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used as both the fluorine source and the lithium source. As another lithium source, lithium carbonate is given.

The fluorine source may be a gas, and fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In the case where lithium fluoride and magnesium fluoride are ground and mixed to form the additive element source 905, the molar ratio of the lithium fluoride to the magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that an approximate value means a value greater than 0.9 times and less than 1.1 times a certain value.

The grinding of the additive element source 905 and the mixing in the case of using two or more kinds of additive element sources can be performed by a dry process or a wet process. A wet process is preferred because it can crush a material into a smaller size. When a wet process is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. Dehydrated acetone with purity higher than or equal to 99.5% is preferably used. With the use of dehydrated acetone with the above-described purity, impurities that might be mixed can be reduced.

A mortar, a ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the rotational frequency is preferably higher than or equal to 300 rpm and lower than or equal to 500 rpm in order to inhibit contamination from the media.

Although two kinds of additive element sources are prepared in the example described above, one kind or three or more kinds of additive element sources may be used.

When the additive element source 905 that has been subjected to the mixing and grinding is collected, classification may be performed using a sieve with an aperture diameter of greater than or equal to 250 μm and less than or equal to 350 μm.

As the addition method of the additive element X, a solid phase method, a liquid phase method such as a sol-gel method, a sputtering method, an evaporation method, a CVD (chemical vapor deposition) method, a PLD (pulsed laser deposition) method, or the like can be employed.

The solid phase method is exemplified. First, a mixture 906 of the additive element source 905 and the composite oxide 904 is formed. Mixing for the mixture 906 can be performed by a dry process or a wet process. For the dry and wet processes and a means of the mixing or the like, the mixing of the additive element source is referred to. Note that in order to prevent the composite oxide 904 from being damaged, the rotational frequency in the mixing or the like is preferably higher than or equal to 100 rpm and lower than or equal to 200 rpm.

Next, second heating 886 is performed on the mixture 906. Any of the conditions of the first heating 885 can be selected to perform the second heating 886.

Here, a supplementary explanation of the heating temperature is provided. The temperature of the second heating 886 needs to be higher than or equal to the temperature at which a reaction between the composite oxide 904 and the additive element source 905 proceeds. The temperature at which the reaction proceeds is the temperature at which interdiffusion occurs in the composite oxide 904 and the additive element source 905, and may be lower than the melting temperatures of these materials. It is known that in the case of an oxide as an example, interdiffusion occurs at a temperature that is 0.757 times the melting temperature Tₘ (Tamman temperature T_{d}). Accordingly, it is only required that the heating temperature of the second heating 886 be higher than or equal to 500° C.

Needless to say, a temperature higher than or equal to the temperature at which part of the composite oxide 904 and the additive element source 905 is melted is preferable because the reaction proceeds easily. In the case where LiF and MgF₂ are included as the additive element sources 905, the eutectic point of LiF and MgF₂ is around 742° C., and the temperature of the second heating 886 is preferably higher than or equal to 742° C., i.e., preferably higher than or equal to 700° C. when possible.

In the case where the mixture 906 is obtained by mixing such that LiCoO₂:LiF:MgF₂=100:0.33:1 (molar ratio), an endothermic peak is observed at around 830° C. in differential scanning calorimetry measurement (DSC measurement). Therefore, the temperature of the second heating 886 is further preferably higher than or equal to 830° C.

A higher heating temperature is preferable because it facilitates the reaction, shortens the heating time, and enables high productivity.

The heating temperature is lower than the decomposition temperature of the composite oxide 904 (the decomposition temperature of LiCoO₂ is 1130° C.). At around the decomposition temperature, a slight amount of the composite oxide 904 might be decomposed. Thus, the heating temperature is preferably lower than or equal to 1000° C., further preferably lower than or equal to 950° C., still further preferably lower than or equal to 900° C.

In view of the above, the heating temperature of the second heating 886 is preferably higher than or equal to 500° C. and lower than or equal to 1130° C., further preferably higher than or equal to 700° C. and lower than or equal to 1000° C., still further preferably higher than or equal to 700° C. and lower than or equal to 950° C., yet still further preferably higher than or equal to 700° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C.

In addition, at the time of heating the mixture 906, the partial pressure of fluorine or a fluoride originating the fluorine source or the like is preferably controlled to be within an appropriate range.

In the formation method described in this embodiment, LiF, which is the fluorine source, functions as flux in some cases. Owing to this function, the temperature of the second heating 886 can be lower than the decomposition temperature of the composite oxide 904, e.g., a temperature higher than or equal to 742° C. and lower than or equal to 950° C., which allows distribution of the additive element X such as magnesium in the surface portion and formation of the positive electrode active material having favorable performance.

However, since LiF in a gas phase has a specific gravity less than that of oxygen, LiF might be sublimated by heating and the sublimation causes a reduction in the amount of LiF in the mixture 906. As a result, the function of flux deteriorates. Thus, heating needs to be performed while the sublimation of LiF is inhibited. Note that even when LiF is not used as the fluorine source or the like, Li at the surface of the composite oxide 904 and F of the fluorine source other than LiF might react to produce LiF, which might be sublimated. Therefore, the sublimation needs to be inhibited also when a fluoride having a higher melting point than LiF is used as the fluorine source other than LiF.

In view of this, the mixture 906 is preferably heated in an atmosphere containing LiF, i.e., the mixture 906 is preferably heated in a state where the partial pressure of LiF in a heating furnace is high. Such heating can inhibit sublimation of LiF in the mixture 906.

The second heating 886 is preferably performed such that particles of the mixture 906 are not adhered to one another. Adhesion of the particles of the mixture 906 during the heating might decrease the area of contact with oxygen in the atmosphere and inhibit a path of diffusion of the additive element (e.g., fluorine), thereby hindering distribution of the additive element (e.g., magnesium) in the surface portion.

It is considered that uniform distribution of the additive element (e.g., fluorine) in the surface portion leads to a smooth positive electrode active material with little unevenness. Thus, it is preferable that the particles not be adhered to one another.

In the case of performing the heating with use of a rotary kiln, the heating is preferably performed while entry and exit of oxygen are controlled so that an atmosphere in the kiln contains oxygen. For example, there is a method of suppressing entry and exit of oxygen, i.e., setting the flow rate of oxygen low, after the atmosphere contains oxygen. Specifically, for example, it is preferable that no introduction (no flowing) of oxygen be performed after oxygen is introduced into the kiln first and the atmosphere in the kiln contains oxygen. Flowing of oxygen in the kiln is not preferable because it might cause sublimation of the fluorine source, which prevents maintaining the smoothness of the surface.

In the case of performing the heating with use of a roller hearth kiln, the mixture 906 can be heated in an atmosphere containing LiF with the container containing the mixture 906 covered with a lid, for example.

The material obtained by heating the mixture 906 is collected and crushing is performed as needed, whereby a composite oxide 907 is obtained. Here, the collected materials are preferably made to pass through a sieve. It is preferable to use a sieve with an aperture diameter of greater than or equal to 40 μm and less than or equal to 60 μm.

Next, a method for adding the additive element source 908 to the composite oxide 907 is described.

First, the additive element source 908 to be added to the composite oxide 907 is prepared under the conditions similar to the conditions used for the preparation of the additive element source 905.

The additive element source 908 contains the additive element Y. The additive element Y is added to the composite oxide 907. Any of the elements described as the additive element X can be used as the additive element Y, and the additive element Y is preferably different from the additive element X. As the addition method of the additive element Y, a solid phase method, a liquid phase method such as a sol-gel method, a sputtering method, an evaporation method, a CVD method, a PLD method, or the like can be employed as in the case of the additive element X.

In the case where a solid phase method is employed as the addition method of the additive element Y, a hydroxide is prepared as the additive element source 908. A nickel hydroxide is given, for example. In the case where two or more kinds of additive element sources are used, the additive element sources are mixed first. At that time, grinding may be performed while the additive element sources are mixed.

The solid phase method is exemplified. First, a mixture 909 of the additive element source 908 and the composite oxide 907 is formed. The mixture 909 can be obtained by a method similar to the formation method of the mixture 906. Note that in order to prevent the composite oxide 907 from being damaged, the rotational frequency in the mixing or the like is preferably higher than or equal to 50 rpm and lower than or equal to 150 rpm.

The mixture 909 is collected and crushing is performed as needed. Here, the collected materials are preferably made to pass through a sieve.

Addition of the additive element may be divided into two or more steps. In view of this, a method for adding an additive element source 910 to the mixture 909 is described in this embodiment. At this time, heating is not necessarily performed on the mixture 909. Needless to say, heating may be performed on the mixture 909.

First, the additive element source 910 to be added to the mixture 909 is prepared under the conditions similar to the conditions used for the preparation of the additive element source 905.

The additive element source 910 contains an additive element Z. The additive element Z is added to the mixture 909. Any of the elements described as the additive element X can be used as the additive element Z, and the additive element Z is preferably different from the additive element X and the additive element Y. As the addition method of the additive element Z, a solid phase method, a liquid phase method such as a sol-gel method, a sputtering method, an evaporation method, a CVD method, a PLD method, or the like can be employed as in the case of the additive element X.

In the case where a sol-gel method is employed as the addition method of the additive element Z, a metal alkoxide can be used as the additive element source 910. In addition to the metal alkoxide, a solvent used for the sol-gel method is prepared. As the solvent, alcohol can be used. In the case of performing addition of aluminum, aluminum isopropoxide can be used as the metal source and isopropanol (2-propanol) can be used as the solvent, for example. In the case of performing addition of zirconium, zirconium(IV) tetrapropoxide can be used as the metal source and isopropanol can be used as the solvent, for example.

Next, an isopropanol solution of the zirconium(IV) tetrapropoxide and an isopropanol solution of the aluminum isopropoxide are stirred to form a mixed solution, the mixture 909 is added to the mixed solution, and stirring is performed, for example. The stirring can be performed with a magnetic stirrer, for example. The stirring can be performed for a time long enough for water in the atmosphere and zirconium(IV) tetrapropoxide to develop hydrolysis and a polycondensation reaction, e.g., for 60 hours, at room temperature.

After the above process, a mixture is collected from the mixed solution. As the collection method, filtration, centrifugation, evaporation to dryness, or the like can be used. In this embodiment, evaporation to dryness is used for the collection, whereby a mixture 911 is obtained. In this embodiment, circulation drying at 95° C. is performed.

Next, third heating 887 is performed on the mixture 911. Any of the conditions of the first heating 885 can be selected to perform the third heating 887.

Here, a supplementary explanation of the heating temperature is provided. The heating temperature of the third heating 887 is preferably a temperature equal to the heating temperature of the second heating 886 or a temperature slightly lower than the heating temperature of the second heating 886. Specifically, the heating temperature is preferably higher than or equal to 450° C. and lower than or equal to 1130° C., further preferably higher than or equal to 450° C. and lower than or equal to 1000° C., still further preferably higher than or equal to 450° C. and lower than or equal to 950° C., yet still further preferably higher than or equal to 450° C. and lower than or equal to 900° C. Furthermore, the heating temperature is preferably higher than or equal to 692° C. and lower than or equal to 1130° C., further preferably higher than or equal to 692° C. and lower than or equal to 1000° C., still further preferably higher than or equal to 692° C. and lower than or equal to 950° C., yet still further preferably higher than or equal to 692° C. and lower than or equal to 900° C. Furthermore, the heating temperature is preferably higher than or equal to 750° C. and lower than or equal to 1000° C., further preferably higher than or equal to 780° C. and lower than or equal to 1130° C., still further preferably higher than or equal to 780° C. and lower than or equal to 1000° C., yet still further preferably higher than or equal to 780° C. and lower than or equal to 950° C., yet still further preferably higher than or equal to 780° C. and lower than or equal to 900° C. The heating time is preferably longer than or equal to 3 hours and shorter than or equal to 50 hours, further preferably longer than or equal to 5 hours and shorter than or equal to 15 hours, for example.

Next, as in the case of the composite oxide 907, the heated material is crushed in a mortar to make particle diameters equal to each other, and then collected. Furthermore, as in the case of the composite oxide 907, classification may be performed using a sieve.

In such a manner, the positive electrode active material 100 to which the additive element is added can be obtained.

### <Formation Method 10>

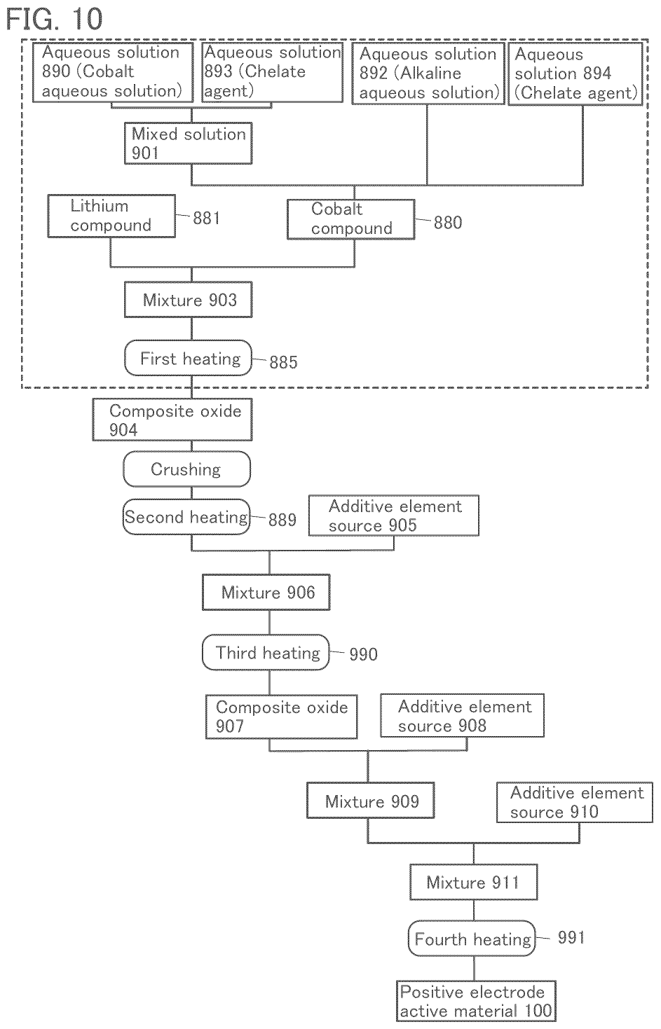

A formation method different from Formation method 5 described above, e.g., a method in which the obtained composite oxide 904 is crushed and another heat treatment (the second heating 889) is performed, is described with reference to FIG. 10. In that case, Formation method 8 described above may be referred to. In FIG. 10, the positive electrode active material 100 obtained in accordance with Formation method 4 described above is denoted by the composite oxide 904 and a method for adding an additive element to the composite oxide 904 is exemplified. Specifically, a method surrounded by a dashed line in FIG. 10 is a method similar to Formation method 4 described above. Note that a method similar to any of Formation methods 1 to 3 described above may be employed as the method surrounded by the dashed line in FIG. 10.

The second heating 889 is the first heating performed on the composite oxide and thus this heating may be referred to as initial heating. Through the initial heating, the surface of the composite oxide is made smooth. A smooth surface refers to a state where the composite oxide has little unevenness on its surface, the composite oxide is rounded as a whole, and a corner portion is rounded. Being smooth refers to a state where few foreign matters are attached to the surface. Foreign matters are deemed to cause unevenness and are preferably not attached to a surface.

The initial heating is heating performed after a composite oxide is obtained, and the initial heating for making the surface smooth can reduce degradation after charging and discharging in some cases. The initial heating for making the surface smooth does not need a lithium source.

Alternatively, the initial heating for making the surface smooth does not need an additive element source.

Alternatively, the initial heating for making the surface smooth does not need a flux agent.

The initial heating is sometimes referred to as preheating or pretreatment.

Impurities are sometimes mixed into the prepared lithium source, and the initial heating can reduce the impurities of the composite oxide.

Impurities are sometimes mixed into also the cobalt source, and the initial heating can reduce the impurities of the composite oxide.

The heating conditions of the initial heating can be freely set as long as the surface of the above composite oxide is made smooth. For example, any of the heating conditions described for the first heating can be selected. Additionally, the heating temperature of the initial heating is preferably lower than the temperature of the first heating so that the crystal structure of the composite oxide is maintained. The heating time of the initial heating is preferably shorter than the time of the first heating so that the crystal structure of the composite oxide is maintained. For example, the heating is preferably performed at a temperature higher than or equal to 700° C. and lower than or equal to 1000° C. for longer than or equal to 2 hours.

In a secondary battery including a composite oxide with a smooth surface as a positive electrode active material, degradation by charging and discharging is suppressed and a crack in the positive electrode active material can be prevented.

It can be said that when surface unevenness information in one cross section of a composite oxide is converted into numbers with measurement data, a smooth surface of the composite oxide has a surface roughness of at least less than or equal to 10 nm. The one cross section is, for example, a cross section obtained in observation using a scanning transmission electron microscope (STEM).

Other steps are similar to those of Formation method 8.

This embodiment can be used in combination with the other embodiments.

### Embodiment 2

In this embodiment, synthesis equipment relating to a coprecipitation method (coprecipitation synthesis equipment) is described. Note that an example is described in which the cobalt compound 880 is formed with use of the mixed solution 901 (including a cobalt aqueous solution), the aqueous solution 892 (an alkaline aqueous solution), and the aqueous solution 894 (a chelate agent) of Formation method 4 described above.

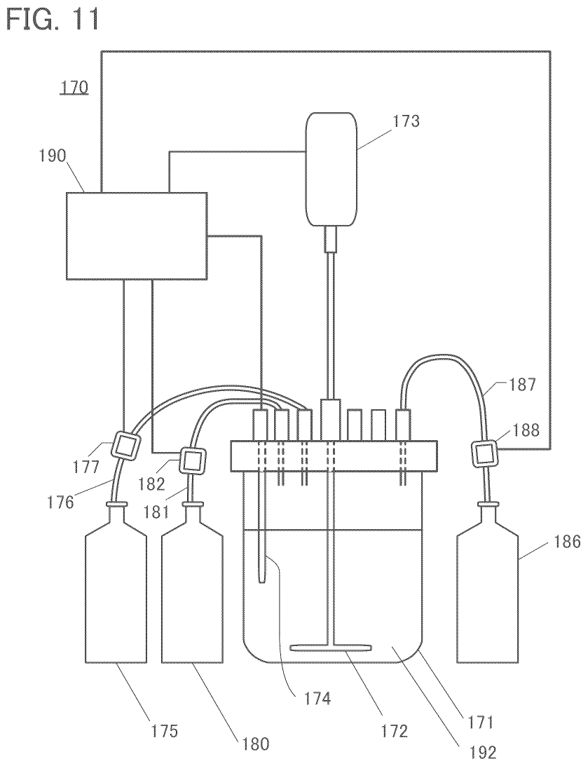

Coprecipitation synthesis equipment 170 illustrated in FIG. 11 includes a reaction container 171. A separable flask is used in the lower part of the reaction container and a separable cover is used in the upper part of the reaction container. The separable flask may be cylindrical or round type. A cylindrical separable flask has a flat bottom. The atmosphere in the reaction container 171 can be controlled with at least one inlet of the separable cover. For example, the atmosphere preferably contains nitrogen.

First, the aqueous solution 894 (a chelate agent) is put in the reaction container 171, and then the mixed solution 901 and the aqueous solution 892 (an alkaline aqueous solution) are dropped into the reaction container 171. The aqueous solution 192 illustrated in FIG. 11 is in the state where dropping has started. Note that the aqueous solution 894 is sometimes referred to as a filling liquid. The filling liquid is described as an adjustment liquid, and denotes an aqueous solution before a reaction, that is, an initial aqueous solution in the reaction container in some cases.

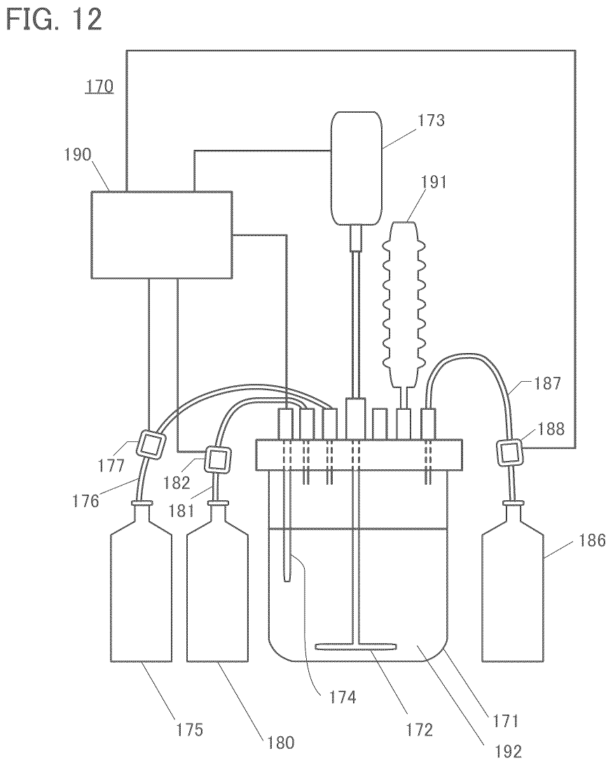

The other components of the coprecipitation synthesis equipment 170 illustrated in FIG. 11 are described. The coprecipitation synthesis equipment 170 is equipped with a stirring portion 172, a stirring motor 173, a thermometer 174, a tank 175, a tube 176, a pump 177, a tank 180, a tube 181, a pump 182, a tank 186, a tube 187, a pump 188, a control device 190, and the like. The coprecipitation synthesis equipment 170 may be equipped with a reflux condenser 191 as illustrated in FIG. 12. The reflux condenser 191 is connected to at least one inlet of the separable cover. With the reflux condenser 191, the atmosphere gas such as nitrogen in the reaction container 171 is evacuated and water can return to the reaction container 171. Note that in FIG. 12, the other components are similar to those in FIG. 11.

The stirring portion 172 can stir the aqueous solution 192 in the reaction container 171, and the stirrer motor 173 is included as a power source that makes the stirring portion 172 rotate. The stirring portion 172 includes a paddle-type stirring blade (denoted as a paddle blade), and the paddle blade includes two to six blades. The blade may have an inclination of greater than or equal to 40° and less than or equal to 70°.

The thermometer 174 can measure the temperature of the aqueous solution 192. The reaction container 171 can be controlled using a thermoelectric element such that the temperature of the aqueous solution 192 is constant. An example of the thermoelectric element is a Peltier element. Although not shown, a pH meter is also provided in the reaction container 171 so as to be in contact with the aqueous solution 192, and the pH of the aqueous solution 192 can be measured.

Different aqueous solutions of raw materials can be pooled in the tanks. For example, the tanks can be filled with the mixed solution 901 and the aqueous solution 892. A tank filled with the aqueous solution 894 serving as a filling liquid may be prepared. Each tank is equipped with a pump and an aqueous solution of a raw material can be dropped into the reaction container 171 through a tube with use of the pump. The dropping amount of the aqueous solution of a raw material, that is the amount of the delivered liquid, can be controlled with the pump. In addition to the pump, a valve may be provided for the tube 176, and the dropping amount of the aqueous solution of a raw material, that is the amount of the delivered liquid, may be controlled.

The control device 190 is electrically connected to the stirrer motor 173, the thermometer 174, the pump 177, the pump 182, and the pump 188, and can control the rotational frequency of the stirring portion 172, the temperature of the aqueous solution 192, the dropping amount of each aqueous solution of a raw material, and the like.

The rotational frequency of the stirring portion 172, specifically, the rotational frequency of the paddle blade is preferably, for example, higher than or equal to 800 rpm and lower than or equal to 1200 rpm. The stirring is preferably performed while the aqueous solution 192 is heated at a temperature higher than or equal to 50° C. and lower than or equal to 90° C. In that case, the mixed solution 901 or the like is preferably dropped into the reaction container 171 at a constant rate. Needless to say, the rotational frequency of the paddle blade is not limited to a constant number, and can be appropriately adjusted. For example, the rotational frequency can be changed depending on the amount of liquid in the reaction container 171. Moreover, the dropping rate of the mixed solution 901 or the like can be adjusted. The dropping rate is preferably controlled to keep the pH of the reaction container 171 constant. The dropping rates may be controlled so that the aqueous solution 892 is dropped when the pH is changed from a desired pH value during dropping of the mixed solution 901. The pH value is within the range of 9.0 to 13.0, preferably 9.8 to 12.5.

Through the above process, a reaction product is precipitated in the reaction container 171. The reaction product includes a cobalt compound. This reaction can be referred to as coprecipitation or co-precipitation, and this step is referred to as a coprecipitation step in some cases.

This embodiment can be used in combination with the other embodiments.

### Embodiment 3

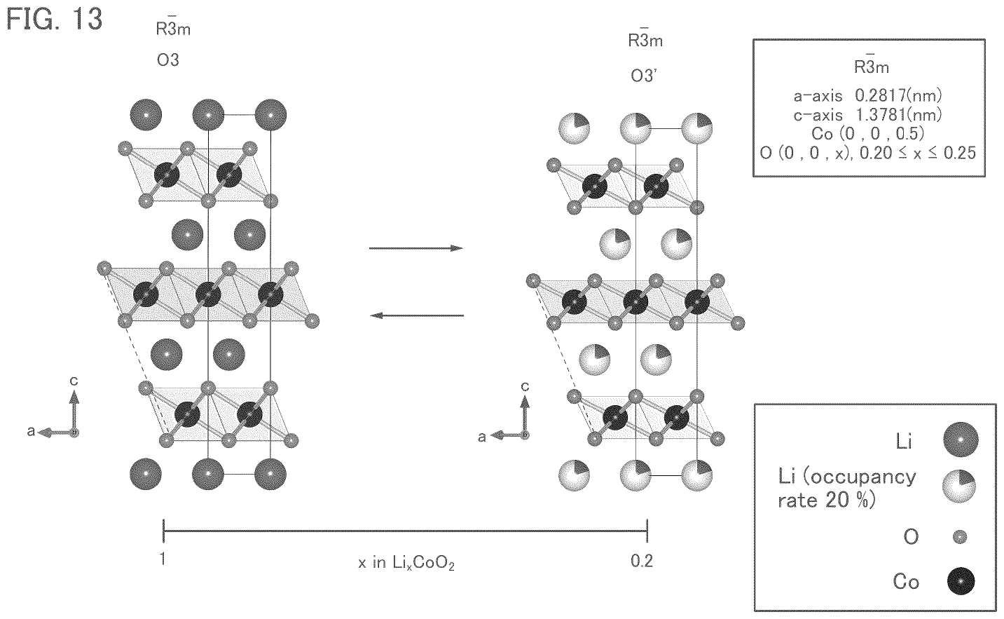

In this embodiment, a crystal structure of a positive electrode active material which is one embodiment of the present invention is described. The case of lithium cobalt oxide is described with reference to FIG. 13 to FIG. 16.

In this embodiment and the like, the Miller index is used for the expression of crystal planes and crystal orientations. An individual plane that shows a crystal plane is denoted by “( )”. In the crystallography, a bar is placed over a number in the expression of crystal planes, crystal orientations, and space groups; in this specification and the like, because of format limitations, crystal planes, crystal orientations, and space groups are sometimes expressed by placing a minus sign (−) in front of the number instead of placing a bar over the number.

### <Crystal Structure>

<<x in LiₓCoO₂ being 1>>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. In FIG. 13, the layered rock-salt crystal structure in a state where x is 1 is denoted by R-3m O3.

<<The State where x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element in a discharged state. Here, “x is small” means 0.1<x≤0.24.

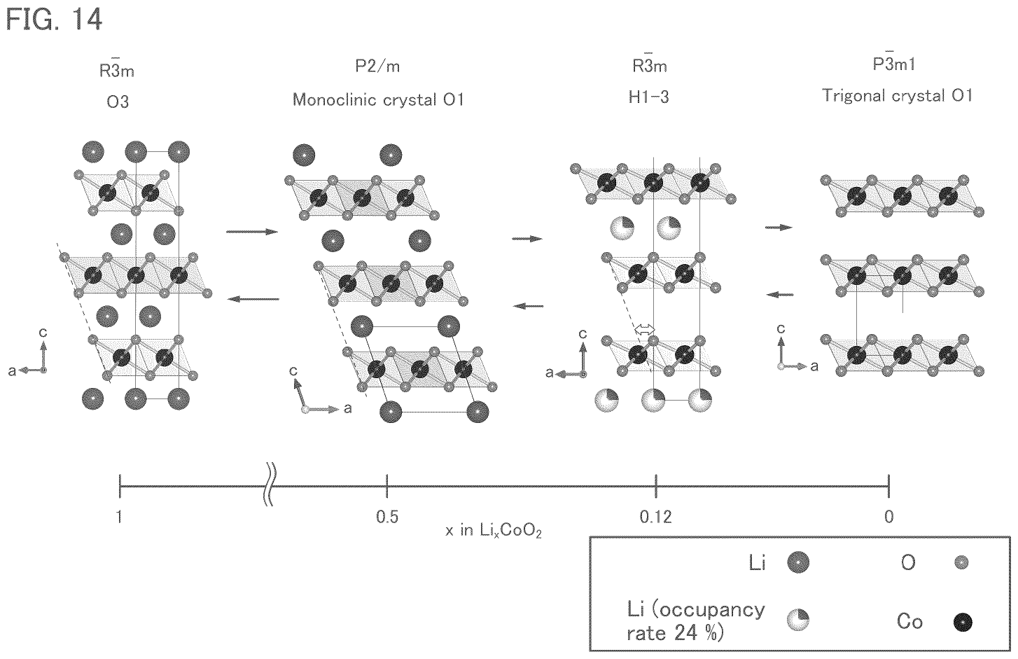

A positive electrode active material shown in FIG. 14 is conventional lithium cobalt oxide that is lithium cobalt oxide (LiCoO₂) to which fluorine and magnesium are not added. In FIG. 14, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an 03 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an 01 type structure or a monoclinic 01 type structure in some cases.

When x is 0, the positive electrode active material has a trigonal crystal structure belonging to the space group P-3 ml, and one CoO₂ layer exists in a unit cell. Thus, this crystal structure is referred to as an 01 type structure or a trigonal 01 type structure in some cases. Moreover, in some cases, this crystal structure is referred to as a hexagonal 01 type structure when a trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal 01 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification including FIG. 14, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that 01 and 02 are each an oxygen atom. A unit cell that should be used for representing a crystal structure in a positive electrode active material can be judged by the Rietveld analysis of an X-ray diffraction (XRD) pattern, for example. In this case, a unit cell is selected such that the value of GOF (goodness of fit) is small.

When charging that makes x in LiₓCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrow in FIG. 14, the CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers deterioration of the cycle performance. This is because the broken crystal structure has a smaller number of sites where lithium can exist stably and makes it difficult to insert and extract lithium.

Meanwhile, in the positive electrode active material 100 of one embodiment of the present invention shown in FIG. 13, a change in the crystal structure between a discharged state with x in LiₓCoO₂ being 1 and a state with x being 0.24 or less is smaller than that in a conventional positive electrode active material. Specifically, a shift in the CoO₂ layers between the state with x being 1 and the state with x being 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and obtain excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 13 shows crystal structures of an inner portion of the positive electrode active material 100 in a state where x in LiₓCoO₂ is 1 and in a state where x in LiₓCoO₂ is approximately 0.2. The inner portion, accounting for the majority of the volume of the positive electrode active material 100, largely contributes to charging and discharging and is accordingly a portion where a shift in CoO₂ layers and a volume change matter most.

The positive electrode active material 100 with x being 1 has the R-3m O3 type crystal structure, which is the same as that of conventional lithium cobalt oxide.

However, the positive electrode active material 100 has a crystal structure different from the H1-3 type crystal structure in a state where x is 0.24 or less, e.g., approximately 0.2 or approximately 0.12, with which conventional lithium cobalt oxide has the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 13, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 0.2797≤a≤0.2837 (nm), further preferably 0.2807≤a≤0.2827 (nm), typically a=0.2817 (nm). The lattice constant of the c-axis is preferably 1.3681≤c≤1.3881 (nm), further preferably 1.3751≤c≤1.3811 (nm), typically, c=1.3781 (nm).

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 13, the CoO₂ layers hardly shift between the R-3m O3 type crystal structure in a discharged state and the O3′ type crystal structure.

The R-3m O3 type crystal structure in a discharged state and the O3′ type crystal structure which contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material 100 is less likely to break even when charging that makes x be 0.24 or less and discharging are repeated. Therefore, a decrease in charge and discharge capacity of the positive electrode active material 100 in charge and discharge cycles is inhibited. Furthermore, the positive electrode active material 100 can stably use a larger amount of lithium than a conventional positive electrode active material and thus has high discharge capacity per weight and per volume. Thus, with the use of the positive electrode active material 100, a secondary battery with high discharge capacity per weight and per volume can be manufactured.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ in the positive electrode active material 100 is greater than 0.1 and less than or equal to 0.24, not all of the inner portion of the positive electrode active material 100 necessarily has the O3′ type crystal structure. The positive electrode active material 100 may have another crystal structure or may be partly amorphous.

In order to make x in LiₓCoO₂ small, charging with a high charge voltage is necessary in general. Therefore, the state where x in LiₓCoO₂ is small can be rephrased as a state where charging with a high charge voltage has been performed. For example, when CC/CV charging is performed at 25° C. and 4.6 V or higher using the potential of a lithium metal as a reference, the H1-3 type crystal structure appears in a conventional positive electrode active material. Therefore, a charge voltage of 4.6 V or higher can be regarded as a high charge voltage with reference to the potential of a lithium metal. In this specification and the like, unless otherwise specified, charge voltage is shown with reference to the potential of a lithium metal.

Thus, the positive electrode active material 100 of one embodiment of the present invention is preferable because the crystal structure with the symmetry of R-3m O3 can be maintained even when charging with a high charge voltage of 4.6 V or higher is performed at 25° C., for example. Moreover, the positive electrode active material 100 of one embodiment of the present invention is preferable because the O3′ type crystal structure can be obtained when charging with a higher charge voltage, e.g., a voltage higher than or equal to 4.65 V and lower than or equal to 4.7 V is performed at 25° C.

In the positive electrode active material 100, when the charge voltage is increased, the H1-3 type crystal is eventually observed in some cases. As described above, the crystal structure is influenced by the number of charge and discharge cycles, a charge current and a discharge current, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltages by the difference between the potential of graphite and the potential of a lithium metal. The potential of graphite is approximately 0.05 V to 0.2 V with reference to the potential of a lithium metal. Therefore, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ in FIG. 13, one embodiment of the present invention is not limited thereto. Lithium may exist unevenly in only some of the lithium sites; for example, lithium may symmetrically exist as in the monoclinic O1 (Li_{0.5}CoO₂) shown in FIG. 14. Distribution of lithium can be analyzed by neutron diffraction, for example.

The O3′ type crystal structure can also be regarded as a crystal structure that contains lithium between layers at random but is similar to a CdCl₂ type crystal structure. The crystal structure similar to the CdCl₂ type crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ type crystal structure in general.

A slight amount of the additive element such as magnesium randomly existing between the CoO₂ layers, i.e., in lithium sites, can inhibit a shift in the CoO₂ layers at the time of charging with a high voltage. That is, magnesium preferably exists in lithium sites. Thus, magnesium between the CoO₂ layers makes it easier to obtain the O3′ type crystal structure. Therefore, magnesium preferably exists in the surface portion of the positive electrode active material 100 of one embodiment of the present invention. Therefore, a heat treatment is preferably performed in the formation process of the positive electrode active material 100 of one embodiment of the present invention.

Note that cation mixing occurs when the heat treatment temperature is excessively high, so that the additive element, e.g., magnesium, is highly likely to enter the cobalt sites. Magnesium existing in the cobalt sites does not have an effect of maintaining the R-3m structure at the time of charging with a high voltage. Furthermore, when the heat treatment temperature is excessively high, adverse effects such as reduction of cobalt to have a valence of two and evaporation of lithium are concerned.

In view of the above, a fluorine compound is preferably added to lithium cobalt oxide during or before the heat treatment for adding magnesium. The addition of the fluorine compound can decrease the melting point of lithium cobalt oxide, which makes it easier to add magnesium at a temperature at which the cation mixing is unlikely to occur. Furthermore, the fluorine compound probably increases corrosion resistance to hydrofluoric acid generated by decomposition of an electrolyte solution.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material 100 of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, the number of magnesium atoms is preferably greater than or equal to 0.001 times and less than 0.04 times the number of atoms of the transition metal M. Alternatively, the number of magnesium atoms is preferably greater than or equal to 0.01 times and less than or equal to 0.1 times the number of atoms of the transition metal M. The magnesium concentration described here may be a value obtained by element analysis on the whole particles of the positive electrode active material using ICP-MS or the like, or may be a value based on the ratio of the raw materials mixed in the formation process of the positive electrode active material, for example.

As a metal other than cobalt (hereinafter, a metal Z), one or more metals selected from nickel, aluminum, manganese, titanium, zirconium, vanadium, and chromium may be added to lithium cobalt oxide, for example, and in particular, at least one of nickel and aluminum is preferably added. In some cases, manganese, titanium, vanadium, and chromium are likely to have a valence of four stably and thus contribute highly to a stable structure. The addition of the metal Z may enable the positive electrode active material of one embodiment of the present invention to have a more stable crystal structure in a high voltage charged state, for example. Here, in the positive electrode active material 100 of one embodiment of the present invention, the metal Z is preferably added at a concentration that does not greatly change the crystallinity of the lithium cobalt oxide. For example, the metal Z is preferably added at an amount with which the Jahn-Teller effect is not exhibited.

As the magnesium concentration in the positive electrode active material 100 of one embodiment of the present invention increases, the charge and discharge capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as the metal Z in addition to magnesium, the charge and discharge capacity per weight and per volume can be increased in some cases. When the positive electrode active material of one embodiment of the present invention contains aluminum as the metal Z in addition to magnesium, the charge and discharge capacity per weight and per volume can be increased in some cases. When the positive electrode active material of one embodiment of the present invention contains nickel and aluminum in addition to magnesium, the charge and discharge capacity per weight and per volume can be increased in some cases.

The concentrations of the elements contained in the positive electrode active material of one embodiment of the present invention, such as magnesium and the metal Z, are described below using the number of atoms.

The number of nickel atoms in the positive electrode active material 100 of one embodiment of the present invention is preferably greater than 0% and less than or equal to 7.5%, preferably greater than or equal to 0.05% and less than or equal to 4%, preferably greater than or equal to 0.1% and less than or equal to 2%, further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The nickel concentration described here may be a value obtained by element analysis on the whole particles of the positive electrode active material using GD-MS, ICP-MS, or the like, or may be a value based on the ratio of the raw materials mixed in the formation process of the positive electrode active material, for example.

Nickel contained at any of the above concentrations easily forms a solid solution uniformly throughout the positive electrode active material 100 and thus particularly contributes to stabilization of the crystal structure of the inner portion. When divalent nickel exists in the inner portion, the additive element having a valence of two and existing in lithium sites, such as magnesium, might be able to exist more stably in the vicinity of the divalent nickel. Thus, even when charging with a high voltage and discharging are performed, dissolution of magnesium might be inhibited. When dissolution of magnesium is inhibited, charge and discharge cycle performance can be improved. Such a combination of the effect of nickel in the inner portion and the effect of magnesium, aluminum, titanium, fluorine, or the like in the surface portion extremely effectively stabilizes the crystal structure at the time of charging with a high voltage.

The number of aluminum atoms in the positive electrode active material 100 of one embodiment of the present invention is preferably greater than or equal to 0.05% and less than or equal to 4%, preferably greater than or equal to 0.1% and less than or equal to 2%, further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The aluminum concentration described here may be a value obtained by element analysis on the whole particles of the positive electrode active material using GD-MS, ICP-MS, or the like, or may be a value based on the ratio of the raw materials mixed in the formation process of the positive electrode active material, for example.

It is preferable that the positive electrode active material 100 of one embodiment of the present invention contain an element Wand phosphorus be used as the element W. The positive electrode active material 100 of one embodiment of the present invention further preferably includes a compound containing phosphorus and oxygen.

When the positive electrode active material 100 of one embodiment of the present invention includes a compound containing the element W, a short circuit can be inhibited while a high voltage charged state is maintained, in some cases.

When the positive electrode active material 100 of one embodiment of the present invention contains phosphorus as the element W, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution may inhibit corrosion of a current collector or separation of a coating film or may inhibit a reduction in adhesion properties due to gelling or insolubilization of PVDF.

When containing magnesium in addition to the element W, the positive electrode active material 100 of one embodiment of the present invention is extremely stable in a high voltage charged state. When the element W is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The phosphorus concentration and the magnesium concentration described here may each be a value obtained by element analysis on the whole particles of the positive electrode active material using ICP-MS or the like, or may be a value based on the ratio of the raw materials mixed in the formation process of the positive electrode active material, for example.

### <Analysis Method>

Whether or not a positive electrode active material has the O3′ type crystal structure at the time of high voltage charging can be judged by analyzing a positive electrode charged with a high voltage by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

As described above, the positive electrode active material 100 of one embodiment of the present invention features in a small change in the crystal structure between a high voltage charged state and a discharged state. A material 50 wt % or more of which has the crystal structure that largely changes between a high-voltage charged state and a discharged state is not preferable because the material cannot withstand charging with a high voltage and discharging. Furthermore, in charging of the above-described material with a predetermined voltage, the material has the O3′ type crystal structure at almost 100 wt %, and increasing the voltage to be higher than the predetermined voltage may cause the H1-3 type crystal structure. Thus, to determine whether or not a positive electrode active material is the positive electrode active material 100 of one embodiment of the present invention, analysis is preferably performed by XRD or other methods.

Note that the crystal structure of the positive electrode active material 100 in a high voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

In order to grasp the state of the positive electrode active material charged with a high voltage, it is preferable that a coin cell (CR2032 type with a diameter of 20 mm and a height of 3.2 mm) with a counter electrode formed using a lithium metal be fabricated, charged, and then analyzed, for example.

More specifically, a coin cell including a positive electrode formed by application of slurry in which the positive electrode active material, a conductive additive, and a binder are mixed to a positive electrode current collector made of aluminum foil is used. A lithium metal can be used for a counter electrode.

The coin cell includes an electrolyte solution, and an electrolyte solution in which ethylene carbonate (EC) and diethyl carbonate (DEC) at EC:DEC=3:7 (volume ratio) and vinylene carbonate (VC) at 2 wt % are mixed can be used. As an electrolyte contained in the electrolyte solution, 1 mol/L lithium hexafluorophosphate (LiPF₆) can be used.

The coin cell includes a separator, and 25-μm-thick polypropylene can be used.

Stainless steel (SUS) can be used for a positive electrode can and a negative electrode can of the coin cell.

The coin cell fabricated with the above conditions is subjected to constant current charging with a freely selected voltage (e.g., 4.6 V, 4.65 V, or 4.7 V) and 0.5 C and then constant voltage charging until the current value reaches 0.01 C. Note that 1 C can be 137 mA/g or 200 mA/g. The temperature is set to 25° C.

After the charging is performed in this manner, the coin cell is disassembled in a glove box with an argon atmosphere to take out the positive electrode, whereby the positive electrode active material charged with a high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere.

### <<XRD>>

The apparatus and conditions adopted in the XRD measurement are not particularly limited. The measurement can be performed with the apparatus and conditions as described below, for example.

XRD apparatus: D8 ADVANCE produced by Bruker AXS
X-ray source: CuKα₁ radiation

### Output: 40 KV, 40 mA

Slit width: Div. Slit, 0.50

### Detector: LynxEye

Scanning method: 2θ/θ continuous scanning
Measurement range (2θ): from 15° to 90°
Step width (2θ): 0.010
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

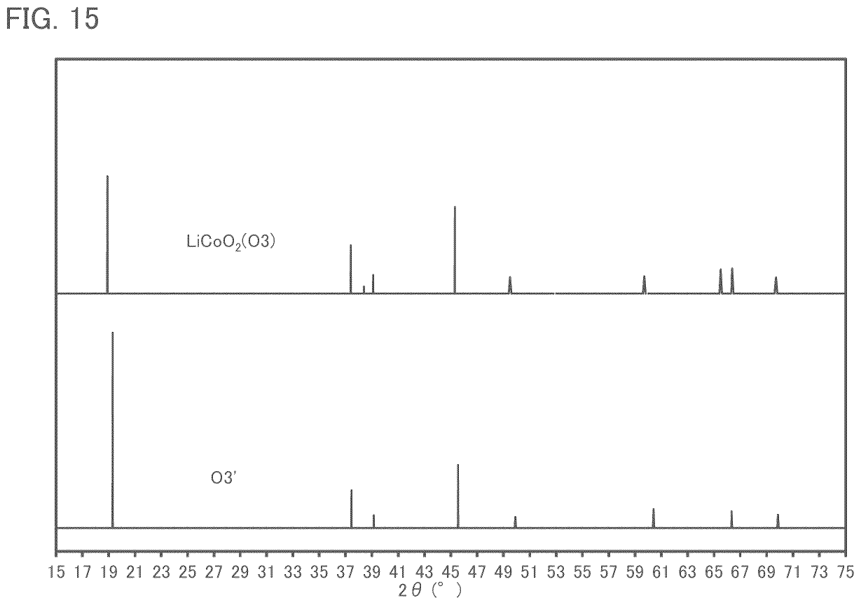

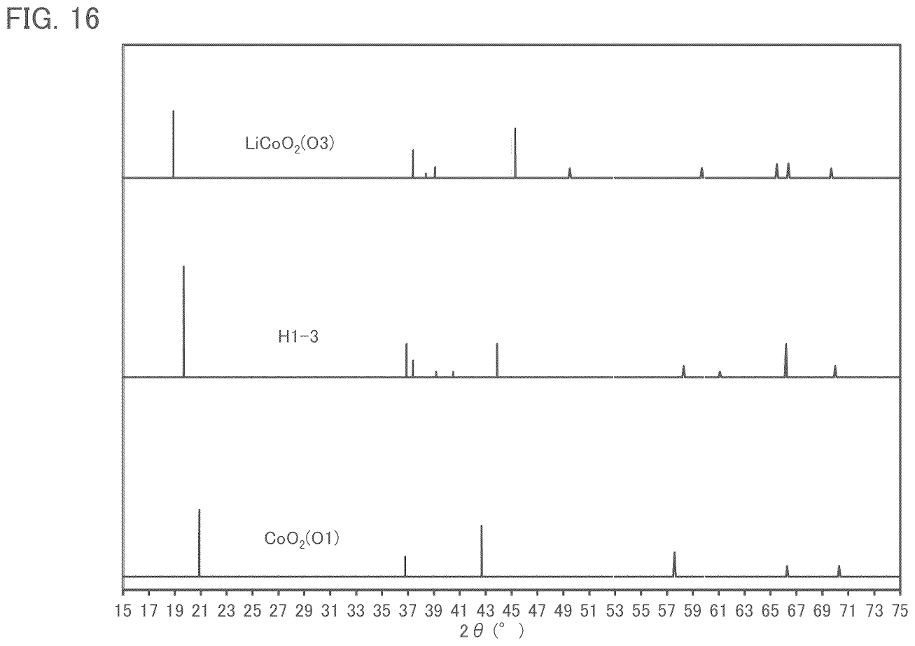

FIG. 15 shows XRD patterns of an O3′ type crystal structure. For comparison, ideal XRD patterns calculated from the crystal structure of LiCoO₂ (O3) with a charge depth of 0 are also shown in FIG. 15. Next, FIG. 16 shows ideal powder XRD patterns with CuKα₁ radiation that are calculated from a model of the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown in FIG. 16. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The range of 2θ is from 15° to 75°, the step size is 0.01, the wavelength λ1 is 1.540562×10⁻¹⁰ m, the wavelength λ2 is not set, and a single monochromator is used.

As shown in FIG. 15, the O3′ type crystal structure exhibits diffraction peaks at 2θ of 19.30±0.20° (greater than or equal to 19.100 and less than or equal to 19.50°) and 2θ of 45.55±0.10° (greater than or equal to 45.450 and less than or equal to 45.65°). More specifically, sharp diffraction peaks appear at 2θ of 19.30±0.100 (greater than or equal to 19.200 and less than or equal to 19.40°) and 2θ of 45.55±0.05° (greater than or equal to 45.500 and less than or equal to 45.60°). However, as shown in FIG. 16, the H1-3 type crystal structure and CoO₂ (O1) do not exhibit peaks at these positions. Thus, the peaks at 2θ of 19.30±0.20° and 2θ of 45.55±0.100 in a high voltage charged state can be the features of the positive electrode active material 100 of one embodiment of the present invention.

As shown in FIG. 15, the O3′ type crystal structure exhibits diffraction peaks at 2θ of 19.25±0.12° (greater than or equal to 19.13° and less than 19.37°) and 2θ of 45.47±0.10° (greater than or equal to 45.37° and less than 45.57°).

However, as shown in FIG. 16, the H1-3 type crystal structure and CoO₂ (O1) do not exhibit peaks at these positions. Thus, the peaks at 2θ of 19.25±0.12° (greater than or equal to 19.13° and less than 19.37°) and 2θ of 45.47±0.10° (greater than or equal to 45.37° and less than 45.57°) in a state where x in LiₓCoO₂ is small can be the features of the positive electrode active material 100 of one embodiment of the present invention.

It can be said that the positions of the XRD diffraction peaks exhibited by the crystal structure with x being 1 and the crystal structure with x being 0.24 or less are close to each other. More specifically, it can be said that a difference in 2θ between the main diffraction peak exhibited by the crystal structure with x being 1 and the main diffraction peak exhibited by the crystal structure with x being 0.24 or less, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure when x in LiₓCoO₂ is small, not all of the positive electrode active material 100 necessarily has the O3′ type crystal structure. The positive electrode active material 100 may have another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50%, preferably greater than or equal to 60%, further preferably greater than or equal to 66% can have sufficiently good cycle performance.

Furthermore, even after 100 or more cycles of charging and discharging after the measurement starts, the O3′ type crystal structure preferably accounts for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions and/or the 20 value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity contributes to stability of the crystal structure.

The crystallite size of the O3′ type crystal structure included in the positive electrode active material 100 does not decrease to less than approximately one-twentieth that of LiCoO₂ (O3) in a discharged state. Thus, a clear peak of the O3′ type crystal structure can be observed when x in LiₓCoO₂ is small, even under the same XRD measurement conditions as those of a positive electrode before the charging and discharging. In contrast, conventional LiCoO₂ has a small crystallite size and a broad and small peak even when it can have a structure part of which is similar to the O3′ type crystal structure. The crystallite size can be calculated from the half width of the XRD peak.

The positive electrode active material sometimes has a crack. When an inner portion of the positive electrode active material with a crack surface includes phosphorus, more specifically, a compound containing phosphorus and oxygen or the like, crack development is inhibited in some cases.

This embodiment can be used in combination with any of the other embodiments.

### Embodiment 4

In this embodiment, a lithium-ion secondary battery including a positive electrode active material of one embodiment of the present invention will be described. The secondary battery at least includes an exterior body, a current collector, an active material (a positive electrode active material or a negative electrode active material), a conductive additive, and a binder. An electrolyte solution in which a lithium salt or the like is dissolved is also included. In the secondary battery using an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the positive electrode active material described in Embodiment 1, and may further include a binder, a conductive additive, or the like.

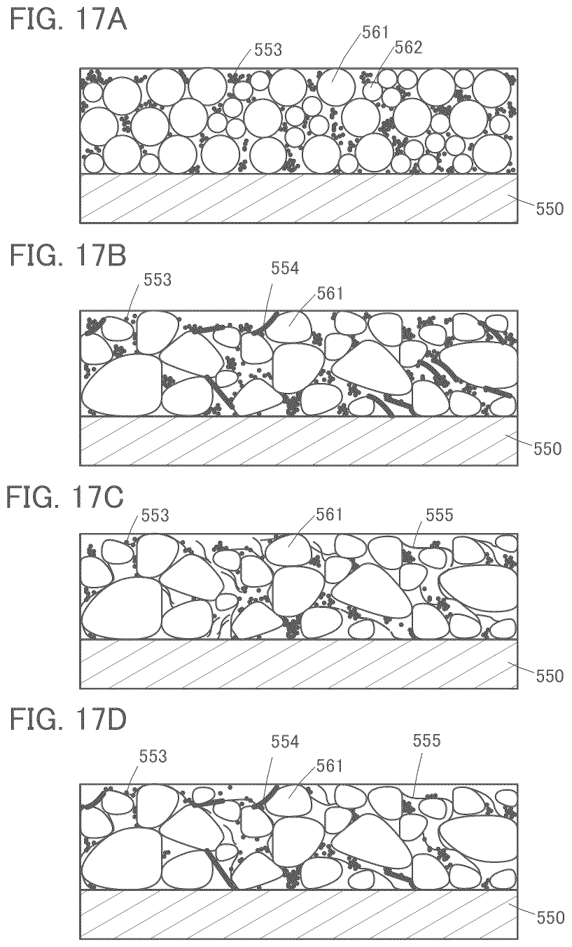

FIG. 17A illustrates an example of a schematic cross-sectional view of the positive electrode.

A current collector 550 is metal foil, and the positive electrode is formed by applying slurry onto the metal foil and drying the slurry. Pressing may be performed after drying. The positive electrode is a component obtained by forming a positive electrode active material layer over the current collector 550.

Slurry refers to a material solution that is used to form a positive electrode active material layer over the current collector 550 and includes at least a positive electrode active material, a binder, and a solvent, preferably also a conductive additive mixed therewith. Slurry may also be referred to as slurry for an electrode or active material slurry; in some cases, in the case of slurry for forming a positive electrode active material layer, slurry for a positive electrode is used, and in the case of slurry for forming a negative electrode active material layer, slurry for a negative electrode is used.

A conductive additive is also referred to as a conductivity-imparting agent or a conductive material, and a carbon material is used. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Typical examples of the carbon material used as the conductive additive include carbon black (e.g., furnace black, acetylene black, and graphite).

In FIG. 17A, acetylene black 553 is illustrated as the conductive additive. In FIG. 17A, the positive electrode active materials 100 have different particle diameters. That is, an example is shown in which a first positive electrode active material 561 with a large particle diameter and a second positive electrode active material 562 with a small particle diameter are mixed. Positive electrode active materials with different sizes are mixed, whereby a high-density positive electrode active material layer can be provided and thus the charge and discharge capacity of the secondary battery can be increased.

In the positive electrode of the secondary battery, a binder (a resin) is mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is reduced to a minimum. In FIG. 17A, the region that is not filled with the first positive electrode active material 561, the second positive electrode active material 562, or the acetylene black 553 represents a space or a binder. A space is required for penetration of the electrolyte solution; too many spaces lower the electrode density, too few spaces do not allow penetration of the electrolyte solution, and a space that remains after the secondary battery is completed lowers the energy density.

Although FIG. 17A shows an example in which the first positive electrode active material 561 has a spherical shape, there is no particular limitation and other various shapes can be employed. The cross-sectional shape of the first positive electrode active material 561 may be an ellipse, a rectangle, a trapezoid, a pyramid, a quadrilateral with rounded corners, or an asymmetrical shape.

FIG. 17B shows an example in which the first positive electrode active materials 561 have various shapes. FIG. 17B shows the example different from that in FIG. 17A.

In the positive electrode in FIG. 17B, graphene 554 is used as a carbon material used as the conductive additive.

In FIG. 17B, a positive electrode active material layer including the first positive electrode active material 561, the graphene 554, and the acetylene black 553 is formed over the current collector 550.

In the step of mixing the graphene 554 and the acetylene black 553 to obtain an electrode slurry, the weight of mixed carbon black is preferably 1.5 times to 20 times, further preferably 2 times to 9.5 times the weight of graphene.

When the graphene 554 and the acetylene black 553 are mixed in the above range, the acetylene black 553 can be dispersed uniformly and less likely to be aggregated at the time of preparing the slurry. Furthermore, when the graphene 554 and the acetylene black 553 are mixed in the above range, the electrode density can be higher than that of an electrode using only the acetylene black 553 as a conductive additive. As the electrode density is higher, the capacity per unit weight can be higher. Specifically, the density of the positive electrode active material layer measured by gravimetry can be higher than 3.5 g/cc. In addition, it is preferable that the positive electrode active material 100 described in Embodiment 1 be used for the positive electrode and the graphene 554 and the acetylene black 553 be mixed in the above range, in which case a synergy effect for higher capacity of the secondary battery can be expected.

Using the positive electrode active material 100 described in Embodiment 1 for the positive electrode and setting the mixing ratio of acetylene black and graphene in the optimal range enable both higher electrode density and formation of an appropriate space needed for ion conduction, whereby high energy density and favorable output characteristics can be achieved.

The electrode density is lower than that of a positive electrode containing only graphene as a conductive additive, but when graphene (a first carbon material) and acetylene black (a second carbon material which is different from the first carbon material in a shape or the like) are mixed in the above range, fast charging can be achieved. In addition, it is preferable that the positive electrode active material 100 described in Embodiment 1 be used for the positive electrode and the graphene 554 and the acetylene black 553 be mixed in the above ratio range, in which case synergy for higher stability and compatibility with faster charging of the secondary battery can be expected. The above features are advantageous for secondary batteries for vehicles.

This structure is also effective in a portable information terminal, and using the positive electrode active material 100 described in Embodiment 1 for the positive electrode and setting the mixing ratio of acetylene black to graphene in the optimal range enable a small secondary battery with high capacity. Setting the mixing ratio of acetylene black to graphene in the optimal range also enables fast charging of a portable information terminal.

In FIG. 17B, the region that is not filled with the first positive electrode active material 561, the graphene 554, or the acetylene black 553 represents a space or a binder.

Using the positive electrode active material 100 obtained in Embodiment 1 for the positive electrode and setting the mixing ratio of acetylene black and graphene in the optimal range enable both higher electrode density and formation of an appropriate space needed for ion conduction, whereby a secondary battery which has high energy density and favorable output characteristics can be obtained.

FIG. 17C shows an example of a positive electrode in which a carbon nanotube 555 is used instead of graphene. FIG. 17C shows the example different from that in FIG. 17B. With the use of the carbon nanotube 555, aggregation of carbon black such as the acetylene black 553 can be prevented and the dispersibility can be increased.

In FIG. 17C, the region that is not filled with the first positive electrode active material 561, the carbon nanotube 555, or the acetylene black 553 represents a space or a binder.

FIG. 17D shows another example of a positive electrode. FIG. 17D shows an example in which the carbon nanotube 555 is used in addition to the graphene 554. With the use of both the graphene 554 and the carbon nanotube 555, aggregation of carbon black such as the acetylene black 553 can be prevented and the dispersibility can be further increased.

In FIG. 17D, the region that is not filled with the first positive electrode active material 561, the carbon nanotube 555, the graphene 554, or the acetylene black 553 represents a space or a binder.

A secondary battery can be manufactured by using any one of the positive electrodes in FIG. 17A to FIG. 17D; setting, in a container (e.g., an exterior body or a metal can) or the like, a stack in which a separator is provided over the positive electrode and a negative electrode is provided over the separator; and filling the container with an electrolyte solution.

Although the above structure is an example of a secondary battery using an electrolyte solution, one embodiment of the present invention is not particularly limited thereto.

For example, a semi-solid-state battery or an all-solid-state battery can be fabricated using the positive electrode active material 100 described in Embodiment 1.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery manufactured using the positive electrode active material 100 described in Embodiment 1 is a secondary battery having high charge and discharge capacity. The semi-solid-state battery can have high charge and discharge voltages. Alternatively, a highly safe or reliable semi-solid-state battery can be provided.

The positive electrode active material described in Embodiment 1 and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ or LiNi₁₋ₓMₓO₂ (0<x<1) (M is Co, Al, or the like)) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material or another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electrical conductivity or a film with extremely low electrical conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### <Negative Electrode Active Material>

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, or preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, copper or the like can be used in addition to a material similar to that of the positive electrode current collector. Note that a material that is not alloyed with carrier ions of lithium or the like is preferably used for the negative electrode current collector.

### [Separator]

A separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyimide, polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging with a high voltage and discharging can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a power storage device from exploding or catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio.

The electrolyte solution used for a power storage device is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the additive agent in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator or a spacer is not necessary. Furthermore, the battery can be entirely solidified; therefore, there is no possibility of liquid leakage and thus the safety of the battery is dramatically improved.

Accordingly, the positive electrode active material 100 obtained in Embodiment 1 and Embodiment 2 can also be applied to all-solid-state batteries. By using the positive electrode slurry or the electrode in an all-solid-state battery, an all-solid-state battery with a high degree of safety and favorable characteristics can be obtained.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be used in combination with the other embodiments.

### Embodiment 5

This embodiment describes examples of shapes of several types of secondary batteries including a positive electrode or a negative electrode formed by the formation method described in the foregoing embodiment.

### [Coin-Type Secondary Battery]

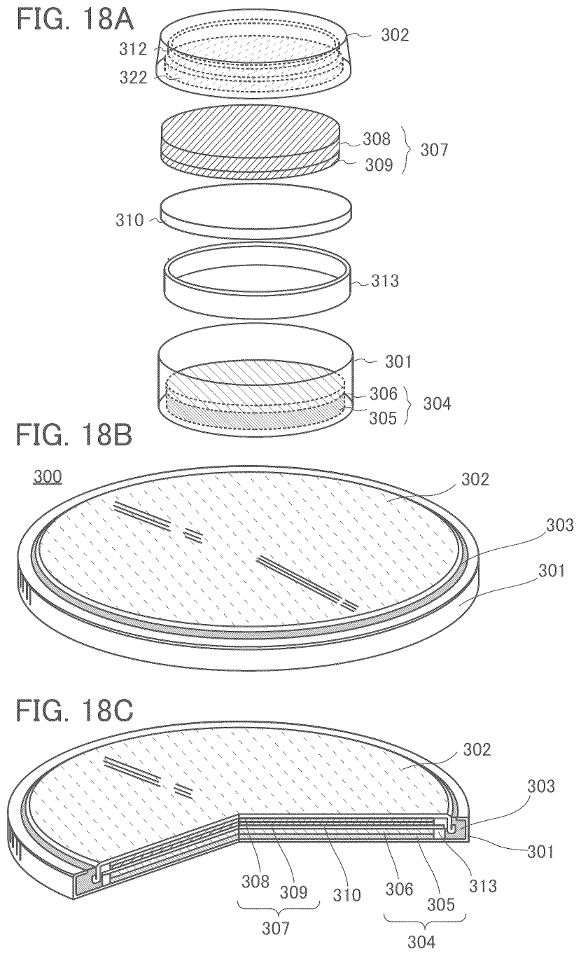

An example of a coin-type secondary battery is described. FIG. 18A is an exploded perspective view of a coin-type (single-layer flat type) secondary battery, FIG. 18B is an external view thereof, and FIG. 18C is a cross-sectional view thereof. Coin-type secondary batteries are mainly used in small electronic devices.

For easy understanding, FIG. 18A is a schematic view showing overlap (a vertical relation and a positional relation) between components. Thus, FIG. 18A and FIG. 18B do not completely correspond with each other.

In FIG. 18A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 18A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 18B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte solution; as illustrated in FIG. 18C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The coin-type secondary battery 300 with the above-described structure can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

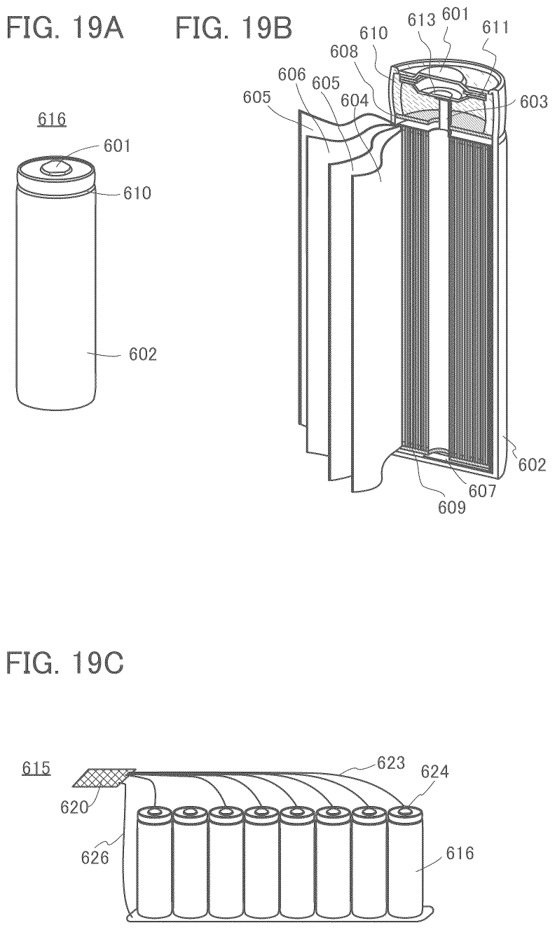

An example of a cylindrical secondary battery is described with reference to FIG. 19A. As illustrated in FIG. 19A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 19B schematically illustrates a cross section of a cylindrical secondary battery. The cylindrical secondary battery illustrated in FIG. 19B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). A nonaqueous electrolyte solution similar to that for the coin-type secondary battery can be used.

Since a positive electrode and a negative electrode that are used for a cylindrical secondary battery are wound, active materials are preferably formed on both surfaces of a current collector.

The positive electrode active material 100 obtained in Embodiment 1 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 19C shows an example of a power storage system 615. The power storage system 615 includes a plurality of secondary batteries 616. The positive electrodes of the secondary batteries are in contact with and electrically connected to conductors 624. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging or overdischarging can be used.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

### [Other Structure Examples of Secondary Battery]

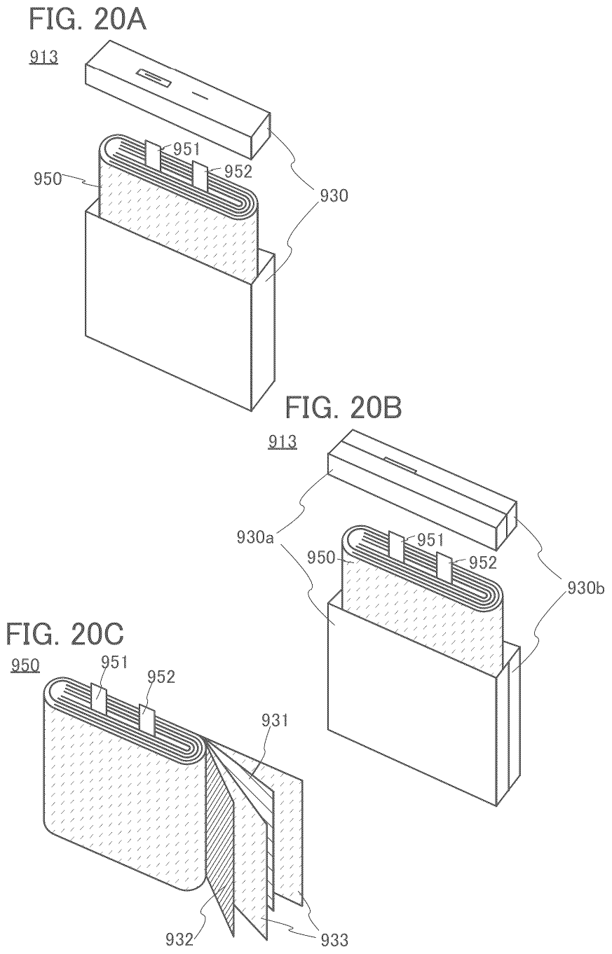

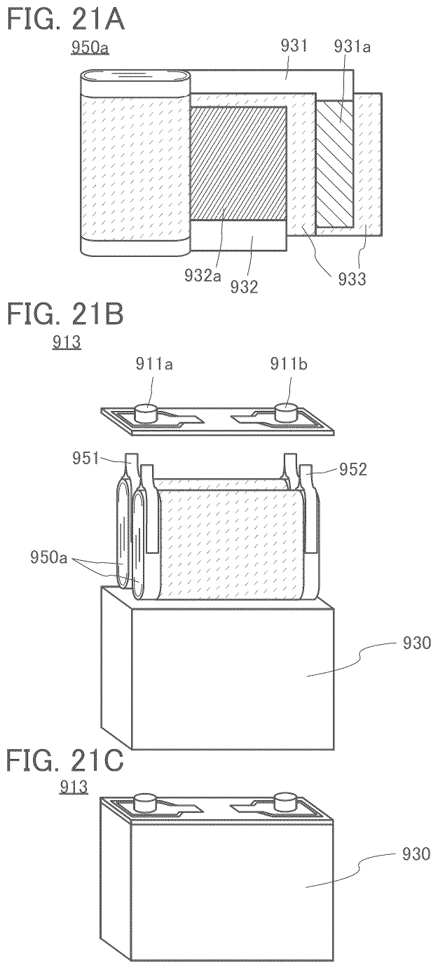

Other structure examples of secondary batteries are described with reference to FIG. 20 and FIG. 21.

A secondary battery 913 illustrated in FIG. 20A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 20A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 20B, the housing 930 in FIG. 20A may be formed using a plurality of materials. For example, in the secondary battery 913 illustrated in FIG. 20B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 20C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 21, the secondary battery 913 may include a wound body 950a. The wound body 950a illustrated in FIG. 21A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiment 1 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 21B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 21C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 21B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 20A to FIG. 20C can be referred to for the other components of the secondary battery 913 illustrated in FIG. 21A and FIG. 21B.

### <Laminated Secondary Battery>

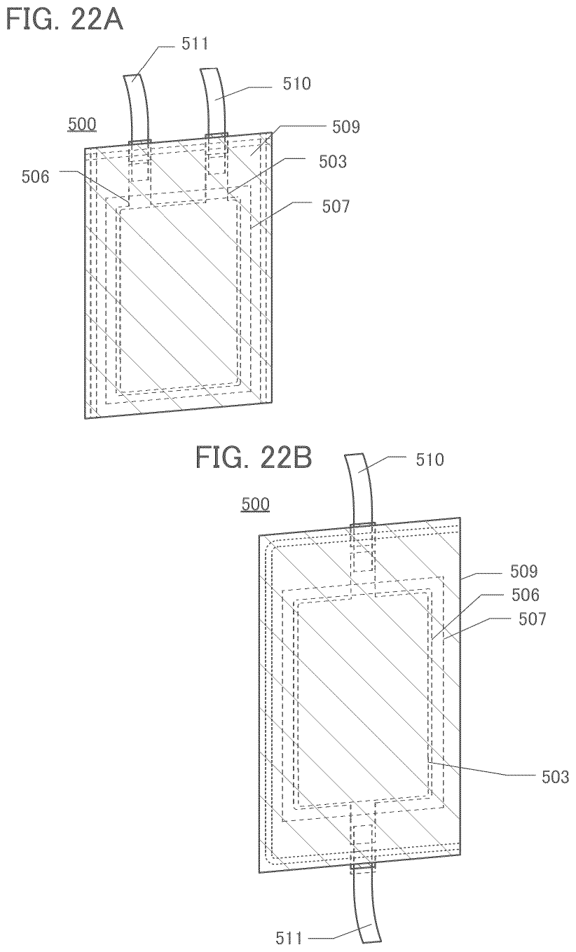

Next, examples of the appearance of a laminated secondary battery are shown in FIG. 22A and FIG. 22B. FIG. 22A and FIG. 22B each include a positive electrode 503, a negative electrode 506, a separator 507, an exterior body 509, a positive electrode lead electrode 510, and a negative electrode lead electrode 511.

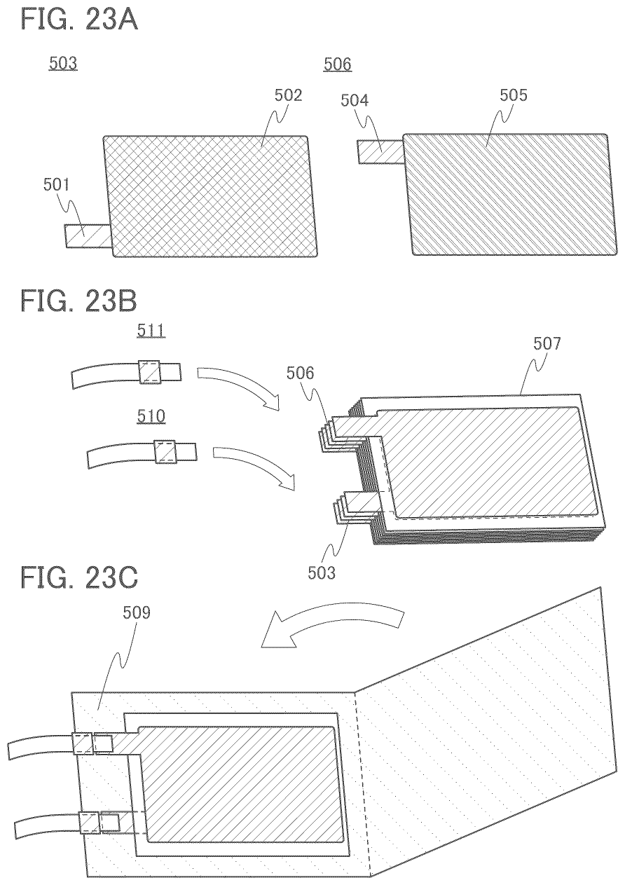

FIG. 23A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples shown in FIG. 23A.

### <Method for Manufacturing Laminated Secondary Battery>

Here, an example of a method for manufacturing the laminated secondary battery whose external view is shown in FIG. 22A is described with reference to FIG. 23B and FIG. 23C.

First, the negative electrode 506, the separator 507, and the positive electrode 503 are stacked. FIG. 23B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 23C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material 100 obtained in Embodiment 1 is used for the positive electrode 503, whereby the secondary battery 500 can have high capacity, high charge and discharge capacity, and excellent cycle performance.

### [Examples of Battery Pack]

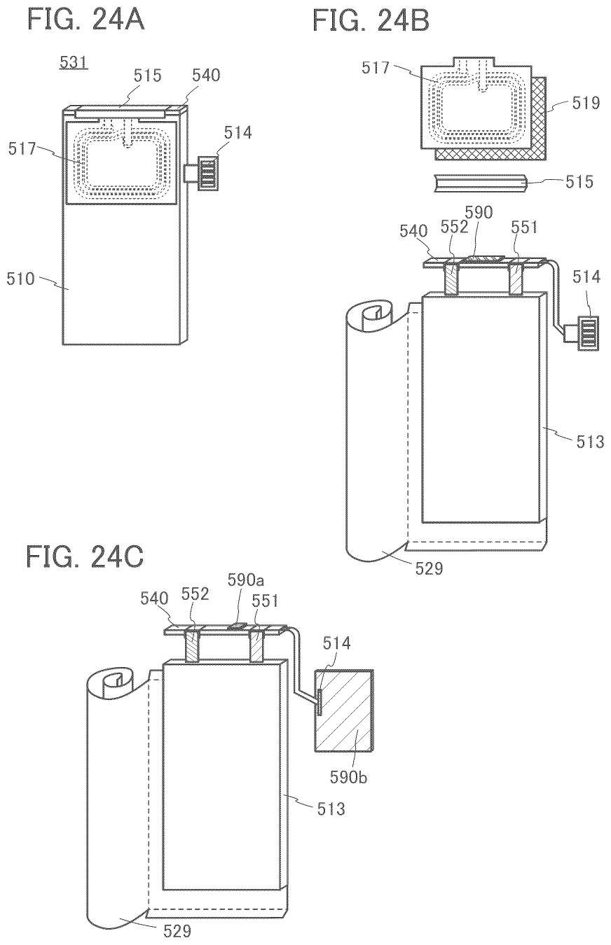

Examples of a secondary battery pack of one embodiment of the present invention that is capable of wireless charging using an antenna will be described with reference to FIG. 24.

FIG. 24A is a diagram illustrating the appearance of a secondary battery pack 531 that has a rectangular solid shape with a small thickness (also referred to as a flat plate shape with a certain thickness). FIG. 24B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 24B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 24C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. For the layer 519, a magnetic material can be used, for example.

This embodiment can be freely combined with the other embodiments.

### Embodiment 6

In this embodiment, an example in which an all-solid-state battery is fabricated using the positive electrode active material 100 obtained in Embodiment 1 will be described.

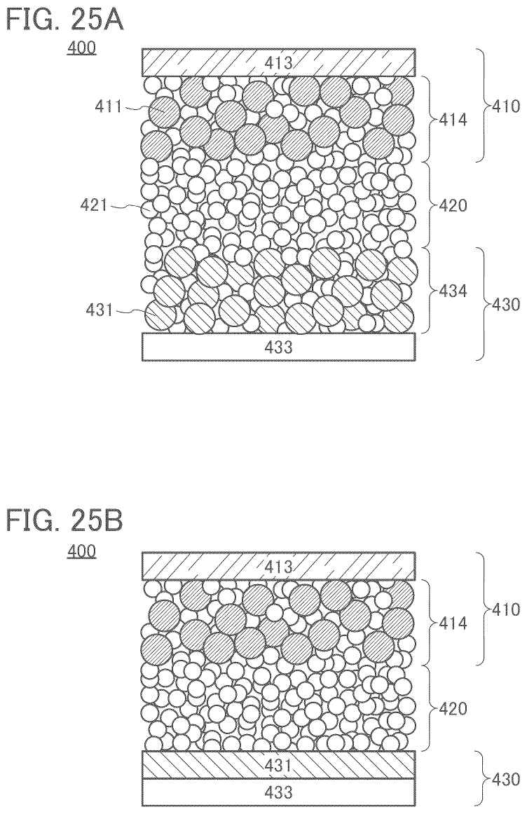

As illustrated in FIG. 25A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 obtained in Embodiment 1 and Embodiment 2 is used as the positive electrode active material 411. The positive electrode active material layer 414 may include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. When metal lithium is used for the negative electrode 430, it is possible that the negative electrode 430 does not include the solid electrolyte 421 as illustrated in FIG. 25B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{30.25}P_{0.95}S₄). The sulfide-based solid electrolyte has advantages such as high conductivity of some materials, low-temperature synthesis, and ease of maintaining a path for electrical conduction after charging and discharging because of its relative softness.

The oxide-based solid electrolyte includes a material with a perovskite crystal structure (e.g., La_{2/3-x}Li₃TiO₃), a material with a NASICON crystal structure (e.g., Li_{1-y}Al_{y}Ti_{2-y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0 [x [1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

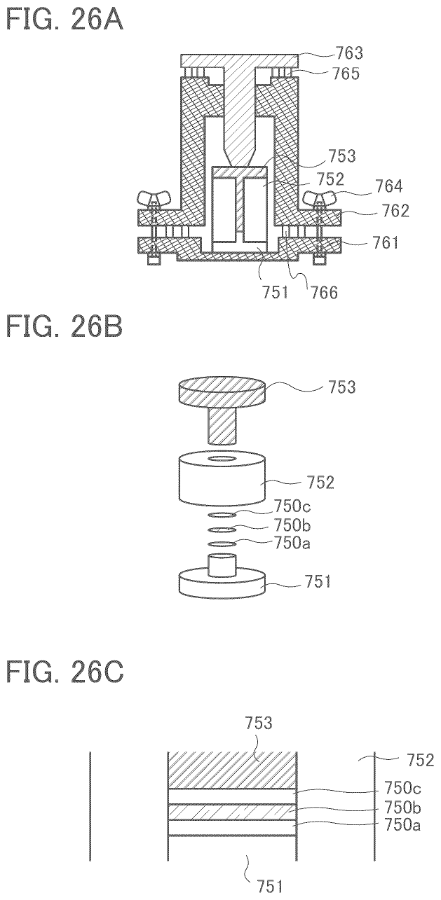

FIG. 26 illustrates an example of a cell for evaluating materials of an all-solid-state battery, for example.

FIG. 26A is a schematic cross-sectional view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 26B is an enlarged perspective view of the evaluation material and its vicinity.

A stack of a positive electrode 750a, a solid electrolyte layer 750b, and a negative electrode 750c is shown as an example of the evaluation material, and its cross-sectional view is illustrated in FIG. 26C. Note that the same portions in FIG. 26A to FIG. 26C are denoted by the same reference numerals.

The electrode plate 751 and the lower component 761 that are electrically connected to the positive electrode 750a can be said to correspond to a positive electrode terminal. The electrode plate 753 and the upper component 762 that are electrically connected to the negative electrode 750c can be said to correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

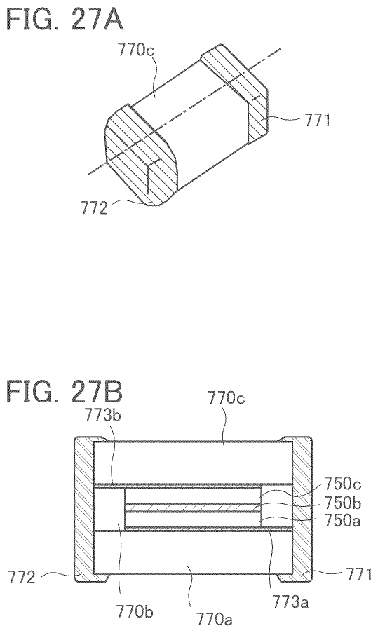

FIG. 27A illustrates a perspective view of a secondary battery of one embodiment of the present invention that has an exterior body and a shape different from those in FIG. 26. The secondary battery in FIG. 27A includes external electrodes 771 and 772 and is sealed with an exterior body including a plurality of package components.

FIG. 27B illustrates an example of a cross section along the dashed-dotted line in FIG. 27A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in Embodiment 1 can achieve an all-solid-state secondary battery having a high energy density and favorable output characteristics.

This embodiment can be used in appropriate combination with the other embodiments.

### Embodiment 7

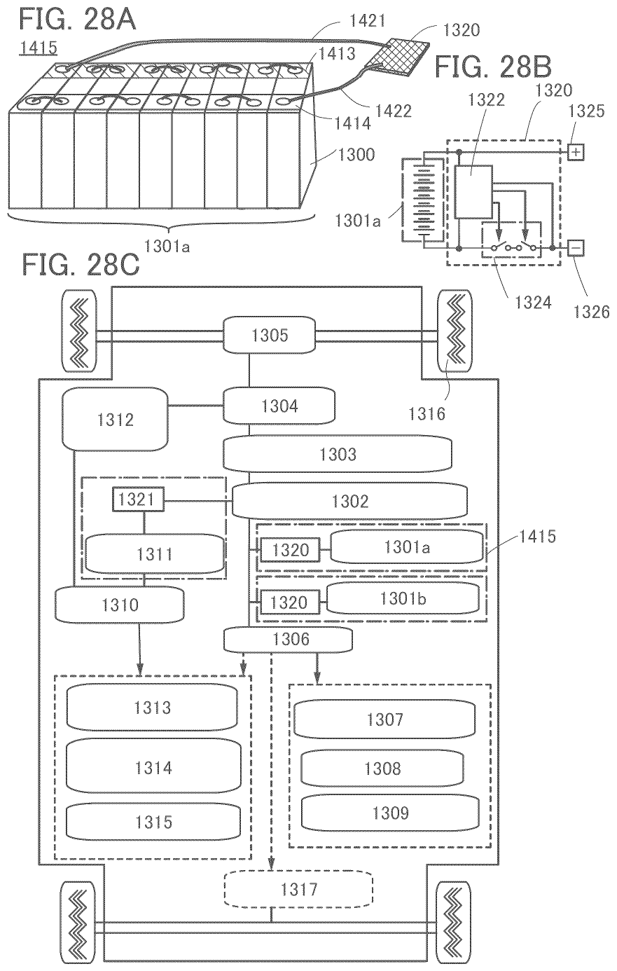

In this embodiment, an example of application to an electric vehicle (EV) is described with reference to FIG. 28A, FIG. 28B, and FIG. 28C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 20C or FIG. 21A or the stacked-layer structure illustrated in FIG. 22A or FIG. 22B. Alternatively, the first battery 1301a may be the all-solid-state battery in Embodiment 6. The use of the all-solid-state battery in Embodiment 6 as the first battery 1301a can achieve high capacity, improvement in safety, and reduction in size and weight.

Although this embodiment shows an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries are also referred to as an assembled battery.

In order to cut off electric power from the plurality of secondary batteries, the secondary batteries in the vehicle include a service plug or a circuit breaker which can cut off a high voltage without the use of equipment; these are provided in the first battery 1301a.

Electric power from the first batteries 1301a and 1301b is mainly used to rotate the motor 1304 and the electric power is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as an audio 1313, a power window 1314, and lamps 1315) through a DCDC circuit 1310.

The first battery 1301a will be described with reference to FIG. 28A.

FIG. 28A illustrates an example in which nine rectangular secondary batteries 1300 form one battery pack 1415. The nine rectangular secondary batteries 1300 are connected in series; one electrodes are fixed by a fixing portion 1413 made of an insulator, and the other electrodes are fixed by a fixing portion 1414 made of an insulator. Although this embodiment shows an example in which the secondary batteries are fixed by the fixing portions 1413 and 1414, a structure in which the secondary batteries are stored in a battery container box (also referred to as a housing) may be employed. Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrodes are electrically connected to a control circuit portion 1320 through a wiring 1421. The other electrodes are electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). The CAAC-OS is an oxide semiconductor that has a plurality of crystal regions each of which has c-axis alignment in a particular direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example.

The control circuit portion 1320 preferably includes a transistor using an oxide semiconductor because it can be used in a high-temperature environment. For the process simplicity, the control circuit portion 1320 may be formed using transistors of the same conductivity type. The operating ambient temperatures of a transistor using an oxide semiconductor in its semiconductor layer are wider than those of a single crystal Si transistor and are higher than or equal to −40° C. and lower than or equal to 150° C., which causes less change of characteristics compared with a single crystal Si transistor when the secondary battery is heated. The off-state current of the transistor using an oxide semiconductor is lower than or equal to the lower measurement limit independently of the temperature; meanwhile, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery including a positive electrode using the positive electrode active material 100 obtained in Embodiment 1 and Embodiment 2, the synergy on safety can be obtained. The secondary battery including a positive electrode using the positive electrode active material 100 obtained in Embodiment 1 and Embodiment 2 and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve causes of instability, such as a micro-short circuit. Examples of the functions include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: a plurality of charging and discharging cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

FIG. 28B illustrates an example of a block diagram of the battery pack 1415 illustrated in FIG. 28A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to including a switch using a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is areal number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle devices for 42 V (for a high-voltage system), and the second battery 1311 supplies electric power to in-vehicle devices for 14 V (for a low-voltage system). Lead storage batteries are usually used for the second battery 1311 due to cost advantage. Lead storage batteries have disadvantages compared with lithium-ion secondary batteries in that they have a larger amount of self-discharge and are more likely to deteriorate due to a phenomenon called sulfation. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 5 may be used. The use of the all-solid-state battery in Embodiment 5 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through the control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit) in some cases. The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200 V outlet with 50 kW, for example. Furthermore, charging can be performed by electric power supplied from an external charge equipment with a contactless power feeding method or the like.

For fast charging, secondary batteries that can withstand charging with a high voltage have been desired to perform charging in a short time.

The above secondary battery in this embodiment uses the positive electrode active material 100 obtained in Embodiment 1 and thus includes a high-density positive electrode. Furthermore, graphene is used as a conductive additive and an electrode layer is formed thick so that a reduction in capacity can be inhibited while the loading amount is increased. Moreover, the maintenance of high capacity can be obtained as synergy; thus, it is possible to achieve a secondary battery whose electrical characteristics are significantly improved. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the positive electrode active material 100 described in Embodiment 1 can increase the operating voltage of the secondary battery, and the increase in charge voltage can increase the available capacity. Moreover, the use of the positive electrode active material 100 described in Embodiment 1 in the positive electrode can provide an automotive secondary battery having excellent cycle performance.

Next, examples in which the secondary battery which is one embodiment of the present invention is mounted on a vehicle, typically a transport vehicle, are described.

Mounting the secondary battery illustrated in either FIG. 21C or FIG. 28A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

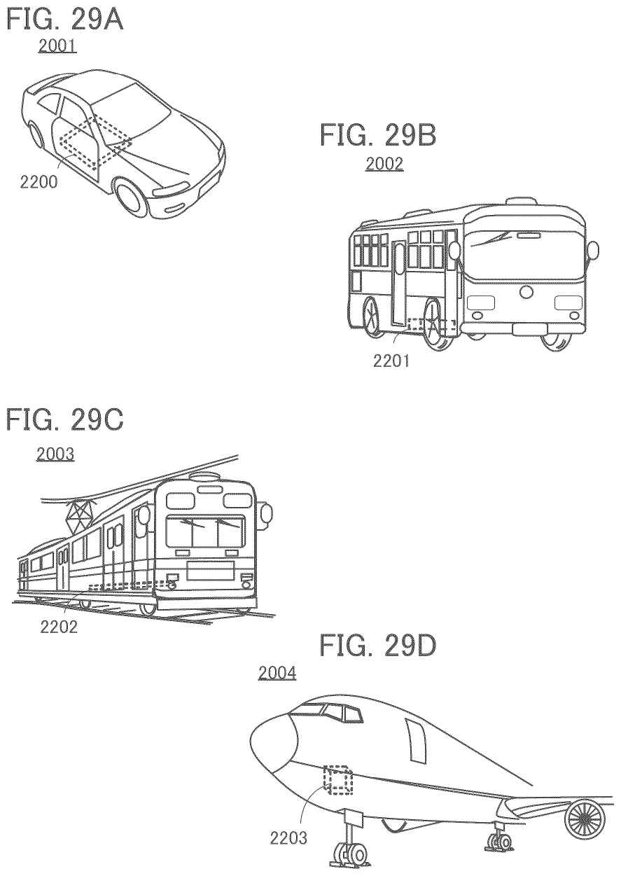

FIG. 29A to FIG. 29D show examples of transport vehicles using one embodiment of the present invention. An automobile 2001 illustrated in FIG. 29A is an electric vehicle that runs on an electric motor as a power source. Alternatively, the automobile 2001 is a hybrid vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 29A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charging equipment by a plug-in system, a contactless charging system, or the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 29B shows a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 29A except, for example, the number of secondary batteries configuring the secondary battery module; thus, the description is omitted.

FIG. 29C shows a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have few variations in the characteristics. By employing the positive electrode active material 100 described in Embodiment 1 for the positive electrode, a secondary battery having stable battery characteristics can be manufactured and mass production at low cost is possible in light of the yield. A battery pack 2202 has the same function as that in FIG. 29A except, for example, the number of secondary batteries configuring the secondary battery module; thus, the description is omitted.

FIG. 29D shows an aircraft 2004 having a combustion engine as an example. The aircraft 2004 shown in FIG. 29D can be regarded as a kind of transport vehicles since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 29A except, for example, the number of secondary batteries configuring the secondary battery module; thus, the description is omitted.

This embodiment can be implemented in appropriate combination with any of the other embodiments.

### Embodiment 8

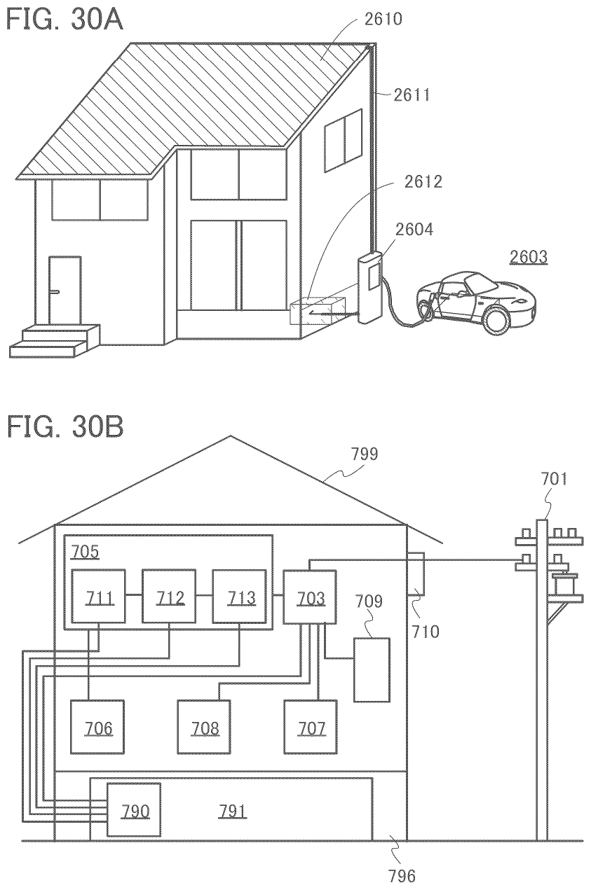

In this embodiment, examples in which the secondary battery which is one embodiment of the present invention is mounted on a building are described with reference to FIG. 30A and FIG. 30B.

A house illustrated in FIG. 30A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 30B shows an example of a power storage device of one embodiment of the present invention. As shown in FIG. 30B, a power storage device 791 of one embodiment of the present invention is provided in an underfloor space 796 of a building 799. The power storage device 791 may be provided with the control circuit described in Embodiment 6, and when a secondary battery including the positive electrode active material 100 obtained in Embodiment 1 and Embodiment 2 is used for the power storage device 791, the synergy on safety can be obtained. The secondary battery including the control circuit described in Embodiment 6 and a positive electrode using the positive electrode active material 100 described in Embodiment 1 can contribute greatly to elimination of accidents due to the power storage device 791 including secondary batteries, such as fires.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not shown).

The general load 707 is, for example, an electronic device such as a TV or a personal computer. The power storage load 708 is, for example, an electronic device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charging and discharging plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable information terminal such as a smartphone or a tablet through the router 709. With the indicator 706, the electronic device, or the portable information terminal, for example, the demand for electric power depending on a time period (or per hour) that is predicted by the predicting portion 712 can be checked.

This embodiment can be implemented in appropriate combination with any of the other embodiments.

### Embodiment 9

In this embodiment, examples in which a motorcycle or a bicycle is provided with the power storage device which is one embodiment of the present invention will be described.

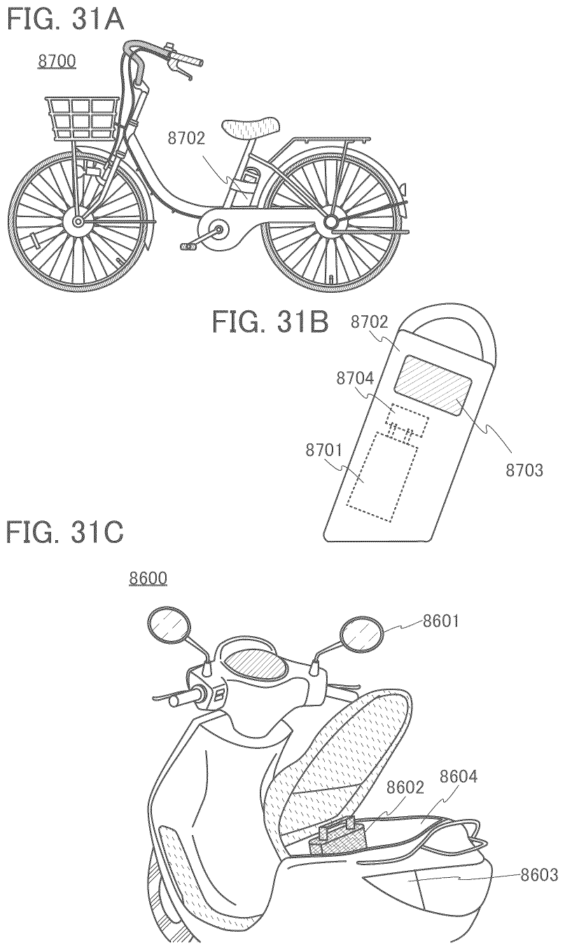

FIG. 31A illustrates an example of an electric bicycle using the power storage device of one embodiment of the present invention. The power storage device of one embodiment of the present invention can be used for an electric bicycle 8700 illustrated in FIG. 31A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 31B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery. The control circuit 8704 is electrically connected to a positive electrode and a negative electrode of the storage battery 8701. The control circuit 8704 may be provided with the small solid-state secondary battery illustrated in FIG. 27A and FIG. 27B. When the small solid-state secondary battery illustrated in FIG. 27A and FIG. 27B is provided in the control circuit 8704, electric power can be supplied to store data in a memory circuit included in the control circuit 8704 for a long time. When the control circuit 8704 is used in combination with a secondary battery including a positive electrode using the positive electrode active material 100 obtained in Embodiment 1, the synergy on safety can be obtained. The secondary battery including a positive electrode using the positive electrode active material 100 obtained in Embodiment 1 and the control circuit 8704 can contribute greatly to elimination of accidents due to secondary batteries, such as fires.

FIG. 31C illustrates an example of a motorcycle using the power storage device of one embodiment of the present invention. An electric bicycle (motor scooter) 8600 illustrated in FIG. 31C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiment 1 can have high capacity and contribute to a reduction in size.

In the motor scooter 8600 illustrated in FIG. 31C, the power storage device 8602 can be stored in a storage unit under seat 8604. The power storage device 8602 can be stored in the storage unit under seat 8604 even with a small size.

### Embodiment 10

In this embodiment, examples in which the secondary battery which is one embodiment of the present invention is mounted on one or both of an electronic device and a lighting device are described. Examples of the electronic device on which the secondary battery is mounted include a television device (also referred to as a TV or a television receiver), a monitor of a computer and the like, a digital camera, a digital video camera, a digital photo frame, a mobile phone (also referred to as a cellular phone or a mobile phone device), a smartphone, a portable game console, a portable music player, a portable information terminal, an audio reproducing device, and a large-sized game machine such as a pachinko machine. Examples of the portable information terminal include a laptop personal computer, a tablet terminal, an e-book terminal, a mobile phone, and a hair iron.

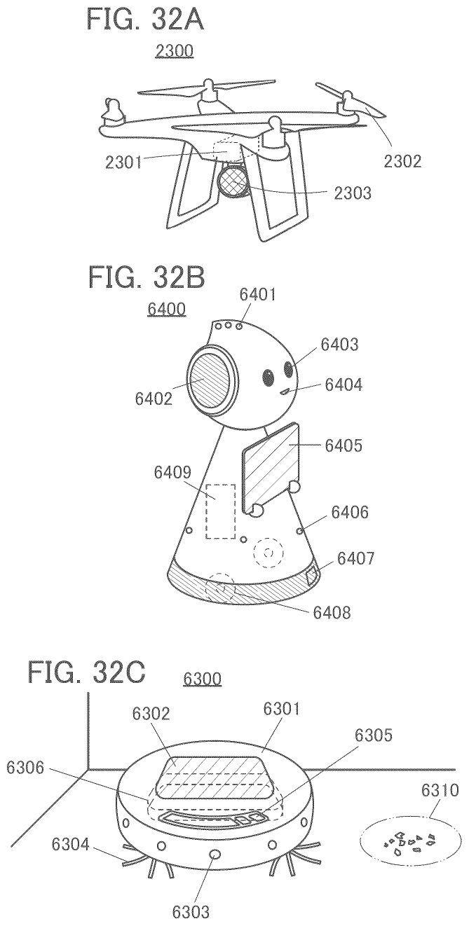

FIG. 32A illustrates an unmanned aircraft 2300 that includes a plurality of rotors 2302. The unmanned aircraft 2300 is also referred to as a drone. The unmanned aircraft 2300 includes a secondary battery 2301 which is one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiment 1 and Embodiment 2 has high energy density and a high level of safety, and thus can be used safely for a long time over a long period of time and is preferable as the secondary battery included in the unmanned aircraft 2300.

FIG. 32B shows an example of a robot. A robot 6400 illustrated in FIG. 32B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. A secondary battery including a positive electrode using the positive electrode active material 100 obtained in Embodiment 1 and Embodiment 2 has high energy density and a high level of safety, and thus can be used safely for a long time over a long period of time and is preferable as the secondary battery 6409 included in the robot 6400.

FIG. 32C shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, a secondary battery 6306 of one embodiment of the present invention and a semiconductor device or an electronic component. A secondary battery including a positive electrode using the positive electrode active material 100 obtained in Embodiment 1 and Embodiment 2 has high energy density and a high level of safety, and thus can be used safely for a long time over a long period of time and is preferable as the secondary battery 6306 included in the cleaning robot 6300.

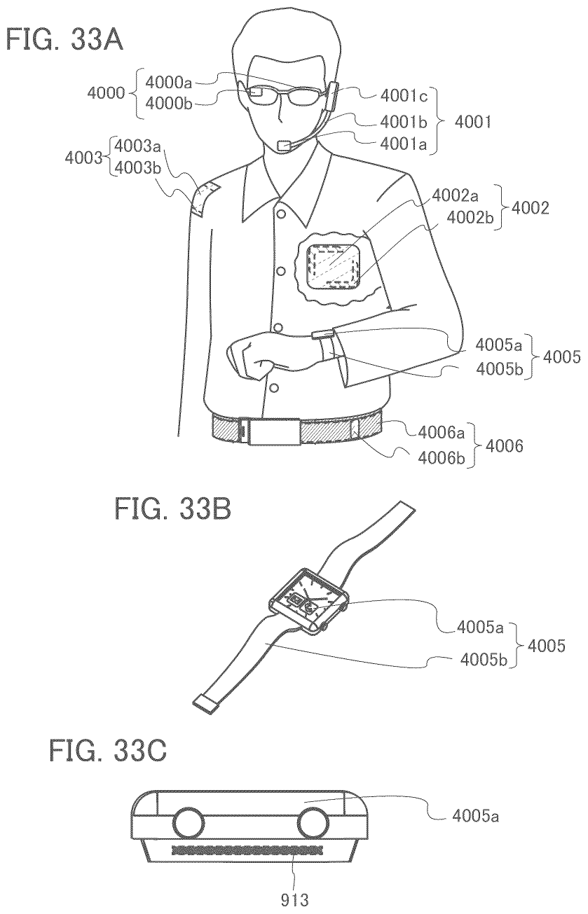

FIG. 33A shows examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery which is one embodiment of the present invention can be provided in a glasses-type device 4000 illustrated in FIG. 33A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiment 1 and Embodiment 2 has high energy density and achieves a structure that accommodates space saving due to a reduction in size of the housing.

The secondary battery which is one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiment 1 and Embodiment 2 has high energy density and achieves a structure that accommodates space saving due to a reduction in size of the housing.

The secondary battery which is one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiment 1 and Embodiment 2 has high energy density and achieves a structure that accommodates space saving due to a reduction in size of the housing.

The secondary battery which is one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiment 1 and Embodiment 2 has high energy density and achieves a structure that accommodates space saving due to a reduction in size of the housing.

The secondary battery which is one embodiment of the present invention can be provided in a belt-type device 4006. The belt-type device 4006 includes a belt portion 4006a and a wireless power feeding and receiving portion 4006b, and the secondary battery can be provided in an inner region of the belt portion 4006a. A secondary battery including a positive electrode using the positive electrode active material 100 obtained in Embodiment 1 and Embodiment 2 has high energy density and achieves a structure that accommodates space saving due to a reduction in size of the housing.

The secondary battery which is one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiment 1 and Embodiment 2 has high energy density and achieves a structure that accommodates space saving due to a reduction in size of the housing.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 33B is a perspective view of the watch-type device 4005 that is detached from an arm.

FIG. 33C is a side view. FIG. 33C illustrates a state where the secondary battery 913 is incorporated in an inner region. The secondary battery 913 is provided to overlap with the display portion 4005a, can have high density and high capacity, and is small and lightweight.

Since the secondary battery in the watch-type device 4005 is required to be small and lightweight, the use of the positive electrode active material 100 obtained in Embodiment 1 and Embodiment 2 in the positive electrode of the secondary battery 913 enables the secondary battery 913 to have high energy density and a small size.

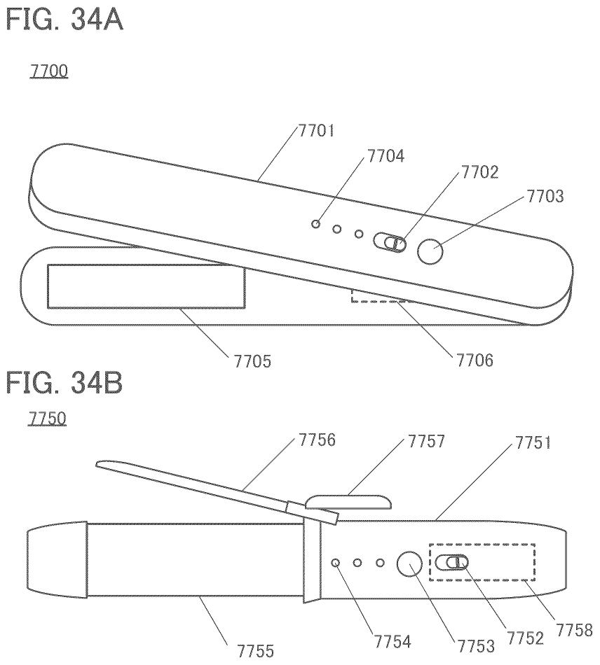

FIG. 34A is a diagram illustrating a hair iron. In FIG. 34A, a hair iron 7700 includes a handle 7701, a power switch 7702, a temperature switching button 7703, temperature lamps 7704, a plate 7705, and a secondary battery 7706. To improve safety, a protection circuit that prevents overcharging and/or overdischarging of the secondary battery 7706 may be electrically connected to the secondary battery 7706. The hair iron 7700 includes an external terminal for connection to a code for charging. A heater for heating the plate 7705 is provided inside the plate 7705. A power source of the heater is the secondary battery 7706. The secondary battery 7706 is preferably lightweight. With the secondary battery of one embodiment of the present invention, which has high capacity and excellent cycle performance, the lightweight hair iron 7700 that can be used for a long time over a long period can be provided.

FIG. 34B is a diagram of a hair iron whose type is different from that of the hair iron illustrated in FIG. 34A. In FIG. 34B, a hair iron 7750 includes a handle 7751, a power switch 7752, a temperature switching button 7753, temperature lamps 7754, a pipe 7755, an auxiliary bar 7756, a lever 7757, a secondary battery 7758, and a connection terminal (not illustrated). To improve safety, a protection circuit that prevents overcharging and/or overdischarging of the secondary battery 7758 may be electrically connected to the secondary battery 7758. The hair iron 7750 includes an external terminal for connection to a code for charging. A heater for heating the pipe 7755 is provided inside the pipe 7755. A power source of the heater is the secondary battery 7758. The secondary battery 7758 is preferably lightweight. With the secondary battery of one embodiment of the present invention, which has high capacity and excellent cycle performance, the lightweight hair iron 7750 that can be used for a long time over a long period can be provided.

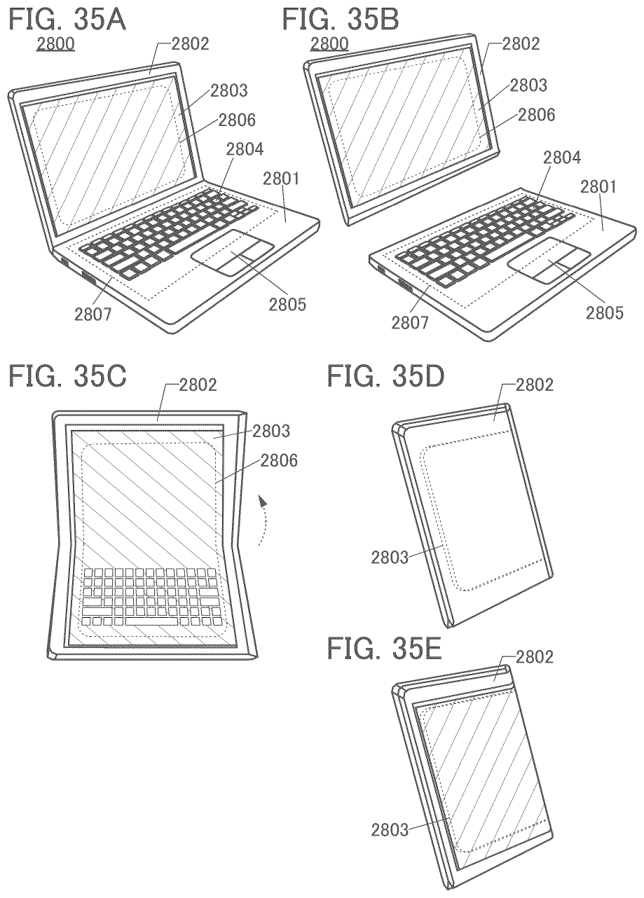

A personal computer 2800 illustrated in FIG. 35A includes a housing 2801, a housing 2802, a display portion 2803, a keyboard 2804, a pointing device 2805, and the like. A secondary battery 2807 is provided inside the housing 2801, and a secondary battery 2806 is provided inside the housing 2802. To improve safety, a protection circuit that prevents overcharging and/or overdischarging of the secondary battery 2807 may be electrically connected to the secondary battery 2807. A touch panel is used for the display portion 2803. As illustrated in FIG. 35B, the housing 2801 and the housing 2802 of the personal computer 2800 can be detached and the housing 2802 can be used alone as a tablet terminal.

The large secondary battery obtained by the method for manufacturing the secondary battery of one embodiment of the present invention can be used as one or both of the secondary battery 2806 and the secondary battery 2807. The shape of the secondary battery obtained by the method for manufacturing the secondary battery of one embodiment of the present invention can be changed freely by changing the shape of the exterior body. When the shapes of the secondary batteries 2806 and 2807 fit with the shapes of the housings 2801 and 2802, for example, the secondary batteries can have high capacity and thus the operating time of the personal computer 2800 can be lengthened. Moreover, the weight of the personal computer 2800 can be reduced.

A flexible display is used for the display portion 2803 of the housing 2802. As the secondary battery 2806, the large secondary battery obtained by the method for manufacturing the secondary battery of one embodiment of the present invention is used. With the use of a flexible film as the exterior body in the large secondary battery obtained by the method for manufacturing the secondary battery of one embodiment of the present invention, a bendable secondary battery can be obtained. Thus, as illustrated in FIG. 35C, the housing 2802 can be used while being bent. In that case, part of the display portion 2803 can be used as a keyboard as illustrated in FIG. 35C.

Furthermore, the housing 2802 can be folded such that the display portion 2803 is placed inward as illustrated in FIG. 35D, and the housing 2802 can be folded such that the display portion 2803 faces outward as illustrated in FIG. 35E.

A bendable secondary battery to which the secondary battery of one embodiment of the present invention is applied can be mounted on an electronic device. In addition, the secondary battery can be incorporated along a curved inside/outside wall surface of a house or a building or a curved interior/exterior surface of a motor vehicle.

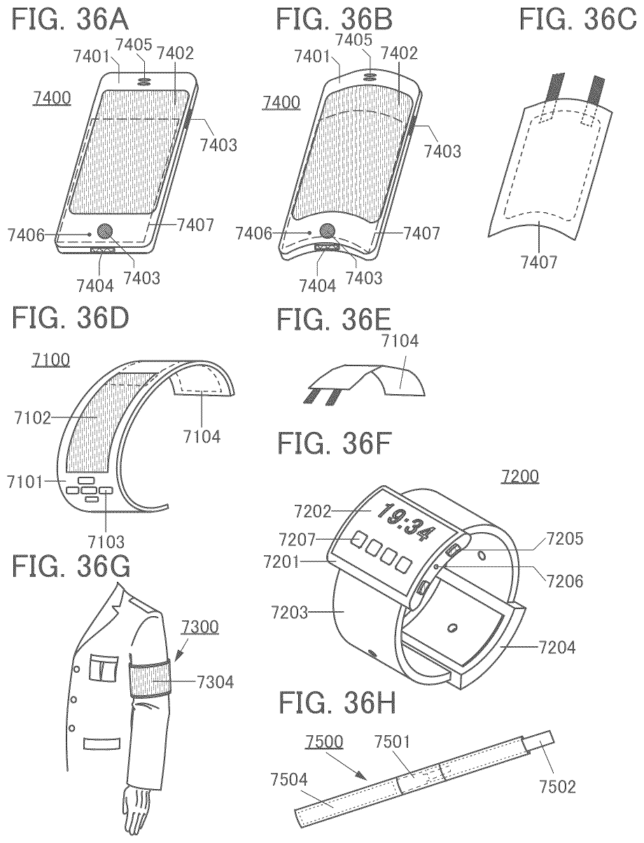

FIG. 36A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided. To improve safety, a protection circuit that prevents overcharging and/or overdischarging of the secondary battery 7407 may be electrically connected to the secondary battery 7407.

FIG. 36B illustrates the mobile phone 7400 that is curved. When the whole mobile phone 7400 is curved by external force, the secondary battery 7407 provided therein is also curved. FIG. 36C illustrates the secondary battery 7407 that is being bent at that time. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 36D shows an example of a bangle display device. A portable display device 7100 includes a housing 7101, a display portion 7102, operation buttons 7103, and a secondary battery 7104. To improve safety, a protection circuit that prevents overcharging and/or overdischarging of the secondary battery 7104 may be electrically connected to the secondary battery 7104. FIG. 36E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 36F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. To improve safety, a protection circuit that prevents overcharging and/or overdischarging of the secondary battery may be electrically connected to the secondary battery. For example, the secondary battery 7104 illustrated in FIG. 36E that is in the state of being curved can be provided in the housing 7201. Alternatively, the secondary battery 7104 illustrated in FIG. 36E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 36G shows an example of an armband display device. A display device 7300 includes a display portion 7304 and the secondary battery of one embodiment of the present invention. To improve safety, a protection circuit that prevents overcharging and/or overdischarging of the secondary battery may be electrically connected to the secondary battery. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

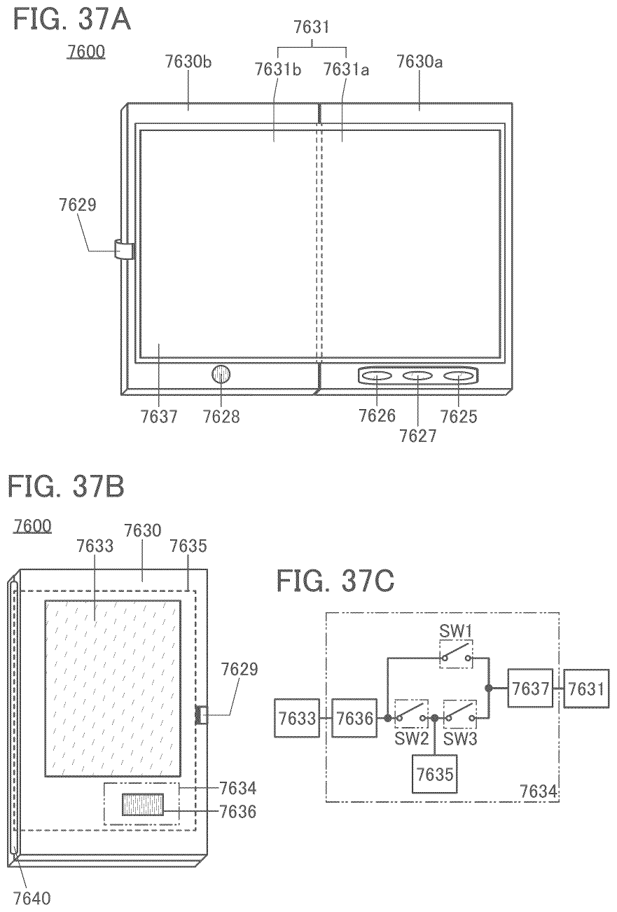

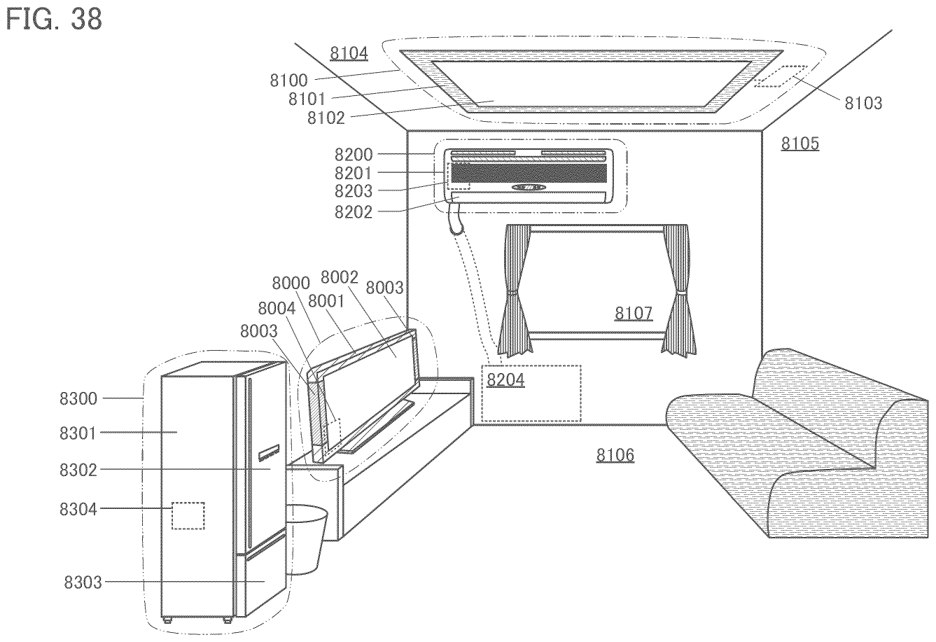

Examples in which the secondary battery of one embodiment of the present invention with excellent cycle performance is mounted on electronic devices are described with reference to FIG. 36H, FIG. 37, and FIG. 38.

When the secondary battery of one embodiment of the present invention is used as a secondary battery of an electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 36H is a perspective view of a device called a cigarette smoking device (electronic cigarette). In FIG. 36H, an electronic cigarette 7500 includes an atomizer 7501 including a heating element, a secondary battery 7504 that supplies electric power to the atomizer, and a cartridge 7502 including a liquid supply bottle, a sensor, or the like. To improve safety, a protection circuit that prevents overcharging and/or overdischarging of the secondary battery 7504 may be electrically connected to the secondary battery 7504. The secondary battery 7504 illustrated in FIG. 36H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIG. 37A and FIG. 37B show an example of a tablet terminal that can be folded in half A tablet terminal 7600 illustrated in FIG. 37A and FIG. 37B includes a housing 7630a, a housing 7630b, a movable portion 7640 connecting the housing 7630a and the housing 7630b to each other, a display portion 7631 including a display portion 7631a and a display portion 7631b, a switch 7625 to a switch 7627, a fastener 7629, and an operation switch 7628. A flexible panel is used for the display portion 7631, whereby a tablet terminal with a larger display portion can be provided. FIG. 37A illustrates the tablet terminal 7600 that is opened, and FIG. 37B illustrates the tablet terminal 7600 that is closed.

The tablet terminal 7600 includes a power storage unit 7635 inside the housing 7630a and the housing 7630b. The power storage unit 7635 is provided across the housing 7630a and the housing 7630b, passing through the movable portion 7640.

The entire region or part of the region of the display portion 7631 can be a touch panel region, and data can be input by touching text, an input form, an image including an icon, and the like displayed on the region. For example, it is possible that keyboard buttons are displayed on the entire display portion 7631a on the housing 7630a side, and data such as text or an image is displayed on the display portion 7631b on the housing 7630b side.

It is possible that a keyboard is displayed on the display portion 7631b on the housing 7630b side, and data such as text or an image is displayed on the display portion 7631a on the housing 7630a side. Furthermore, it is possible that a switching button for showing/hiding a keyboard on a touch panel is displayed on the display portion 7631 and the button is touched with a finger, a stylus, or the like to display a keyboard on the display portion 7631.

Touch input can be performed concurrently in a touch panel region in the display portion 7631a on the housing 7630a side and a touch panel region in the display portion 7631b on the housing 7630b side.

The switch 7625 to the switch 7627 may function not only as an interface for operating the tablet terminal 7600 but also as an interface that can switch various functions. For example, at least one of the switch 7625 to the switch 7627 may function as a switch for switching power on/off of the tablet terminal 7600. For another example, at least one of the switch 7625 to the switch 7627 may have a function of switching the display orientation between a portrait mode and a landscape mode or a function of switching display between monochrome display and color display. For another example, at least one of the switch 7625 to the switch 7627 may have a function of adjusting the luminance of the display portion 7631. The luminance of the display portion 7631 can be optimized in accordance with the amount of external light in use of the tablet terminal 7600 detected by an optical sensor incorporated in the tablet terminal 7600. Note that another sensing device including a sensor for sensing inclination, such as a gyroscope sensor or an acceleration sensor, may be incorporated in the tablet terminal, in addition to the optical sensor.

FIG. 37A shows an example in which the display portion 7631a on the housing 7630a side and the display portion 7631b on the housing 7630b side have substantially the same display area; however, there is no particular limitation on the display areas of the display portion 7631a and the display portion 7631b, and the display portions may have different sizes or different display quality. For example, one may be a display panel that can display higher-definition images than the other.

The tablet terminal 7600 is folded in half in FIG. 37B. The tablet terminal 7600 includes a housing 7630, a solar cell 7633, and a charging and discharging control circuit 7634 including a DCDC converter 7636. The secondary battery of one embodiment of the present invention is used as the power storage unit 7635.

Note that as described above, the tablet terminal 7600 can be folded in half, and thus can be folded when not in use such that the housing 7630a and the housing 7630b overlap with each other. By the folding, the display portion 7631 can be protected, which increases the durability of the tablet terminal 7600. With the power storage unit 7635 including the secondary battery of one embodiment of the present invention, which has high capacity and excellent cycle performance, the tablet terminal 7600 that can be used for a long time over a long period can be provided. To improve safety, a protection circuit that prevents overcharging and/or overdischarging of the secondary battery included in the power storage unit 7635 may be electrically connected to the secondary battery.

In addition, the tablet terminal 7600 illustrated in FIG. 37A and FIG. 37B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 7633, which is attached on the surface of the tablet terminal 7600, can supply electric power to a touch panel, a display portion, a video signal processing portion, and the like. Note that the solar cell 7633 can be provided on one surface or both surfaces of the housing 7630 and the power storage unit 7635 can be charged efficiently. The use of a lithium-ion battery as the power storage unit 7635 brings an advantage such as a reduction in size.

The structure and operation of the charging and discharging control circuit 7634 illustrated in FIG. 37B are described with reference to a block diagram in FIG. 37C. The solar cell 7633, the power storage unit 7635, the DCDC converter 7636, a converter 7637, a switch SW1 to a switch SW3, and the display portion 7631 are illustrated in FIG. 37C, and the power storage unit 7635, the DCDC converter 7636, the converter 7637, and the switch SW1 to the switch SW3 correspond to the charging and discharging control circuit 7634 illustrated in FIG. 37B.

First, an operation example in which electric power is generated by the solar cell 7633 using external light is described. The voltage of electric power generated by the solar cell is raised or lowered by the DCDC converter 7636 to a voltage for charging the power storage unit 7635. When the display portion 7631 is operated with the electric power from the solar cell 7633, the switch SW1 is turned on and the voltage is raised or lowered by the converter 7637 to a voltage needed for the display portion 7631. When display on the display portion 7631 is not performed, the switch SW1 is turned off and the switch SW2 is turned on, so that the power storage unit 7635 is charged.

Note that the solar cell 7633 is described as an example of a power generation unit; however, one embodiment of the present invention is not limited to this example. The power storage unit 7635 may be charged using another power generation unit such as a piezoelectric element or a thermoelectric conversion element (Peltier element). For example, the charging may be performed with a non-contact electric power transmission module that performs charging by transmitting and receiving electric power wirelessly (without contact), or with a combination of other charge units.

FIG. 38 illustrates other examples of electronic devices. In FIG. 38, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. To improve safety, a protection circuit that prevents overcharging and/or overdischarging of the secondary battery 8004 may be electrically connected to the secondary battery 8004. The secondary battery 8004 of one embodiment of the present invention is provided in the housing 8001. The display device 8000 can be supplied with electric power from a commercial power source and can use electric power stored in the secondary battery 8004. Thus, the display device 8000 can be operated with the use of the secondary battery 8004 of one embodiment of the present invention as an uninterruptible power source even when electric power cannot be supplied from a commercial power source due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 38, an installation lighting device 8100 is an example of an electronic device including a secondary battery 8103 of one embodiment of the present invention. Specifically, the lighting device 8100 includes a housing 8101, alight source 8102, the secondary battery 8103, and the like. To improve safety, a protection circuit that prevents overcharging and/or overdischarging of the secondary battery 8103 may be electrically connected to the secondary battery 8103. Although FIG. 38 illustrates the case where the secondary battery 8103 is provided in a ceiling 8104 on which the housing 8101 and the light source 8102 are installed as an example, the secondary battery 8103 may be provided in the housing 8101. The lighting device 8100 can be supplied with electric power from a commercial power source and can use electric power stored in the secondary battery 8103. Thus, the lighting device 8100 can be operated with the use of the secondary battery 8103 of one embodiment of the present invention as an uninterruptible power source even when electric power cannot be supplied from a commercial power source due to power failure or the like.

Note that although the installation lighting device 8100 provided in the ceiling 8104 is illustrated in FIG. 38 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 38, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. To improve safety, a protection circuit that prevents overcharging and/or overdischarging of the secondary battery 8203 may be electrically connected to the secondary battery 8203. Although FIG. 38 illustrates the case where the secondary battery 8203 is provided in the indoor unit 8200 as an example, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power source and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power source even when electric power cannot be supplied from a commercial power source due to power failure or the like.

Note that although the split-type air conditioner including the indoor unit and the outdoor unit is illustrated in FIG. 38 as an example, the secondary battery of one embodiment of the present invention can be used in an air conditioner in which the function of an indoor unit and the function of an outdoor unit are integrated in one housing.

In FIG. 38, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. To improve safety, a protection circuit that prevents overcharging and/or overdischarging of the secondary battery 8304 may be electrically connected to the secondary battery 8304. The secondary battery 8304 is provided in the housing 8301 in FIG. 38. The electric refrigerator-freezer 8300 can be supplied with electric power from a commercial power source and can use electric power stored in the secondary battery 8304. Thus, the electric refrigerator-freezer 8300 can be operated with the use of the secondary battery 8304 of one embodiment of the present invention as an uninterruptible power source even when electric power cannot be supplied from a commercial power source due to power failure or the like.

Note that among the electronic devices described above, a high-frequency heating apparatus such as a microwave oven and an electronic device such as an electric rice cooker require high electric power in a short time. Therefore, the tripping of a breaker of a commercial power source in use of the electronic device can be prevented by using the secondary battery of one embodiment of the present invention as an auxiliary power source for supplying electric power which cannot be supplied enough by a commercial power source.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power source.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery which is one embodiment of the present invention is used in the electronic device described in this embodiment, whereby a more lightweight electronic device with a longer lifetime can be obtained.

This embodiment can be implemented in appropriate combination with the other embodiments.

### Example 1

In this example, positive electrode active materials were formed in accordance with the formation methods described in the embodiment and the like and the results of obtaining battery characteristics are shown.

### <Formation of Positive Electrode Active Material>

Samples 1 to 3 were prepared with reference to Formation method 4 described in Embodiment 1 and FIG. 4, for example. Hereinafter, the formation steps will be described in detail.

### <Samples 1 to 3>

First, pure water in which cobalt sulfate is dissolved was prepared as the aqueous solution 890 (a cobalt aqueous solution) shown in FIG. 4 and first glycine was added thereto as a chelate agent, whereby the mixed solution 901 was prepared. The molar concentrations of the cobalt sulfate and the first glycine were adjusted to be 2 mol/L and 0.075 mol/L, respectively.

Next, pure water in which sodium hydroxide is dissolved was prepared as the aqueous solution 892 (an alkaline aqueous solution) shown in FIG. 4. The molar concentration of the sodium hydroxide was adjusted to be 5 mol/L. An aqueous solution containing second glycine dissolved in pure water was prepared as the aqueous solution 894 (a chelate agent). Note that the molar concentration of the second glycine was adjusted to be equal to that of the first glycine. The aqueous solution containing the second glycine was put in a reaction container in advance.

The mixed solution 901 and the sodium hydroxide aqueous solution were dropped into the second glycine aqueous solution. Flowing of nitrogen was performed at a flow rate of 1 L/min, whereby the reaction container had a nitrogen-containing atmosphere. The rotational frequency of a stirring blade was 1000 rpm and the temperature of the aqueous solution in the reaction container was kept at 70° C. Moreover, the dropping rate of the sodium hydroxide aqueous solution was adjusted so that the pH of the aqueous solution in the reaction container was kept at 10.3. Then, a precipitate was generated in the reaction container. The precipitate contained cobalt hydroxide.

In order to obtain the cobalt hydroxide, the aqueous solution in the reaction container was filtered and unnecessary moisture was removed. Before the filtration, a step of washing the precipitate with pure water and a step of washing the precipitate with acetone were sequentially performed.

Next, a drying step was performed to remove moisture of the precipitate. The precipitate after the filtration was moved to a petri dish, the petri dish was placed in bell jar type vacuum equipment, and the pressure was reduced until a differential pressure gauge shows −0.1 MPa. That is, a vacuum state was obtained with use of the bell jar type vacuum equipment and the precipitate after the filtration was dried at 80° C. for 1 hour in the vacuum state. The resulting object used as the cobalt compound 880 and lithium hydroxide used as the lithium compound 881 were mixed, whereby the mixture 903 was formed. The cobalt compound 880 and the lithium hydroxide were weighed so that the Li/Co ratio was 1.01 and they were mixed, whereby the mixture 903 was obtained. For the mixing, a mixer (a planetary centrifugal mixer Awatorirentaro produced by THINKY CORPORATION) was used.

### <Heating Conditions for Samples 1 to 3>

Next, heating was performed on the mixture 903. The heating temperatures were 750° C., 850° C., and 950° C. for Samples 1, 2, and 3, respectively. As conditions common to Samples 1 to 3, the heating time was 10 hours and the heating atmosphere was an oxygen atmosphere. In order to make the oxygen atmosphere, specifically, flowing of an oxygen gas was continuously performed at a flow rate of 5 L/min.

### <XRD Analysis Results of Samples 1 to 3>

Samples 1 to 3 were subjected to XRD measurement. The conditions are as follows.

X-ray source: CuKα₁ radiation

### Output: 40 KV, 40 mA

Slit width: Div. Slit, 0.5°

### Detector: LynxEye

Scanning method: 2θ/θ continuous scanning
Measurement range (2θ): from 15° to 90°
Step width (2θ): 0.01°
Counting time: 1 second/step
Rotation of sample stage: 15 rpm

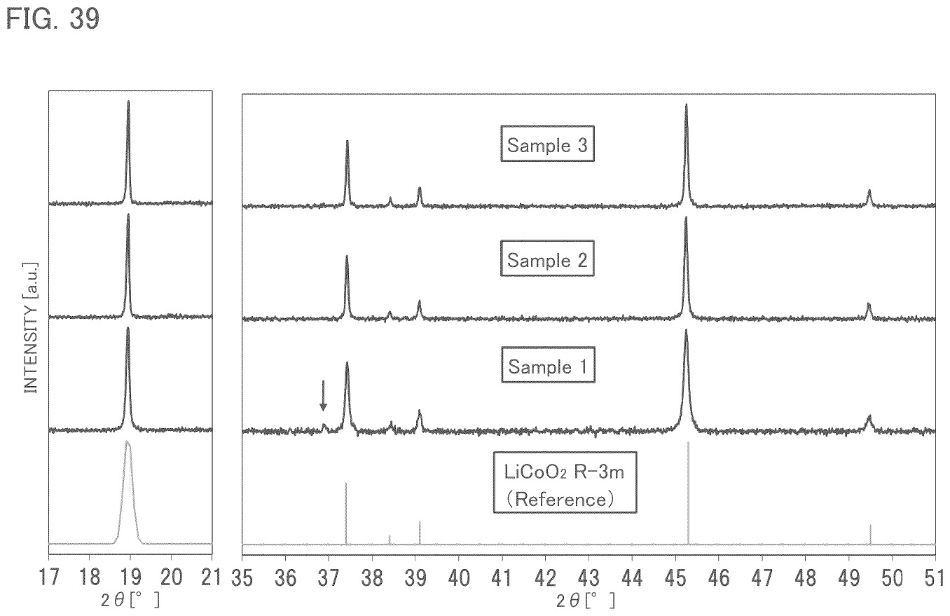

FIG. 39 shows XRD analysis results. FIG. 39 also shows the XRD analysis results of the R-3m crystal structure of LiCoO₂ as a reference. In Samples 1 to 3, peaks were observed at the same positions as those in the reference. The positions of the peaks can be found in FIG. 39. In Sample 1, a peak that does not exist in the reference (a peak at a position at which 20 is greater than or equal to 36.5° and less than 37°) was observed at a position of 20 denoted by an arrow. The heating temperature for Sample 1 was the lowest and it is considered that cobalt hydroxide that did not react with a Li source thermally decomposed, tricobalt tetraoxide (Co₃O₄) was generated, and a peak corresponding to Co₃O₄ was observed. In Samples 2 and 3, such a peak that does not exist in the reference was not observed. Table 1 lists lattice constants, half widths of peaks at around 20=180 and peaks at around 20=45°, and crystallite sizes.

TABLE 1

| | | | Half width [°] | | Crystal- |
|---|---|---|---|---|---|
| Sample | Lattice constant [nm] | | Around 18° | Around 45° | lite size |
| name | a-axis | c-axis | (003) plane | (104) plane | [nm] |
| Sample 1 | 0.2817 | 1.4058 | 0.09 | 0.112 | 106.7 |
| Sample 2 | 0.2818 | 1.4055 | 0.068 | 0.082 | 171.6 |
| Sample 3 | 0.2817 | 1.4050 | 0.065 | 0.073 | 191.9 |

A smaller half-width value indicates higher crystallinity. It is found that Sample 3 has the smallest half width and high crystallinity. In addition, the crystallite size of Sample 3 is larger than those of Samples 1 and 2, which reveals that the higher the heating temperature is, the larger the crystallite size tends to be.

### <SEM Observation of Samples 1 to 3>

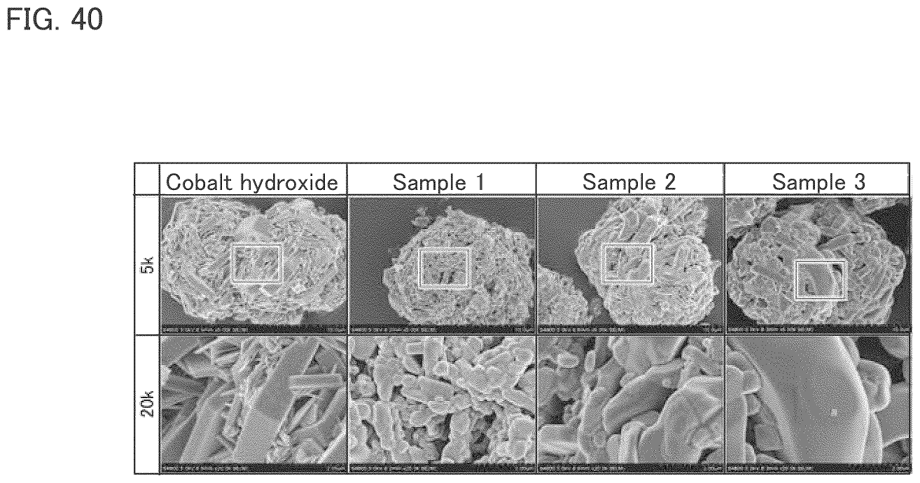

Next, FIG. 40 shows plan SEM images of Samples 1 to 3. FIG. 40 also shows plan SEM images of cobalt hydroxide as a reference. The plan SEM images were obtained with use of S4800 produced by Hitachi High-Tech Corporation, the accelerating voltage was fixed to 5 kV, and the magnifications were 5000 times (5 k) and 20000 times (20 k). As secondary electron detectors, one over a stage (upper) and one beside the stage (lower) were used. An observation region at a magnifcation of 20 k was a region denoted by a frame on the SEM image of 5 k.

It can be found that Samples 1 to 3 are in the form of secondary particles and the shapes of the secondary particles reflect the shape of cobalt hydroxide which is a precursor. The diameter of the secondary particle of each of Samples 1 to 3 was approximately 20 m. In Sample 3, a flat-plate primary particle was observed. It is considered that the thickness direction of the primary particle is a direction parallel to the c-axis of LiCoO₂ and it is considered that Samples 1 to 3 are each the secondary particle in which a large number of planes parallel to the c-axis (sometimes referred to as basal planes) are placed on the surface. A secondary battery including such a secondary particle is expected to have improved rate characteristics. Comparison between Samples 1 to 3 indicates that the diameter of the primary particle is large in Sample 3. That is, it is found that higher heating temperature makes the diameter of the primary particle larger and the diameter of the secondary particle larger.

### <Cycle Test>

A cycle test was performed using Samples 1 to 3. First, Samples 1 to 3 were prepared as positive electrode active materials, acetylene black was prepared as a conductive additive, PVdF was prepared as a binder, and NMP was prepared as a solvent. Slurry for a positive electrode was formed by mixing the positive electrode active material, the conductive additive, and the binder at a weight ratio of 95:3:2 at 2000 rpm for 3 minutes with use of the planetary centrifugal mixer. The slurry for a positive electrode was applied to a positive electrode current collector made of aluminum and dried, whereby a positive electrode was formed.

A lithium metal was prepared for a negative electrode that is a counter electrode.

Next, coin-type cells each including the positive electrode formed by the above-described method, a negative electrode, a separator provided therebetween, and an electrolyte solution with which the separator is impregnated were fabricated. Note that polypropylene was used for the separator. As the electrolyte solution, a solution obtained by adding vinylene carbonate (VC) to a mixed organic solvent of ethylene carbonate (EC) and diethyl carbonate (DEC) (a volume ratio of EC to DEC=3:7) as an additive agent at 2 wt % and dissolving lithium hexafluorophosphate (LiPF₆) at a molar concentration of 1 in the mixture was used.

Next, the coin-type cells fabricated by the above-described method were subjected to the cycle test.

The conditions of the cycle test were as follows: charging was performed under a constant current/constant voltage (CC/CV) condition to an upper limit voltage (end-of-charge voltage) of 4.6 V at 0.5 C, constant voltage charging was performed until a current value reached 0.05 C, discharging was performed under a constant current (CC) condition to a lower limit voltage (end-of-discharge voltage) of 2.5 V at 0.5 C, and then the discharge capacity was measured at a measurement temperature of 25° C.

In addition, 50 cycles of the above charging and discharging were performed and then the discharge capacity was obtained. It can be said that higher discharge capacity is preferable as the performance of a secondary battery.

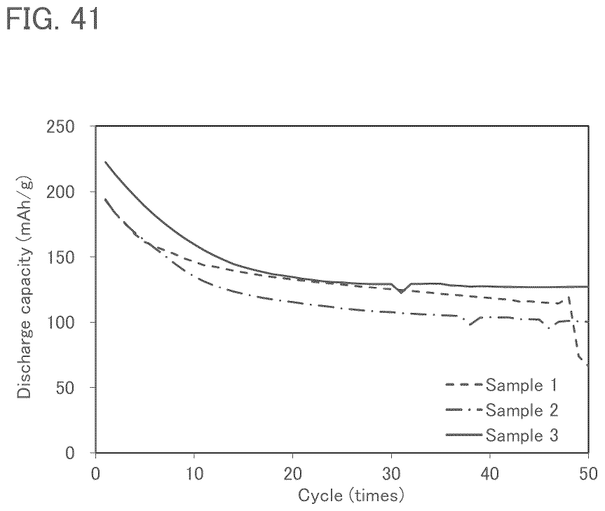

FIG. 41 shows the results of the discharge capacity in the above-described cycle test. It was found from FIG. 41 that the secondary battery including the positive electrode active material of Sample 3 has a battery characteristic of the highest discharge capacity. The maximum discharge capacities of Sample 1, Sample 2, and Sample 3 were 193 (mAh/g), 194 (mAh/g), and 222 (mAh/g), respectively.

### Example 2

In this example, positive electrode active materials were formed in accordance with the formation methods described in the embodiment and the like and the results of obtaining battery characteristics are shown. Samples 4 and 5 were newly prepared with reference to Formation method 4 described in Embodiment 1 and FIG. 4, for example. Hereinafter, the formation steps will be described in detail.

### <Samples 4 and 5>

In order to consider a lithium source, a material used for the lithium compound 881 differed between Samples 4 and 5. For Sample 4, cobalt hydroxide obtained in a manner similar to that in Example 1 and lithium carbonate were mixed with use of the planetary centrifugal mixer, whereby the mixture 903 was obtained. For Sample 5, cobalt hydroxide obtained in a manner similar to that in Example 1 and lithium hydroxide were mixed, whereby the mixture 903 was obtained.

Next, heating was performed on the mixture 903. The heating temperature was 950° C., the heating time was 10 hours, and the heating atmosphere was an oxygen atmosphere. In order to make the oxygen atmosphere, specifically, flowing of an oxygen gas was continuously performed at a flow rate of 5 L/min.

### <Cycle Test>

In order to perform cycle tests using Samples 4 and 5, coin-type cells were fabricated using Samples 4 and 5 as positive electrode active materials under the conditions similar to those in Example 1. The coin-type cells fabricated by the above-described method were subjected to the cycle tests. The conditions of the cycle tests were as follows: charging was performed under a constant current/constant voltage (CC/CV) condition to an upper limit voltage (end-of-charge voltage) of 4.4 V or 4.6 V at 0.5 C, constant voltage charging was performed until a current value reached 0.05 C, discharging was performed under a constant current (CC) condition to a lower limit voltage (end-of-discharge voltage) of 2.5 V at 0.5 C, and then the discharge capacity was measured at a measurement temperature of 25° C.

In addition, 50 cycles of the above charging and discharging were performed and then the discharge capacity was obtained. It can be said that higher discharge capacity is preferable as the performance of a secondary battery.

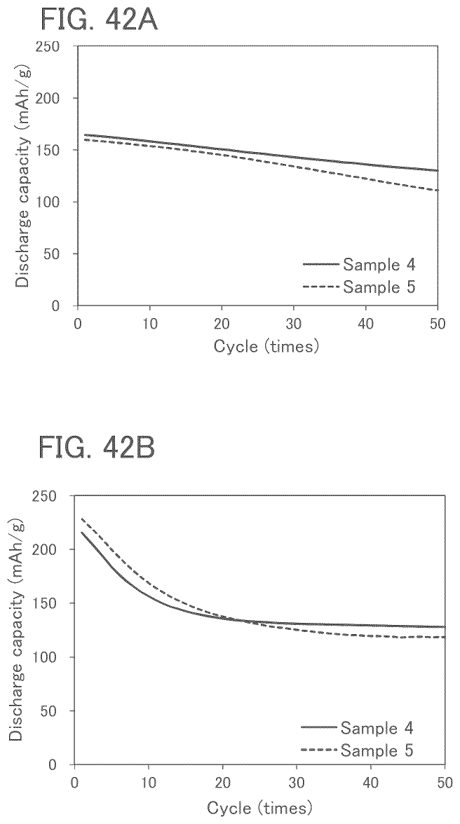

FIG. 42A shows the results of the discharge capacity with an upper limit voltage of 4.4 V and FIG. 42B shows the results of the discharge capacity with an upper limit voltage of 4.6 V. It is found from FIG. 42A and FIG. 42B that the positive electrode active material formed using lithium carbonate, such as Sample 4, and the positive electrode active material formed using lithium hydroxide, such as Sample 5, achieve sufficient discharge capacity. It is found from FIG. 42A that the use of lithium carbonate increases discharge capacity.

It was confirmed that a secondary battery including such a positive electrode active material has a battery characteristic of high discharge capacity.

### Example 3

In this example, positive electrode active materials were formed in accordance with the formation methods described in the embodiment and the like and the results of obtaining battery characteristics are shown. Samples 6 to 8 were newly prepared with reference to Formation method 4 described in Embodiment 1 and FIG. 4, for example. Hereinafter, the formation steps will be described in detail.

### <Samples 6 to 8>

In order to consider an optimal Li/Co ratio in the case of using lithium carbonate as a Li source, the mixing amount of lithium carbonate differed between Samples 6 to 8. For Sample 6, lithium carbonate and cobalt hydroxide were weighed so that the molar ratio (Li/Co ratio) of lithium of the lithium carbonate to cobalt of the cobalt hydroxide obtained in a manner similar to that in Example 1 was 1.01 and they were mixed, whereby the mixture 903 was obtained. For Sample 7, lithium carbonate and cobalt hydroxide were weighed so that the Li/Co ratio was 1.03 and they were mixed, whereby the mixture 903 was obtained. For Sample 8, lithium carbonate and cobalt hydroxide were weighed so that the Li/Co ratio was 1.05 and they were mixed, whereby the mixture 903 was obtained. For the mixing, a mixer (a planetary centrifugal mixer Awatorirentaro produced by THINKY CORPORATION) was used.

Next, heating was performed on the mixture 903. The heating temperature was 950° C., the heating time was 10 hours, and the heating atmosphere was an oxygen atmosphere. In order to make the oxygen atmosphere, specifically, flowing of an oxygen gas was continuously performed at a flow rate of 5 L/min.

### <XRD Analysis Results of Samples 6 to 8>

Samples 6 to 8 were subjected to XRD measurement. The conditions of the XRD measurement are the same as the conditions in Example 1.

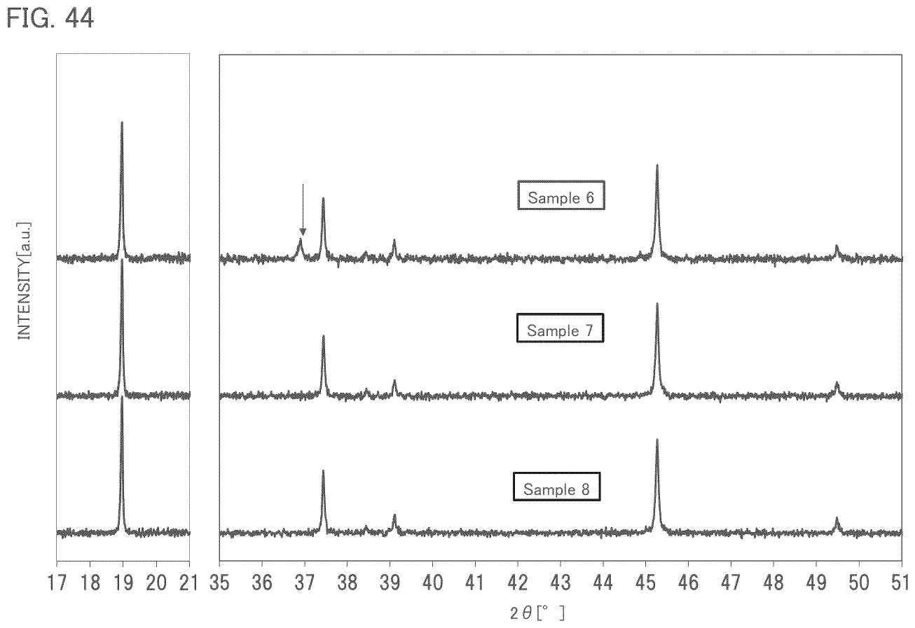

FIG. 44 shows XRD analysis results. Although not shown in FIG. 44, the XRD analysis results of the R-3m crystal structure of LiCoO₂ that are shown as a reference in FIG. 39 showing the results in Example 1 can be referred to. In Samples 6 to 8, peaks were observed at the same positions as those in the reference. The positions of the peaks can be found FIG. 44. In Sample 6, a peak that does not exist in the reference (a peak at a position at which 20 is greater than or equal to 36.5° and less than 37°) was observed at a position of 20 denoted by an arrow. It is considered that in Sample 6, cobalt hydroxide that did not react with a Li source thermally decomposed, tricobalt tetraoxide (Co₃O₄) was generated, and a peak corresponding to Co₃O₄ was observed. In Samples 7 and 8, such a peak that does not exist in the reference was not observed. Table 2 lists lattice constants, half widths of peaks at around 2θ=18° and peaks at around 2θ=45°, and crystallite sizes.

TABLE 2

| | | | Half width [°] | | Crystal- |
|---|---|---|---|---|---|
| Sample | Lattice constant [nm] | | Around 18° | Around 45° | lite size |
| name | a-axis | c-axis | (003) plane | (104) plane | [nm] |
| Sample 6 | 0.2815 | 1.4060 | 0.067 | 0.079 | 223.4 |
| Sample 7 | 0.2816 | 1.4051 | 0.065 | 0.077 | 238.5 |
| Sample 8 | 0.2815 | 1.4051 | 0.063 | 0.078 | 244.0 |

A smaller half-width value indicates higher crystallinity. It is found that Sample 8 has a small half width and high crystallinity. In addition, the crystallite size of Sample 8 is larger than those of Samples 6 and 7, which reveals that the higher the Li/Co ratio is, the larger the crystallite size tends to be.

### <SEM Observation of Samples 6 to 8>

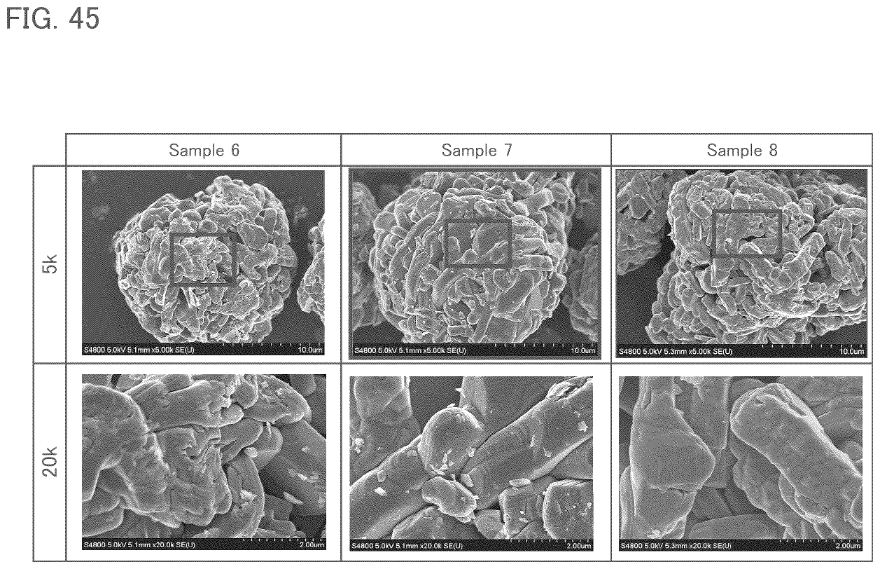

Next, FIG. 45 shows plan SEM images of Samples 6 to 8. The plan SEM images were obtained with use of S4800 produced by Hitachi High-Tech Corporation, the accelerating voltage was fixed to 5 kV, and the magnifications were 5000 times (5 k) and 20000 times (20 k). An observation region at a magnification of 20 k was a region denoted by a frame on the SEM image of 5 k.

The diameter of the secondary particle of each of Samples 6 to 8 was found to be approximately 20 m. In addition, it is found from Samples 6 to 8 that higher Li/Co ratio makes the diameter of the primary particle larger and the diameter of the secondary particle larger.

### <Cycle Test>

In order to perform cycle tests using Samples 6 to 8, coin-type cells were fabricated using Samples 6 to 8 as positive electrode active materials under the conditions similar to those in Example 1. The coin-type cells fabricated by the above-described method were subjected to the cycle tests. The conditions of the cycle tests were as follows: charging was performed under a constant current/constant voltage (CC/CV) condition to an upper limit voltage (end-of-charge voltage) of 4.4 V or 4.6 V at 0.5 C, constant voltage charging was performed until a current value reached 0.05 C, discharging was performed under a constant current (CC) condition to a lower limit voltage (end-of-discharge voltage) of 2.5 V at 0.5 C, and then the discharge capacity was measured at a measurement temperature of 25° C.

In addition, 50 cycles of the above charging and discharging were performed and then the discharge capacity was obtained. It can be said that higher discharge capacity is preferable as the performance of a secondary battery.

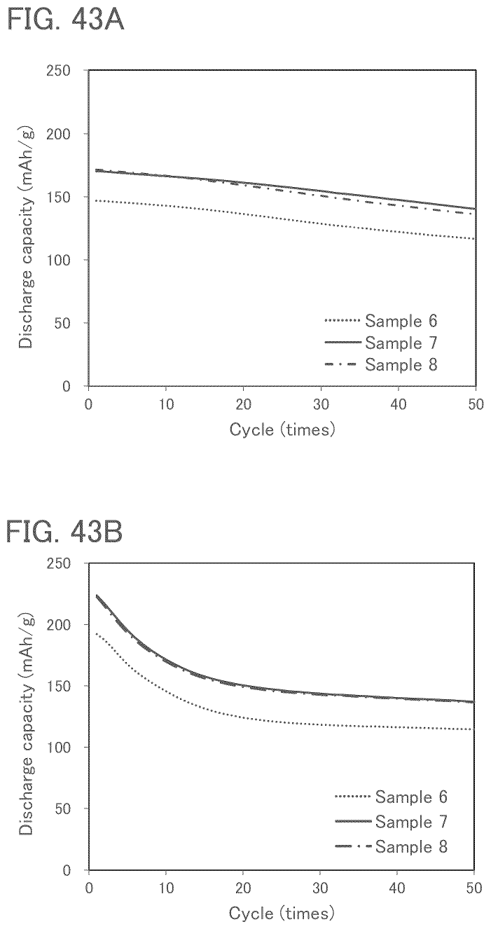

FIG. 43A shows the results of the discharge capacity with an upper limit voltage of 4.4 V and FIG. 43B shows the results of the discharge capacity with an upper limit voltage of 4.6 V. It is found from the results of Samples 6 to 8 in FIG. 42A and FIG. 42B that in the case of using lithium carbonate, the Li/Co ratio is preferably higher than or equal to 1.01 and lower than or equal to 1.05, further preferably 1.03 and the vicinity thereof.

It was confirmed that a secondary battery including such a positive electrode active material has a battery characteristic of high discharge capacity.

### REFERENCE NUMERALS

100: positive electrode active material, 170: coprecipitation synthesis equipment, 171: reaction container, 172: stirring portion, 173: stirring motor, 175: tank, 176: tube, 177: pump, 180: tank, 181: tube, 182: pump, 186: tank, 187: tube, 188: pump, 190: control device, 191: reflux condenser, 192: aqueous solution, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: secondary battery, 514: terminal, 515: sealant, 517: antenna, 519: layer, 529: label, 531: secondary battery pack, 540: circuit board, 550: current collector, 551: positive electrode lead or negative electrode lead, 552: negative electrode lead or positive electrode lead, 553: acetylene black, 554: graphene, 555: carbon nanotube, 561: first positive electrode active material, 562: second positive electrode active material, 590a: circuit system, 590b: circuit system, 590: control circuit, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 615: power storage system, 616: secondary battery, 620: control circuit, 623: wiring, 624: conductor, 626: wiring, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 750a: positive electrode, 750b: solid electrolyte layer, 750c: negative electrode, 751: electrode plate, 752: insulating tube, 753: electrode plate, 761: lower component, 762: upper component, 763: pressure screw, 764: butterfly nut, 765: O ring, 766: insulator, 770a: package component, 770b: package component, 770c: package component, 771: external electrode, 772: external electrode, 773a: electrode layer, 773b: electrode layer, 790: control device, 791: power storage device, 796: underfloor space, 799: building, 880: cobalt compound, 881: lithium compound, 885: first heating, 886: second heating, 887: third heating, 889: second heating, 890: aqueous solution, 891: aqueous solution, 892: aqueous solution, 893: aqueous solution, 894: aqueous solution, 895: third heating, 896: fourth heating, 901: mixed solution, 902: mixed solution, 903: mixture, 904: composite oxide, 905: additive element source, 906: mixture, 907: composite oxide, 908: additive element source, 909: mixture, 910: additive element source, 911a: terminal, 911b: terminal, 911: mixture, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 1300: rectangular secondary battery, 1301a: first battery, 1301b: first battery, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1413: fixing portion, 1414: fixing portion, 1415: battery pack, 1421: wiring, 1422: wiring, 2001: automobile, 2002: transporter, 2003: transport vehicle, 2004: aircraft, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging equipment, 2610: solar panel, 2611: wiring, 2612: power storage device, 2800: personal computer, 2801: housing, 2802: housing, 2803: display portion, 2804: keyboard, 2805: pointing device, 2806: secondary battery, 2807: secondary battery, 4000a: frame, 4000b: display portion, 4000: glasses-type device, 4001a: microphone portion, 4001b: flexible pipe, 4001c: earphone portion, 4001: headset-type device, 4002a: housing, 4002b: secondary battery, 4002: device, 4003a: housing, 4003b: secondary battery, 4003: device, 4005a: display portion, 4005b: belt portion, 4005: watch-type device, 4006a: belt portion, 4006b: wireless power feeding and receiving portion, 4006: belt-type device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 7600: tablet terminal, 7625: switch, 7627: switch, 7628: operation switch, 7629: fastener, 7630a: housing, 7630b: housing, 7630: housing, 7631a: display portion, 7631b: display portion, 7631: display portion, 7633: solar cell, 7634: charging and discharging control circuit, 7635: power storage unit, 7636: DCDC converter, 7637: converter, 7640: movable portion, 7700: hair iron, 7701: handle, 7702: power switch, 7703: temperature switching button, 7704: temperature lamp, 7705: plate, 7706: secondary battery, 7750: hair iron, 7751: handle, 7752: power switch, 7753: temperature switching button, 7754: temperature lamp, 7755: pipe, 7756: auxiliary bar, 7757: lever, 7758: secondary battery, 8000: display device, 8001: housing, 8002: display portion, 8003: speaker portion, 8004: secondary battery, 8100: lighting device, 8101: housing, 8102: light source, 8103: secondary battery, 8104: ceiling, 8105: side wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 8600: motor scooter, 8601: side mirror, 8602: power storage device, 8603: indicator light, 8604: storage unit under seat, 8700: electric bicycle, 8701: storage battery, 8702: power storage device, 8703: display portion, 8704: control circuit

1. A method for forming a positive electrode active material, comprising the steps of:
forming a cobalt compound by reacting a cobalt aqueous solution with an alkaline aqueous solution;
mixing the cobalt compound and a lithium compound and then performing a first heat treatment, thereby forming a first composite oxide;
mixing the first composite oxide and a compound comprising a first additive element and then performing a second heat treatment, thereby forming a second composite oxide; and
mixing the second composite oxide and a compound comprising a second additive element and then performing a third heat treatment,
wherein the first heat treatment is performed at a temperature higher than or equal to 700° C. and lower than or equal to 1100° C.,
wherein the second heat treatment is performed at a temperature higher than or equal to 700° C. and lower than or equal to 1000° C., and
wherein the third heat treatment is performed at a temperature equal to the temperature of the second heat treatment or at a temperature lower than the temperature of the second heat treatment.

2. The method for forming a positive electrode active material, according to claim 1,
wherein the cobalt compound is formed by reacting the cobalt aqueous solution with the alkaline aqueous solution and a chelate agent.

3. A method for forming a positive electrode active material, comprising the steps of:
forming a cobalt compound by reacting a first mixed solution comprising a cobalt aqueous solution and a first chelate agent with a second mixed solution comprising an alkaline aqueous solution and a second chelate agent;
mixing the cobalt compound and a lithium compound and then performing a first heat treatment, thereby forming a first composite oxide;
mixing the first composite oxide and a compound comprising a first additive element and then performing a second heat treatment, thereby forming a second composite oxide; and
mixing the second composite oxide and a compound comprising a second additive element and then performing a third heat treatment,
wherein the first heat treatment is performed at a temperature higher than or equal to 700° C. and lower than or equal to 1100° C.,
wherein the second heat treatment is performed at a temperature higher than or equal to 700° C. and lower than or equal to 1000° C., and
wherein the third heat treatment is performed at a temperature equal to the temperature of the second heat treatment or at a temperature lower than the temperature of the second heat treatment.

4. A method for forming a positive electrode active material, comprising the steps of:
forming a cobalt compound by reacting a first mixed solution comprising a cobalt aqueous solution and a first chelate agent with an alkaline aqueous solution and a second chelate agent;
mixing the cobalt compound and a lithium compound and then performing a first heat treatment, thereby forming a first composite oxide;
mixing the first composite oxide and a compound comprising a first additive element and then performing a second heat treatment, thereby forming a second composite oxide; and
mixing the second composite oxide and a compound comprising a second additive element and then performing a third heat treatment,
wherein the first heat treatment is performed at a temperature higher than or equal to 700° C. and lower than or equal to 1100° C.,
wherein the second heat treatment is performed at a temperature higher than or equal to 700° C. and lower than or equal to 1000° C., and
wherein the third heat treatment is performed at a temperature equal to the temperature of the second heat treatment or at a temperature lower than the temperature of the second heat treatment.

5. The method for forming a positive electrode active material, according to claim 2,
wherein the chelate agent comprises one of glycine, oxine, 1-nitroso-2-naphthol, and 2-mercaptobenzothiazole.

6. The method for forming a positive electrode active material, according to claim 3,
wherein the first chelate agent comprises one of glycine, oxine, 1-nitroso-2-naphthol, and 2-mercaptobenzothiazole, and
wherein the second chelate agent comprises one of glycine, oxine, 1-nitroso-2-naphthol, and 2-mercaptobenzothiazole.

7. The method for forming a positive electrode active material, according to claim 6,
wherein the first chelate agent comprises the same material as the second chelate agent.

8. The method for forming a positive electrode active material, according to claim 1,
wherein the first additive element comprises one of Mg and F, and
wherein the second additive element comprises one of Ni and Al.

9. The method for forming a positive electrode active material, according to claim 1,
wherein before performing the third heat treatment, a compound comprising a third additive element is mixed to a mixture of the second composite oxide and the compound comprising the second additive element.

10. The method for forming a positive electrode active material, according to claim 9,
wherein the first additive element comprises one of Mg and F,
wherein the second additive element comprises Ni, and
wherein the third additive element comprises one of Zr and Al.

11. The method for forming a positive electrode active material, according to claim 1,
wherein the first composite oxide is crushed and then the second heat treatment is performed to form the second composite oxide.

12. The method for forming a positive electrode active material, according to claim 3,
wherein the first additive element comprises one of Mg and F, and
wherein the second additive element comprises one of Ni and Al.

13. The method for forming a positive electrode active material, according to claim 3,
wherein before performing the third heat treatment, a compound comprising a third additive element is mixed to a mixture of the second composite oxide and the compound comprising the second additive element.

14. The method for forming a positive electrode active material, according to claim 13,
wherein the first additive element comprises one of Mg and F,
wherein the second additive element comprises Ni, and
wherein the third additive element comprises one of Zr and Al.

15. The method for forming a positive electrode active material, according to claim 3,
wherein the first composite oxide is crushed and then the second heat treatment is performed to form the second composite oxide.

16. The method for forming a positive electrode active material, according to claim 4,
wherein the first chelate agent comprises one of glycine, oxine, 1-nitroso-2-naphthol, and 2-mercaptobenzothiazole, and
wherein the second chelate agent comprises one of glycine, oxine, 1-nitroso-2-naphthol, and 2-mercaptobenzothiazole.

17. The method for forming a positive electrode active material, according to claim 16,
wherein the first chelate agent comprises the same material as the second chelate agent.

18. The method for forming a positive electrode active material, according to claim 4,
wherein the first additive element comprises one of Mg and F, and
wherein the second additive element comprises one of Ni and Al.

19. The method for forming a positive electrode active material, according to claim 4,
wherein before performing the third heat treatment, a compound comprising a third additive element is mixed to a mixture of the second composite oxide and the compound comprising the second additive element.

20. The method for forming a positive electrode active material, according to claim 19,
wherein the first additive element comprises one of Mg and F,
wherein the second additive element comprises Ni, and
wherein the third additive element comprises one of Zr and Al.

21. The method for forming a positive electrode active material, according to claim 4,
wherein the first composite oxide is crushed and then the second heat treatment is performed to form the second composite oxide.
